(19) United States
(12) Patent Application Publication
(10) Pub. No.: US 2005/0165829 A1
(43) Pub. Date: Jul. 28, 2005

(54) Systems, Methods and Computer Program Products for Developing Enterprise Software Applications

(76) Inventor: Jeffrey Varasano, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 10/982,222

(22) Filed: Nov. 4, 2004

Related U.S. Application Data
(60) Provisional application No. 60/517,191, filed on Nov. 4, 2003.

(51) Int. Cl. G06F 17/00

(52) U.S. Cl. 707/102

(57) ABSTRACT

Abstract of the Disclosure

A software development system and associated methodologies for a business solution including the steps of creating a document having a plurality of variations, defining for the document a plurality of data elements, rows and columns of data from which to populate the document, designating for each data element an attribute associated with the access of that data element based on the each variation of the document, designating for each row and column of data access rights based on different defined classes of audience, receive a request to view the document, determining which data elements are presented in the document based on the task attributes, determining which column and rows of data are presented in the document based in audience access rights, and generating the document for presentation to a user. The invention further comprising determining if any of the data elements that are presentable in the document according to the task attributes need to be hidden of rendered blank based on the audience access rights.

### Detailed Description of the Invention

### RELATED APPLICATIONS

The present application claims the benefit of U.S. Provisional Patent Application Serial No. 60/517,191 filed November 4, 2003, which is hereby incorporated by reference as if set forth fully herein.

### FIELD OF THE INVENTION

The present invention generally relates to database applications, and more particularly, to data management and manipulation systems, methods and computer program products.

### BACKGROUND OF THE INVENTION

Companies need data management systems to handle their order processing, accounting, customer relations, inventory, payroll, budget, industry specific modules, etc. Designed correctly, these data management systems can seamlessly integrate all of the areas of a company. For instance, they can provide management with solid information about their business, reduce the cost of operations by millions of dollars, and support the entire customer experience. Designed poorly, these data management systems run millions of dollars over budget and leave managers clueless, operations disorganized, and customers frustrated.

Industry research shows that only about one tenth (10%) of the projects are done on-time and on-budget. But one third of the projects are cancelled outright, typically after going substantially over budget. The remaining projects, just over half, experience budget overruns averaging three times the projected costs and time while yielding less than half of the functionality originally expected. The problem in the United States is estimated at $50-100 billion a year. Despite the advances that have been made in technology over the last twenty years, businesses have found that their systems have remained extremely costly to build, maintain, and modify as their businesses grow.

The defining characteristic of all the prior art business systems is that they are always highly customized for particular businesses. Businesses often fail because they cannot handle growing complexity. For instance, each change or new business process adds a dimension of complexity. The systems increase in complexity as more and more code is added to accommodate the changed or new business processes, and soon the project spins out of control. Because the code starts to grow geometrically in size, it becomes increasingly more difficult to maintain and edit.

Geometric expansion of code is caused by “permutations,” that result from the changed or additional business processes. Database development tools currently in place allow simple variations to become permutations which expand the size of the code exponentially. FIG. 1 illustrates how the geometric expansion of business processes results in a corresponding expansion of the software that relates to the business. In the exemplary illustration shown in FIG. 1, a basic sales order system exists. At the very beginning, the box representing the sales system may only include, for example, ten pages of code needed to implement a basic screen. As variations in the order system are recognized, such as those relating to the other tasks of repair, contract, and service, several additional variations to our basic sales order system begin to develop. Each task type (Service, Contract, Repair, Sale, etc.) has some similar rules for inputting data because they all use products from the products Table. However, they also have some different rules. For example, Sales and Consignment pull prices from a price list, but Repairs and Service do not. Repairs do not pull from inventory, have no commissions, and allow for manual price entry. Only the Consignment version has a “date due back” column. Service has commissions, but no inventory. Therefore, these differences will affect the columns that are displayed in the Order Item detail list, the fields that are displayed in a user interface in the header, and the calculations that are performed on the displayed data. Even at this relatively simple level of complexity, most systems will choose some form of separation. This may result in several times as much code as the base case – for example, forty pages.

Still referring to FIG. 1, while these task variations act like a force that generates code, causing it to expand in one dimension, many other dimensions of complexity are simultaneously expanding the code in other directions. For example, each sales order may have several audiences, including the customer service representative who enters the order, the salesperson, the staff in shipping or manufacturing who processes the order, and the customer who gets some kind of copy of the order. Each audience may only need to view a different subset of the entire order. The customer service representatives needs to view information on late payments, the employees in shipping need to view inventory data or manufacturing instructions, but do not need to view commission information or credit data. The customers may view a logo, a product description from the brochure, and return information., but will not view information on commissions or inventories. The salesperson, who may be a transient or seasonal worker, would not view inventory information, but would view commission information. This dimension of complexity is still compounded by the first variances between the four order types based on the task, but now each of the four order types will need a different version depending on which of the four audiences may view the information. In most prior art business enterprise software or database systems, there would already be close to several hundred pages of code due to the geometric expansions in only the two dimensions described above.

Still referring to FIG. 1, to add a third dimension, each view of the data may need to be output in several ways. For example, the customer service representative may need to see things on the screen, the accounting staff may want data downloaded to Excel, or the customer may access data on the web or receive a printout receipt packed with the order, etc. There might even be another machine that receives a copy of the order in a special format. For example, an order may be sent to a cooperating vendor’s computer, adding both an audience and an output variation. Due to the expansion in three dimensions, a business enterprise software program may quickly grow out of control in both size and complexity. The software program also begins to become inconsistent as not all possibilities are handled.

The problem is further multiplied because sales may be just one process. With multiple processes, a business enterprise database software program may need to interconnect with each program. For example, sales may need to be connected to distribution. If sales is partitioned into sales, repairs, and samples, while the distribution system is similarly split into UPS, FedEx, and U.S. Mail, then multiple connections may be needed. As illustrated in FIG. 2, the combined multiple processes may result is an extraordinarily large series of permutations and connections. Parts that were not designed as “plug and play” are manually connected in a difficult and expensive process. Worst of all, these systems are inherently unstable because changing one process throws the whole system into chaos due to unforeseen permutations. This diagram only shows business processes such as [[-]] sales, inventory, and purchasing. There are also computer processes such as buttons, menus, windows, tables, and servers. These also need to be managed by the software program. There are also dimensions internal to each cube that have been left out for simplicity, but which will be covered in more detail in the invention. In all, there are at least seven major dimensions of complexity and many minor ones as well. Thus, it is not unusual to see such systems exceed one hundred thousand pages of code even though the underlying business processes are not overly complex. This level of complexity may lead to substantial costs, and even ultimately failure.

### BRIEF DESCRIPTION OF THE SEVERAL VIEWS OF THE DRAWING(S)

Reference will now be made to the accompanying drawings, which are not necessarily drawn to scale, and wherein:

FIGS. 1-2 show diagrams illustrating the problem with permutations in business enterprise software.

FIG. 3 is a diagram illustrating the plug-and-play concept of an exemplary system in accordance with an embodiment of the present invention.

FIG. 4 is a diagram showing framework layers in accordance with an embodiment of the present invention.

FIG. 5 is a diagram showing the interaction of framework layers in accordance with an embodiment of the present invention.

FIG. 6 is a chart depicting framework concepts versus application concepts in accordance with an embodiment of the present invention.

FIG. 7 is a general technical specification for the exemplary system in accordance with an embodiment of the present invention.

FIGs. 8-13 depict set-up and creation of screens in accordance with an embodiment of the present invention.

FIG. 14 is a diagram illustrating the loading of documents in a system in accordance with an embodiment of the present invention.

FIG. 15 is a chart having brief descriptions of various features of a system in accordance with an embodiment of the present invention.

FIG. 16 is a chart related to the BPtr system in accordance with an embodiment of the present invention.

FIGs. 17 to 43 are screen shots illustrating some exemplary features that are possible with the use of the BPtr system in accordance with an embodiment of the present invention.

FIGs. 44-74 are screen shots of an exemplary user interfaces illustrating task and audience variation in accordance with an embodiment of the present invention.

FIG. 75 is a flow diagram of task and audience variation in accordance with an embodiment of the present invention.

FIGs. 76 – 78 are illustrations and screen shots relating to local table variations in accordance with an embodiment of the present invention.

FIGs. 79 – 83 are illustrations related to output format variations in accordance with an embodiment of the present invention.

FIGs. 84 – 87 are illustrations relating to re-usable querying in accordance with an embodiment of the present invention.

FIG. 88 relates to general tables in accordance with an embodiment of the present invention.

FIGs. 89 - 91 relate to list view interface features in accordance with an embodiment of the present invention.

FIGS. 92 – 100 relate to document view architecture in accordance with an embodiment of the present invention.

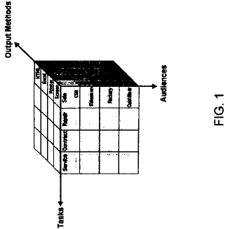

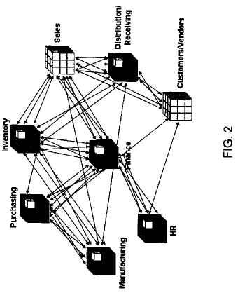

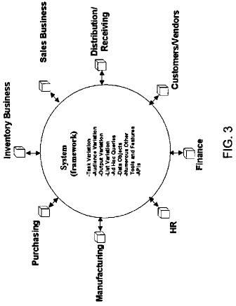

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

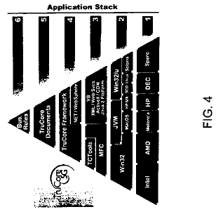

FIG. 3 illustrates the framework and plug-and-play concepts of a business enterprise program that has as its framework an exemplary system of the present invention. The present invention provides an application and development framework that handles most of the complex and repetitive tasks that have oftentimes lead to long-term failure for developers. The exemplary system thus includes and provides a framework that allows business rules to be isolated from the inner complexities of structuring a whole integrated system. Developers create simple business rules documents that are attached to the main framework. This creates a “plug and play” system, whereby developers focus on business rules while the framework handles complexities. Each area of permutation-inducing variation is handled within the framework. Developers are given very simple interfaces to provide information to the framework to allow the framework to handle the above-mentioned complex permutations with the minimum amount of input and workload.

An exemplary system of the present invention combines several features simultaneously, such that the remaining code in each business rules document is minimal and uniquely concerned with the particular business and not the operation of the software. Such features may include an application framework, wherein a common architecture handling hundreds of features and establishing basic ground rules for systems is provided for. The application framework has, for example, a hierarchical structure that may allow developers to deal with far fewer types of code. The framework takes the most complex tasks out of the hands of end developers. The application framework may also allow developers to focus on “documents” rather than integration. Developers may create documents that define their business rules. Business rules may include those that relate to Inventory, Sales, Distribution/Receiving, Customers/Vendors, Finance, HR, Manufacturing, Purchasing, etc. These documents can then be “attached” to the framework. The framework then deals with the large body of tools and API calls and features, most of which are implemented with little or no developer code required. Thus, parts may integrate to the framework, instead of each other, reducing the size and complexity of business enterprise software. An application framework feature may also provide for function scalability in that expansion may be forward and backward. Thus, a system of the present invention not only may provide for a development environment, but it may serve as the framework that developers can use to create database systems, such as ERP, CRM, accounting, payroll, inventory, or any other database modules.

A system of the present invention may also have features that target each area of permutation. For example, an exemplary system may allow for task variation in which multi-flavored screens co-exist. Such an exemplary system may also have features that allow for audience variation in which different audiences experience a different program without forcing the developer to implement separate code. Such audience variation may result in, for example, a particular audience being able or unable to access, for example, an entire object, layout, macro, or report. It may also result in a particular audience being able or unable to access certain columns or rows.

A system of the present invention may also allow for output variation in which documents may be “virtual” and can be rendered as screens, reports, HTML, email, spreadsheets, etc.

A system of the present invention may also allow for ad hoc queries or reusable query results, which may allow for the management of connections between modules and the transformation of data into information. Such querying capability may involve search tools, related data, compare queries, addition of highlighted entries, an analysis of data.

Other features of a system of the present invention may include, for example, templates for managing scrolling areas within an edit screen. This may, for example, allow for the automatic management of connections to the header, menu options and features related to menu options, and use of pre-programmed tools for the most complex parts of any screen. Such features will be described more fully herein.

Another feature of a system of the present invention utilizes a BObject and BPtr (or “B Pointer”) data object system, which will be described more fully herein.

FIG. 4 illustrates how common hardware, operating systems, and application layers relate to one another, and depicts an exemplary environment in which an exemplary system of the present invention (“the exemplary system”) operates. Applications are layered in that there are a series of frameworks that sit on top of one another. Each layer responds to the layer below it, creates and controls layers above it (Framework), and provides services and tools for layers above it to use (API). The first three layers are common to most everyday programs.

Each of the frameworks has the following characteristics. Each framework can initialize itself by creating connections to the layer above it or to the outside world. Each framework tracks the states of objects that it uses (for example, using tables of “registered objects,” and also sets up an interface. Each framework can also create and control higher objects; compared to the higher framework, the current framework has the first and last word on everything. In this way, the framework actually defines the structure of whatever sits above it. The higher layer’s function is to respond to events created by the framework below it. For example, the framework may receive events, pre-processes events (here is where the current framework may react to an even lower framework), notify applications (higher layer) of the event (or generate new higher level events), post-process events (here is where current framework reacts to the higher Framework), and, as much as possible, take all action based on information provided by the higher layer (“Action vs. Description”). So wherever possible, the higher layer should describe what type of action is needed and then the Framework actually takes the action. Each framework can track states (register object vs. create object). The framework always wants to “know” what is happening. So objects are “registered” rather than doled out and objects are changed by calling API functions, so that changes can be tracked. Each framework also should hold the generic, reusable code. Anything that is useful for many variations of lower layers should be put into the framework. Another way of saying this is that reusable code should be pushed into the lowest framework practicable. Each framework should provide a toolkit and an API onto the toolkit (framework calls inner layer through events or “messages,” and inner layer calls framework through API - push/pull). Each framework should have entry points for expansion of itself. Startup expansion items can at times alter the framework itself.

In the present system, all of these features work together in one product, working seamlessly. The end result is that Application code is substantially reduced, even while user features increase dramatically.

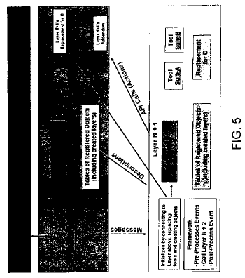

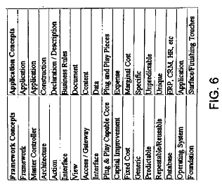

Referring to FIG. 5, one can follow the cycle of LayerN. It is initialized and then falls into its framework, where it processes events and passes them on as needed to N+1. Layer-N can own multiple LayerN+1 objects at a time. Each is registered. LayerN uses its own toolbox and allows LayerN+1 to use it also. LayerN+1 additionally can replace all or part of of a LayerN tool box. LayerN+1 cannot create or destroy objects Registered with LayerN. It can only request that LayerN do so. LayerN+1 provides descriptions of registered objects to LayerN. LayerN then manages the objects based on the descriptions. LayerN+1 is structured in a similar way. LayerN+1 can create LayerN+2 objects (not shown), which interacts with it the same way that LayerN+1 reacts to LayerN. Layers form an "Application/Framework" structure. That is, there is a master controller (the “framework”) and then there is the “application” that is being controlled. This terminology will be used from here out instead of the cumbersome LayerN, LayerN+1, etc.

An exemplary system of the present invention includes and serves as the framework (which encompasses actually two framework layers – Layers 4 and 5). The application is code that is specific to a particular set of business rules, such as ERP, payroll, CRM, etc. The “application” in this example is Layer 6. The exemplary system spans levels 3 – 5. In Layer 3, the exemplary system sits on top of MFC’s (Microsoft Foundation Classes for C++) framework, but replaces almost all of its tools. In Layer 4, the exemplary system provides a data application framework that is a solid framework and large API specifically tailored for creating business enterprise software. In Layer 5, the exemplary system provides inside the application framework another powerful framework that manages multi-dimensional variations. At Layer 5, all of the Tools available at lower layers are woven together by the exemplary system into a completed application as a coherent whole, not just parts. Also, this layer handles the “permutation problems” that cause most programs to spin out of control. Enterprise processes have multi-dimensional variations which, up until now had to be handled on a case by case basis, causing code to expand out geometrically in size and complexity. The exemplary system identifies the sources of these variations and provides systems for handling them, separate from the business rules. The exemplary system framework encompasses redundant tasks, variations, and complex connections providing leverage to the developer and reducing substantially the amount of code required to build an enterprise application. At Layer 6, nestled inside the powerful document framework of the exemplary system, business rules may be highly focused.

FIG. 6 is a table that illustrates exemplary differences in framework concepts from application concepts. As mentioned above, the present system embodies the concept that a database program is to be split into two parts - there is a master controller (the “framework”) and then there is the “application.” Many development environments provide developers with a framework having a suite of tools and an API (convenient functions that the developer uses to access the tools). The application is code that is specific to a particular business need such as ERP, payroll, CRM, etc. Generic or “reusable” code is put into the framework, and business module code is put into the application. The goal is typically to have more Framework and less Application because the Framework is reusable but the Application may not be.

The system of the present invention provides such a framework (which encompasses a huge toolkit as well) and has extensive toolboxes and API's. It is structured in a way that most developers will not need to use most of this toolbox directly. In the present system, the entire toolkit is woven together to form a single framework. The present system allows developers to create robust applications with a minimum amount of code and thus a minimum amount of effort. As much as possible, the framework takes all action, based on information provided by the application. The application need only describe what type of action is needed and then the Framework actually takes the action. Additionally, the application's function is to respond to events created by the framework. For example, the framework may receive an event, pre-processes the event, notify the application of the event (generates new higher level events), and then post-processes the event. Thus, the present system can provide the framework for any database application.

The exemplary system operates best with the multitudes of data formats being defined at an early stage. This follows the system’s goal of pushing the many variations of higher layers to the lowest level practicable. For example, the system may require an SQL column called “CommissionPercent.” When this value appears in a report, it should be displayed in a percentage format. So the value “.125” should display as “12.5%.” The SQL database does not rely on the format in which the value is stored. The number .125 could be applied as a static decimal number, a percent, a string, etc. Regardless, the database can store the number in only one format. Even though all data needs to appear on an interface at some point, the SQL database does not store interface information because it is responsible for storing data, not interfacing with data. The exemplary system provides the standards which allow the data to interface to a number of different formats as required for various applications.

Since the SQL database does not store formatting information, the exemplary system must handle the formatting of the data. In most applications this numeric format is applied just prior to display. Hence, the information must be determined on the form or dialog. If the “CommissionPercent” appears in five places, usually the developer will have to format the data five separate times. The exemplary system corrects this problem by applying the correct standards to the data, so that it is formatted correctly prior to reaching the application.

The exemplary system utilizes an extensive data dictionary to capture descriptions as early as possible. The data dictionary is a large body of containing date parameters or identified predictable differences for the formatting of the data. It contains descriptions of each data layout, table, column, etc. necessary for the desired displays.

The data dictionary consists of two distinct parts. The first part of the data dictionary contains a great number of pre-defined tables. In the exemplary system, these are SQL Tables as defined in JCreateTables.txt. When the system framework loads onto a client machine, it copies the necessary tables into their corresponding structures. Developers can then edit these tables using through display screens provided by the exemplary system.

The second part of the data dictionary consists of structures that are difficult to be stored in table format. The second part of the data dictionary further contains items that will be infrequently changed. This increases access speed by avoiding the need to store and access table structures and allowing direct access to developers designing on top of the described system.

The majority of information stored in the data dictionary is maintained in the first part as tables. This allows the system to know as much as possible about that data before a developer ever begins drafting the code to use the data. Entire displays may by defined entirely inside the data dictionary, without the need for any developer code at all. These will be described below.

The exemplary system defines structures that tell it what is going on and what is changing. Changes to system-owned objects are made through a system-supplied API which can recognize changes and take the appropriate action.

An exemplary program that includes the exemplary system as the framework and developer application that utilizes the framework may have, for example, the following startup routine, which shows the basic structure of the program:

Make Connection to SQL Server

Set Up Structures

Data Dictionary

Compile-based

Server-based

Client Machine Based (Locally Saved Preferences)

Track States

Open Documents (Windows/Reports)

Processors (Timed Tasks)

Logs

Data Caches

Global Data and Misc States

Create Application

Setup Default Interface (Main Frame)

Menus

Load Toolbar

Application.OnStartup()

Respond to User

This type of structure is repeated again and again at different scales. It is fractal in nature. The pattern repeats, on different scales embedded within each other. For example, within the last item above, "Respond to User", the following logic is nested in order to open a window:

Connect to Data Selection (List of active SQL Rows)

Set Up Structures

Data Dictionary

Resource-based (Dialog Resource)

Server-based (Pulled from or pointers to Main Data Dictionary)

Track States

Virtual Controls and Control Groups

Data Record (Current SQL Row)

Local Tables

Misc Data

Create Application Document

Setup Default Interface (Viewer)

Controls and Control Groups

Frame and Buttons

Action Toolbar

ApplicationDocument.OnLoadDocument()

Respond to User

The job of a framework is to allow ways to handle exceptions by turning control over to the next layer at strategic points. If the framework is very useful, the next layer will not have to handle many exceptions. TruCore sits inside the MFC framework. However, TruCore has opted out of most of MFC's functionality. Only about 10% of TruCore classes rely heavily on MFC classes. TruCore uses MFC's simple Win32 wrappers, but only a tiny part of its architecture.

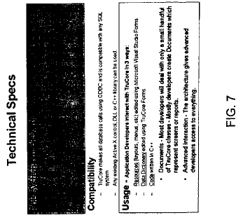

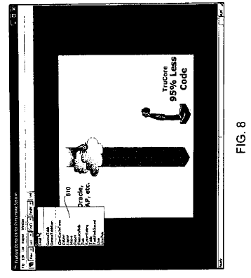

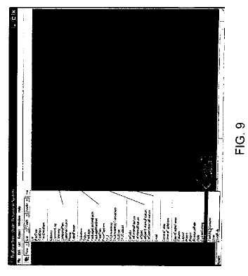

The exemplary system of the present invention provides an application framework. FIG. 7 illustrates exemplary technical specifications of the exemplary system. In the exemplary embodiment, the exemplary system is primarily a library written in C++, with several ActiveX controls that support the C++ program, and a series of SQL stored procedures. However, conceptually, the exemplary system is independent of any programming language and is specifically designed to be easily transportable to Java, C# (C -Sharp) or any other object oriented programming language. This independence is achieved by isolating all of the operating systems calls into a small toolkit within the exemplary system. Only one section of Layer 4, the “Viewers,” interact heavily with Layers 2 (the OS) and Layer 3 (Microsoft Foundation Classes for C++ - a wrapper for the OS). The exemplary system’s Layer 5, the Document Layer, contains virtually no operating system calls, nor do any of the data objects or containers. These concepts will become clearer as the Document / View architecture is described below. Although the exemplary system is written in C++, any application framework of the present invention may be written in other programming languages.

Unlike a lot of development tools, the exemplary system is a complete working program. It is not just a tool for creating programs. In other words, right out of the box, one can launch the exemplary system. It will startup, link to the database, create a main window with menus and a toolbar and be ready to go. Then one can use the toolbar to load up windows (referred to herein as “Documents”), add data, save, and finally exit the program. When a developer first loads the exemplary system, only a few data tables exist. FIG. 8 depicts an exemplary display when a user, for example a developer, first launches the exemplary system. The toolbar menu shows all of the tables 810 that can be edited. These tables are generic and are non-industry specific.

A developer interacts with the exemplary system by adding on to it. The exemplary system is the application framework and encompasses Layers 3-5. Developers add on to the exemplary system by adding Layer 6. Advanced developers can also go back and create substitutions for lower layers. After adding industry specific tables, such as Orders, Packages, PackageManifest, and Menu items, like Customer Service, Shipping and Accounting, etc., a display of an exemplary enterprise program based on the application framework (which may be the exemplary system) may appear as in FIG. 9. As shown in FIG. 9, several lists 910 have been created by the developer. Icons corresponding to the accessible lists include those for “Orders,” “PackageManifest,” and “SKUInventory.”

To interact with the exemplary system, the developer adds resources (such as dialogs and menus) and creates C++ classes that descend from the exemplary system’s classes. Then the developer makes entries into the Data Dictionary to tell the exemplary system the names of the resources and C++ classes. The Data Dictionary is “meta-data.” That is, it stores data about other data. The exemplary system can then use that information to link everything together. The Data Dictionary are the tables at the bottom that begin with the letter “j,” such as jTable, jLayout, jColumn, etc. To add to the exemplary system, the developer can create resources and C++ classes, give each a name, and then put the names of those into appropriate places in the Data Dictionary.

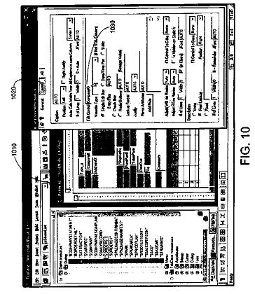

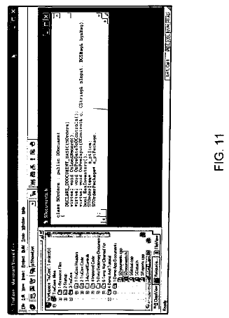

The first step may be, for example, to add a resource. In FIG. 10, an exemplary display, the developer is adding a dialog resource named “SORDERS” 1010. This may be done using, for example, Microsoft Visual Studio’s standard dialog editor. Still referring to FIG. 10, the developer is editing a control of the exemplary system called XEdit by filling in the properties page 1020. Below the user is telling the exemplary system that this control will hold a SQL Column for Order.CompanyID 1030.

The second step may be, for example, to add a handler class. FIG. 11 depicts an exemplary display wherein the developer adds a C++ class named SOrders which descends from a class of the exemplary system called “DDocument.” This can be seen in the SDocuments.h window 1110.

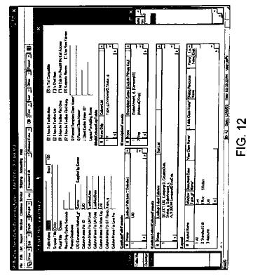

The third step may be, for example, adding to the Data Dictionary. FIG. 12 depicts an exemplary display in which the developer adds names of the SQL Table, the Resource, and C++ Handler class to the Data Dictionary.

When the exemplary system starts, it copies data from the Data Dictionary to the local client. The below is a quick review of the startup cycle for the exemplary system’s Layer 4:

Make Connection to SQL Server

Set Up Structures

Data Dictionary

Compile-based

Server-based - this will include data about “sorder”

Client Machine Based (Locally Saved Preferences)

Track States

Open Documents (Windows/Reports)

Processors (Timed Tasks)

Logs

Data Caches

Global Data and Misc States

Create Application

Setup Default Interface (Main Frame)

Menus

Load Toolbar - this will show tablename “orders” as a choice for the user

Application.OnStartup()

Respond to User

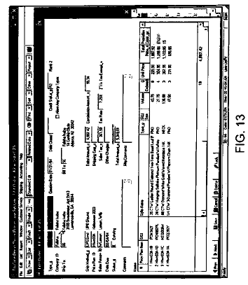

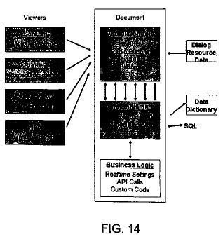

Using this information in the Data Dictionary, the exemplary system builds the toolbars so that the SORDERS screen is accessible to the user. When the user requests the document, the exemplary system loads the dialog resource, creates the C++ class, and links everything together. FIG. 13 shows an exemplary window that may appear. FIG. 13 also illustrates how the developer adds to the exemplary system. In this example, the developer added a Dialog and matching DDocument. Although this is the most common addition to the exemplary system, here is a summary of the other exemplary additions:
Data Dictionary - Tell us about your database - Compile Time info for the exemplary system
Resources - Layouts, menus, toolbars and other static data, compile time info for MFC
Write C++ Code - Linking to the exemplary system.
Application Handlers - These are Layer 6 additions:
Main Frame - One’s application runs its own startup routine.
Documents
DDocument
TLocalTable
Macro Handlers
System Settings
Background Jobs
Data Cache Controllers
QTableSchema (aka QRecordTemplate), etc.
Expansion Lists – the exemplary system defines utilities and adds them to master lists. Developers can add their own entries into these lists
Display Formats
Entry Filters
Fonts
Attributes
Additional BObjects with RuntimeClass Entries
Framework Substitutions (For Advanced Developers) - Replacements or Addendums to Lower layers. Can add on to or replace anything in Layers 3-5 (or even Layer 2, the OS, for the extremely ambitious). Most common might be:
View Classes
View Controls

In the example given above, the exemplary system was notified about an addition when the developer entered the names of the objects into the Data Dictionary. That methodology is used for most application handlers. With expansion lists, framework substitution and some application handlers, the exemplary system is notified in the main frame startup routine or during other executing code. The starting point, though, is always the Data Dictionary. If one wants to create a custom startup routine, the class for that application handler goes in the Data Dictionary, and then that class, once created, can make other substitutions while it is executing.

The above description related to how the exemplary system got to a Document. The following description relates to what is a Document, and how is it loaded. Below is a review of startup cycle for the exemplary system’s Layer 5, the Document layer:
Connect to Data Selection (List of active SQL Rows)
Set Up Structures
Data Dictionary
Resource-based (Dialog Resource)
Server-based (Pulled from or pointers to Main Data Dictionary)
Track States
Virtual Controls and Control Groups
Data Record (Current SQL Row)
Local Tables
Misc Data
Create Application Document
Setup Default Interface (Viewer)
Controls and Control Groups
Frame and Buttons
Action Toolbar
ApplicationDocument.OnLoadDocument()
Respond to User

FIG. 14 is an exemplary diagram that serves to illustrate the loading of Documents in the exemplary system. It can be compared in detail with the Layer 5 framework cycle above. Referring to FIG. 14, the following are exemplary steps to loading, for example, an exemplary Order Screen. Recall that “SOrders” is an application handler based on DDocument. DDocument (Layer 5) will do most of the work but it will give SOrders (Layer 6) an opportunity to make edits. This is the basis for the Framework/Application Relationship. Referring to FIG. 4 for context, the following are the basic load steps:
User Requests loading 'Orders' by picking it from the toolbar.
Data Dictionary entries are retrieved. Layer 4 is now ready to create a Layer 5 object.
A C++ class for 'SOrders' is created and registered on Layer 4's table of open Documents.
Dialog Resource Data for 'SORDERS' is retrieved. Data from the property pages is fed into the DDocument. DDocument creates 'Virtual Controls' - data objects which store information about screen elements. However actual screen elements are not created yet.
Data Containers are initialized
Data from the SQL Server is loaded into basic Data Containers. Data Containers are part of the exemplary system’s Tools located at layers 3 & 4. Layer 4 contains a toolkit with an API that is used to move data from the SQL Server to the Data Containers.
Some data loaded automatically by the exemplary system's DDocument
DDocument calls SOrders which load more data by calling the exemplary system’s Layer 4 data loading API.
The exemplary system attempts to link every piece of data loaded to a description in the Layer 4 Data Dictionary. This way, the exemplary system will know how to handle each piece of data.
Based on the dictionary information, raw data may be reorganized and put into more sophisticated Data Containers.
Virtual Controls are linked to Data Containers by linking names together.
Extensive measurements are taken so that controls may resize themselves to fit the data
Controls also link to Layer 4 Data Dictionary
Combining resource data, SQL Data, and Data Dictionary info, the Virtual Controls are configured for viewing
SOrders is given final notification and allowed to make adjustments.
The document is completely loaded
A Viewer is attached to the Document. Viewers are Layer 4 constructs. Their function is to link the Document to an output device. An output device is a physical thing, such as, for example, a printer, a screen, a file on a hard drive, etc.
Layer 1 - Output devices
Layer 2 (the OS) - hardware drivers, virtual devices (aka hDC = hDeviceContext), File Manager, email manager
Layer 3 – MFC’s wrapper for virtual devices (aka CDC = CDeviceContext), CFile, IPStream etc.
Layer 4 - The “Viewer” links layer 4 Virtual Controls, to an appropriate layer 2 or 3 object or API.
The Viewer chooses how to implement the DDocument. So a screen viewer might add, for example, “Next,” “Previous,” “Save,” or “Cancel” buttons, but an Excel viewer would not, etc. This is what implements “Output Variation,” as described below.
Layer 5 - Virtual Controls pointing to Data Containers

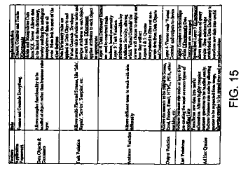

FIG. 15 is a chart that reviews primary features (although other features are and may be incorporated within the exemplary system) as they relate to Layer 4 (the framework, which may be the exemplary system) and Layer 5 (the DDocument).

Data is the foundation of the exemplary system. To solve many permutation and complexity issues, the exemplary system implements a system referred to herein as the BObject/BPtr system, which is an object oriented system. C++ and SQL both deal with data. However, both systems are concerned with how data is stored and retrieved and not so much with how it can be powerfully manipulated and analyzed. There are many problems with how data is stored in prior art database systems.

The problem is that SQL has very limited data typing capabilities. SQL was developed in the 1970’s when the main concern was developing standards for the storage and retrieval of data. Developing uniform standards for Storage and Retrieval were critical problems at the time, because the lack of standards was causing variation/permutation problems at that low level. SQL solved those problems. However it did not anticipate the next level of usage, which is the manipulation and analysis of data. For example, SQL can't tell the difference between the string “Hello Kitty” and the string “http://www.yahoo.com.” Both follow the same rules when it comes to data storage, so SQL doesn't differentiate. But, of course, the second string is a URL, for which there is much information, including information relating to how URLs behave. So rather than just declare this to be of type “String” or “Varchar,” the exemplary system creates a higher level object called a BURL. Other objects may include BTime, BEmail, BColor, BTrackingNumber etc.

Again, there is a distinction between description and action. For example, a SQL Column called “Product.ImageURL” can be created. The Application developer creates a screen to edit the product and this screen contains an edit control for the ImageURL column. In many databases, support for this piece of data would have to be implemented by the application directly on the document. So the developer might add a button to allow the user to load a file. There might be a second control nearby that displays the image found at the URL. The document would be responsible for loading the image when the user loads the record and also whenever the user edits the value of ImageURL, etc. In this way, the application would be responsible for acting on the URL.

In the present invention, data objects are handled by the application framework, which may be the exemplary system. In the Data Dictionary, the developer declares ImageURL to be of type BURL. The exemplary system implements the BURL data type every time the ImageURL data is shown. BURL may support its own pop-up menu (Right-mouse button menu) that has “load from file” options. The controls will also accept file drags. Chasing the URL and loading the image file found at the URL is also handled by the framework (e.g., the exemplary system), even when the URL text and URL image appear side-by-side as columns in a display table. Thus, once again, the application describes, and the framework acts.

Another problem is that C++ is an object oriented programming language. That means that it can be used to create hierarchical data objects. Yet one continues to see new database client tools in the prior art systems that do not make use of this concept. Consider this structure:

class Orders

{

UniqueID int

CompanyID int

SalesmanID int

ShippingMethod CString

TrackingNumber CString

TotalPrice double

CompanyCode CString

SalespersonName CString

}

This type of structure is very commonly seen in Java, VB or C++ applications. Data is being stored using basic data types such as int, CString or double. SQL table structures are being reproduced in a hard coded object.

Again, like with the URL example, with the way the data is structured, the developer is forced to manipulate and support the data by adding custom code around it. The number of permutation problems created by this kind of structure is so extraordinarily large. For example, suppose that the TrackingNumber appears in five places, in each time as a Cstring data type. So it might appear on an edit screen, a list screen, a search result screen, in a package, in the order, etc. Presumably, the user desires the ability to check the status of a tracked package by looking up the number on the shipper’s website. With the structure above, code would have to be written in each and every place this appears to give this feature to the user. And, if a new tracking-related feature were developed in the future, a developer would have to go back to each occurrence and insert support for that new feature.

Yet another problem is that MFC and C++ in general attempt to strictly define data types. From a compilation and memory viewpoint, this is appropriate. But, from the viewpoint of creating a high level 5th generation programming interface, strict data typing is a real problem. There need to be common ways to manipulate data, regardless of their types. It would be impractical to have a switch statement to test for every data type at every turn. While MFC recommends the use of templatized classes for its data containers, such as Carray, this has several problems:
There are so many different data types, that creating a template for each one would significantly increase the compile size. Since the exemplary system compiles into a Fat client (rather than a DLL) which must be distributed around networks, small size is preferred.
Templatized classes do not work well with heirarchical objects. Although it is possible to build Templatized classes this way, the code is difficult to write, read, and follow.
If the containers themselves need to be heirarchical, as well as the object being contained, templatization completely breaks down.
Many objects need to hold data whose type is unknown at compile time. Even a simple action like “Select * from Table” can throw off any attempt to know all types before compiling.
Many collections want to hold items with mixed types.

Thus, templatized classes are not used in the exemplary system of the present invention. Each of the above problems leads to an explosion of code because at nearly every turn, functions have to first test the nature of the data that they are dealing with and then branch off to run custom code for each. This branching causes variations, which again feed on one another, causing multi-dimensional permutations, an explosion of code, inconsistent interfaces, and a lack of user power.

The exemplary system uses the BObject/BPtr System, which serves as the foundation for all data manipulation within the exemplary system. The following notes on terminology apply to the BOject/BPtr System:
A data 'Object' or 'Data Object' will refer to "Single Value Data Objects". So an Object may be string, a date, an image, etc.
A Collection holds many Objects. Collections are Arrays (lists of Objects), Tables (an Array of an Array of Objects), Records (all the columns from one SQL row), etc.
A Container holds multiple types of data, usually several types of Collection. A DDocument is a container which holds tables, Arrays, Records and other data.
Data Classes - any of the above
The BObject is the primary foundation class for almost all of the exemplary system’s classes, especially data classes. The BObject system:
Creates a system of Hierarchical Data types
Has its own simple Message Passing system
Creates an elegant data type independent Parent/Child ownership System using BPtr
Maintains a Basic Dirty Counter
Provides mechanisms whereby the owned object can callback its own container, when needed.

In the present invention, all data classes descend from BObject, including classes such as BInt, BDouble, BString, BTime, etc. These basic data types correspond to SQL data types. We also have extended data types, such as BURL, BImage and BForeignKey. Extended data types allow for more complex interaction than basic data types. BObject

BNumber

BInt

BBool

BCheck

BBoolIcon

BLineNo

BCount

BVersion

BColor

BDouble

BRoundedDouble

BMoney

BTime

BCreationDate

BFormatedDouble

BRangeDouble

BString

BText

BLiteral

BLongBinary

BAnimation

BImage

BBarCode

BTrackingNumber

BTimeStamp

BURL

BEmail

BGeneralTable

BGeneralTableTemp

BGeneralTableDynamic

BTimeRelative

BPassword

BPtr

BRevertablePtr

TBRevertablePtr

QRecordColumn

BUniversalDataHolder

BUID

BForeignKey

BUIDKey

BVariableForeignKey

BDescCell

BDescCellGT

BPctOfTotal

DControl

TControl

TLocalTable

BDataCatalog- This class is both a collection and a single value Data object

BDataLibrary

Using hierarchical data types provides a common interface for interacting with the data types. All data types support the following functions:

virtual bool SetFromString()

virtual bool SetFromNumber()

virtual CString GetAsString()

virtual double GetAsNumber()

virtual LRESULT SendMsg()

In this way, function calls like the following will work with all data types:

pBObject->SetFromString(sSQLFetchedData);

sViewData = pBObject->GetAsString();

Functionality is expanded because other functions rely on the Get/Set functions:

virtual operator==

virtual operator=

virtual operator+= , +, -=, -

virtual Compare()

virtual IsBlank()

Although these other functions are also virtual, for the most part it is not necessary to override them. They all feed back through the four Get/Set routines. So long as those four routines are managed, all the others should work properly. The GetCompareType() function will indicate to BObject which pair of Get/Set functions to use when handling operations such as Compare, +, +=, etc.

As indicated above, this provides a common base for data storage and transfer instead of using templates, AArray and other containers to hold pointers to BObjects. Further, this allows a tremendous number of routines to be written generically. In addition, single data containers can now hold a mixture of data types. Moreover, it allows object logic to be self-contained. Whereas templates require that the Container understand the Objects it holds, the BObject system only requires that the objects understand themselves and each other. So tests like these make perfect sense:

BLMUser("Larry") == BString("Larry") //Common Object Bstring

BDouble(36121.12) == BLMDate("July 4, 2002") //Common Object Bnumber

BDouble(36121.12) == BString("36121.12") //Common Object BObject

The BGSMsg (Get/Set Message) system (“Message Passing System”) dramatically increases the power and flexibility of BObject by allowing Get and Set messages to be performed in context. All Get Set routines and all routines which rely on Get and Set, make use of the BGSMsg.

class BGSMsg

{

public:

IStyle b_Flags; //DWORD

flag - access these using the HasFlag macros, instead of directly

DControl* b_pDControl; //Pointer to the top of the BPtr chain

LPARAMb_Param; //Misc extra parameter

EFormatDisplay* b_pFormat;

BObject* b_pContainer; //QRecord*, ALocalTableColumn*, TLocalTable*,

};

BGSMsg may serve as a message container. That is, every call to any of the Get/Set routines can have a full suite of parameters passed in so that the objects always know who is querying them and for what purpose. Then the results can be tailored to fit the context as shown in the following example:

BString->GetAsString(BGSMsg(FLAG_Display)) -> "Hello"

BString->GetAsString(BGSMsg(FLAG_SQLSAVE)) -> "'Hello'"

BString->SetFromString(BGSMsg(FLAG_Input)) -> "Hello"

BTime->GetAsString(BGSMsg(FLAG_Display)) -> "July 4, 2002"

BTime->GetAsString(BGSMsg(FLAG_Input)) -> "07/04/02"

BTime->GetAsString(BGSMsg(FLAG_SQLSAVE)) -> "36121.12"

BNumber->SetFromString("36121.12",BGSMsg(FLAG_Input))

BTime->SetFromString("36121.12",BGSMsg(FLAG_Input)) is not allowable because the BTime->SetFromString("36121.12",BGSMsg(FLAG_Data)) equals 7/4/2002, the 36121st day since 1900. BNumber->SetFromString("07/04/2002",BGSMsg(FLAG_Input)) would perform division twice.

Consider the last 2 entries above. The string "07/04/2002" if put into a BTime object will yield a valid date, but put into a BNumber it would try to divide 7/4 then take the result and divide by 2002. So BTime descends from BNumber, but interrupts the SetFromString function to put in separate logic for handling user input. Yet where the functions do not differ, both rely on the same base code.

BTime->SetFromString(SQLFetchedData, BGSMsg(FLAG_SQLFetch | FLAG_ResetDirty))

Consider these next two entries listed below. BImage holds a long image, like a jpg or bmp file. If a 50K image stream is to be inserted, and if that data is in memory, then the first call can be made. If the string representing the name and location of the file is known, that string can be entered and BImage will go there and get the image itself. The context flag FLAG_Input informs BImage that the string being passed in, for example, "C:/MyPhoto.png", is not an image stream, but rather is a regular string representing a location where the image file can be opened and imported.

BImage->SetFromString(My50KCStringBuffer, BGSMsg(FLAG_Data));

BImage->SetFromString("C:/MyPhoto.png", BGSMsg(FLAG_Input));

BGeneralTable is a data object that points to a small list of information. For instance, assume that a particular BGeneralTable points to a list with entries for phone types like, "Home", "Fax", "Cell", "Office". If the user inputs just the first 2 characters, "ce", BGeneralTable would look up “ce” on its list and interpret that user’s input as "Cell". If the user inputs an invalid entry, the entire list can be presented for a user’s selection from the list.

BGeneralTable->SetFromString("Ce", BGSMsg(FLAG_Input)); //Sets to "Cell"

In the following example, the input is the same "501", but the context determines the result. BForeignKey links to a DataDictionary object that has schema information about an SQL table called "SKU" which holds product information. The value held by BForeignKey is the ID of a SKU record.

BForeignKey->SetFromString("501", BGSMsg(FLAG_Input)); //Sets to ID: 962, Code: "501 Jeans"

BForeignKey->SetFromString("501", BGSMsg(FLAG_Data )); //Sets to ID: 501, Code: "Guess Jeans"

In the above example, if it is desired to sort an array of BForeignKey's, then the sorting may be based upon the ID number or Code. The value held by BForeignKey is the ID number. The code is a string format readable by the user. BForeignKey will decide the proper sorting method based on the context flag. If the context contains FLAG_UserSort, then the sort will be based upon the Code. On the other hand, if the flag is FLAG_Data, the sort will be based upon the integer ID number.

BObjects support many flags. Each flag is assigned a single bit which can be XOR'd together, ie 0x00000001 - 0x80000000. Exemplary flags and flag combinations are shown below.

FLAG_Data

FLAG_Input

FLAG_Display

FLAG_Description

FLAG_LookupDescription

FLAG_DisplayText

FLAG_SQLFetch

FLAG_SQLSave

FLAG_ResetDirty

FLAG_InIsDirty

FLAG_Revert

FLAG_GetOriginal

FLAG_AnswerForData

FLAG_NotifyDoc

FLAG_SetByUser

FLAG_FocusAction

FLAG_Find

FLAG_UserSort

FLAG_CustomFormat

FLAG_DirtyLoggingOff

FLAG_WhereData

FLAG_FullStringCompare

FLAG_ClipExport

FLAG_Serialize

FLAG_TransferToExtend

FLAG_Sort

FLAG_OnCopy

//BObject Flag Common Combinations

FLAG_FirstData FLAG_Data | FLAG_ResetDirty

FLAG_QueryResult FLAG_FirstData | FLAG_SQLFetch

FLAG_UserAction FLAG_Input | FLAG_NotifyDoc | FLAG_FocusAction | FLAG_SetByUser

FLAG_UserDataAction FLAG_Data | FLAG_NotifyDoc | FLAG_FocusAction | FLAG_SetByUser

FLAG_SimulateInput FLAG_Input | FLAG_NotifyDoc | FLAG_FocusAction

FLAG_SetAndNotify FLAG_Data | FLAG_NotifyDoc

FLAG_FindFirst FLAG_Data | FLAG_Find

FLAG_FindData FLAG_Data | FLAG_Find | FLAG_AnswerForData

FLAG_FindDisplay FLAG_Display | FLAG_Find | FLAG_AnswerForData

FLAG_WhereClause FLAG_Data | FLAG_SQLSave | FLAG_WhereData

FLAG_TextOnly FLAG_Display | FLAG_DisplayText

FLAG_FullSerialize FLAG_Data | FLAG_Serialize

FLAG_SetUDH FLAG_SQLFetch | FLAG_SQLSave

BPtr is a special type of BObject. In a way, BPtr sets up a chain system so objects can be nested, adding to their functionality and separating permutation problems into components which can be added together at will. This feature may be referred to as “Parent/Child Ownership using BPtr - Nesting Objects and Functionality.”

Any BObject function has the option to add functionality compared to its Parent Class. In addition, the BObject may call its Parent Class by using the function call format, MyParent::Function(). So for example, consider BTime which is based upon BNumber. As shown below, BTime can call the function “SetFromNumber(d)” from its Parent Class, BNumber.

BTime::SetFromNumber(d)

{

If (RangeOK(d)) //Added functionality

BNumber::SetFromNumber(d); //Call to Parent Class

}

In addition, there is the option of adding functionality by using BPtr’s. BPtr is a BObject that owns another BObject. Consider the example below:

class BPtr : public BObject

{

BObject* p; //Can a BString, BTime, etc.

//BPtr has overrides for all of BObjects virtual functions.

//By default, each function calls p->Function(Parameters);

}

By itself, BPtr does not have additional functionality, but it can call the BObject that it owns. However, the children of BPtr have a third option that BObjects do not have. This additional option creates enormous possibilities for nesting functionality as shown below:
Add functionality
Call their Parent Class - MyParent::Function();
Call their owned object - p->Function(); This object in turn can
Add functionality
Call its Parent Class

As a further example, this BPtr shown below is called BrevertablePtr:

class BRevertablePtr : public BPtr

{

BObject* pOriginal;

bool Revert();

bool IsDirty();

etc.

}

A BRevertablePtr stores 2 BObjects, the “current object” which is stored by BPtr, plus a copy of a saved “original” object. If given a BRevertablePtr that owns a BTime which is set to 7/4/2004, the code would resemble the following:

BRevertablePtr -> BTime(7/4/2004)

The owner of the BRevertablePtr does not really care if it owns a BTime or a BRevertablePtr, because the API is the same either way. So given a list of dates:

BObject* pMyTime;

pMyTime = new BTime(36121);

pMyTime->GetAsString(BGSMsg(FLAG_Input)) -> "07/04/02"

Although the above example is straightforward, now substitute BRevertablePtr for BTime in the second line above:

BObject* pMyTime;

pMyTime = new BRevertablePtr(new BTime(36121));

pMyTime->GetAsString(BGSMsg(FLAG_Input)) -> "07/04/02"

So the owner of pMyTime owns a BRevertablePtr that owns the BTime. The owner is simply a BObject, not typed to be a BTime. pMyTime doesn't care what it points to because the GetAsString function is the same and the return value is the same. BRevertablePtr will simply pass the function call to its owned object, the BTime object, and return the result. The key to BRevertablePtr is that it can make the decision to call BTime when necessary, but it can also add its own functionality to BTime. Consider the following example:

pMyTime->SetFromString("12/25/99");

This call is sent to BRevertablePtr. In a simplified version, BRevertablePtr may perform the following:

BRevertablePtr::SetFromString(CString str, BGSMsg bgsmsg)

{

if (HasFlag(FLAG_ResetDirty))

{

FreePointer(pOriginal);

return;

}

else if (pOriginal == NULL)

pOriginal = p->GetNewCopy();

BPtr::SetFromString(str, bgsmsg); //This will go ahead and call BTime with "12/25/99")

}

So now BRevertablePtr may return these values:

pMyTime->GetAsString(BGSMsg(FLAG_Input)) -> "12/25/99"

pMyTime->GetAsString(BGSMsg(FLAG_Input | FLAG_GetOriginal )) -> "07/04/02"

BRevertablePtr also supports other features. Revert() will restore the original object. Setting an object's value back to its original value will automatically mark the object as “Clean” again. So every data cell in the program can be reverted back to its original value. This providees the ability to handle a third value just prior to initiating a transaction that supports rollback. Two different kinds of functionality are embedded in the classes. The BPtr handles one type and the single value BObject handles the other. These can be ADDED together. The BObject could be of any type, a BTime, a BImage, etc. Adding functionality together is a linear, not geometric expansion.

Building further on that, QRecordcolumn, as illustrated below, is a BRevertablePtr. QRecordcolumn stores one value from a SQL Row. So the basic SQL command, "Select * from Orders where Orders.ID = 5," returns all the columns in one SQL Row. This is stored as a QRecord object which holds an Array of QRecordcolumn's. Each QRecordcolumn is a BRevertablePtr which could in turn hold BTime, BString, BTrackingNumber, BForeignKey objects, etc. When a message is passed to QRecordCoumn it can do Record-related actions first, then its parent BRevertablePtr::Function(), which will handle its own logic, will then pass the call down eventually to the final Single Value Object at the bottom of the chain.

QRecordcolumn::SetFromString(str, BGSMsg(flags))

{

bool rtn = BRevertablePtr::SetFromString(str, BGSMsg)//Calls Parent.

if (rtn)

q_pParentRecord->OnDataChange(this); //Notify Owning QRecord

return rtn;

}

Next, a BPtr such as DControl is considered. A DControl is a “virtual control” of the exemplary system. It contains a pointer to some data, plus all the graphical info needed to render the object. Like all BPtrs, DControl can trap a Set Command, do some processing, and can call its parent class or the function of its contained object

DControl::SetFromString(str, BGSMsg(flags))

{

SaveDataInCaseRejected

d_pParentDocument->GetLookupFilters(this)

if (BPtr::SetFromString(str, BGSMsg(flags, this))); //Call to another BObject's SetFromString

d_pParentDocument->NotifyOfControlChange(this)

BPtr::MarkDirty() //Call to ParentClass

}

Now, the following example illustrates how multiple BPtr's can be nested together.

DControl -> QRecordColumn -> Bint

//SQL Basic Integer

DControl -> QRecordColumn -> Bstring

//SQL Basic String

TControl -> QRecordColumn -> BForeignKey -> BInt

//SQL Related Table (Foreign Key) using UID

DControl -> QRecordColumn -> BForeignKey -> Bstring

//SQL Related Table (Foreign Key) using string Key

DControl -> Bstring

//Misc String -> not SQL Based

DControl -> BForeignKey -> BInt

//Misc Table Lookup, But not linked to a related Table

DControl -> BGeneralTable

//Misc GT Lookup

TControl -> QRecordColumn-> BForeignKey -> BInt

//SQL Related Table (Foreign Key) using string Key

Since DControl, QRecordColumn, and BForeignKey are all BPtr’s, they each contain some other BObject. BInt, BString, and BGeneralTable are not BPtr's, but rather are the “end of the line” in each example. The BPtr system allows for a nice clean API. If the user types "Guess Jeans" in a CEdit, the view simply calls:

myCEdit.pDControl->SetFromString("Guess Jeans", BGSMsg(FLAG_Input))

DrawDocument()

Draw( myCEdit.pDControl->GetAsString(BGSMsg(FLAG_Display)))

This command will just keep passing the message down the chain until all the work is done. Referring to the last example from above, the Root Object is TControl. TControl has the option to use the functionality of any of its parents (DControl, BPtr, BObject) or to call upon its enclosed object, a QRecordColumn. This object in turn can call its parents or its enclosed object. In this way, a single call to TControl->SetFromString() can allow all of these classes below to weigh in, each adding its own functionality:

TControl QRecordColumn BForeignKey

DControl BRevertableBPtr BUID

BPtr -> BPtr -> BPtr -> BInt

BObject BObject BObject BObject

The root object is TControl. Messages are passed down to parents, or across, via the BPtr to another object. Some of these, in turn will notify other classes such as their collection or container classes, TLocalTable, QRecord & DDocument or other classes such as QRecordColumnTemplate, EDisplayFormat, etc. Here is a simplified sample of the cascade of calls:

TControl::SetFromString(str, BGSMsg(flags))

{

bool rtn = DControl::SetFromString(str, BGSMsg(flags))

If (rtn && (dups not allowed then))

{

if (Value is a dup)

{

Revert();

return FALSE;

}

}

if (rtn)

t_pTable->OnDataChange(this, BGSMsg(flags));

//Notify owning TLocalTable

return rtn;

}

DControl::SetFromString(str, BGSMsg(flags))

{

SaveDataInCaseRejected

d_pDocument->GetLookupFilters(this)

bool rtn = BPtr::SetFromString(str, BGSMsg(flags, this)); //Calls Parent.

if (rtn)

d_pDocument->OnDataChange(this, (this)

//Notify Owning DDocument

return rtn;

}

BPtr::SetFromString(str, BGSMsg(flags))

{

p->SetFromString(str, BGSMsg(flags));

//Calls QRecordColumn::SetFromString

}

QRecordColumn::SetFromString(str, BGSMsg(flags, DControl))

{

bool rtn = BRevertablePtr::SetFromString(str, BGSMsg)

//Calls Parent.

if (rtn)

q_pParentRecord->OnDataChang(this); //Notify Owning QRecord

return rtn;

}

BRevertablePtr::SetFromString(str, BGSMsg)

{

if (!HasFlag(FLAG_ResetDirty) && !pOriginal && p)

!pOriginal = p->GetNewCopy();

return BPtr::SetFromString(str, BGSMsg))

//Calls BForeignKey::SetFromString

}

BPtr::SetFromString(str, BGSMsg(flags))

{

p->SetFromString(str, BGSMsg(flags));

//Calls BForeignKey::SetFromString

}

BForeignKey::SetFromString(str, BGSMsg)

{

if (HasFlag(FLAG_INPUT)

{

int RecordID = LookupString(str)

if (RecordID)

return BPtr::SetFromNumber(RecordID, BGSMsg);

//Calls BInt::SetFromNumber

else

DControl->Reject()

}

else

return BPtr::SetFromString(str, BGSMsg); //Calls BInt::SetFromNumber

}

BInt::SetFromNumber(d, BGSMsg(flags, DControl))

{

if (b_int != d)

{

b_int = d;

MarkDirty(bgsMsg) //Calls back up the chain again to let everyone know something has happended

return TRUE;

}

return FALSE;

}

Although this may seem like a lot of calls to change one number, it creates an incredibly powerful structure, with a simple uniform API. Every possible owner has weighed in with its own inputs about the set. The Document is notified, the owning record, dups where check, reversion is managed, etc. Further, the functionality of all of these classes can be mixed and matched together with either none or very insignificant geometric expansion of code, or any code inside the business rules document. In the exemplary system, all the code is embedded into the layers of the exemplary system.

New functionality can be inserted by creating a chain of BPtrs. There is a type of BRevertableBPtr called a TBRevertableBPtr. This object may have all the functionality of BrevertableBPtr’s, but may also add the ability to have the cell of a LocalTable have a custom format, different than every other cell in the same column. When a TLocalTable is created from SQL Data, the data is put into Single Value Data Objects like BTime, etc. To include both the reversion and custom formatting ability on top of BTime's logic, TBRevertableBPtr can be inserted into the chain.

So if one starts with

Array[3]= *myBTime;

One can insert the reversion feature by performing this:

TBRevertableBPtr* pMyTptr = new TBRevertableBPtr;

pMyTptr ->p = Array[3];

Array[3] = pMyTptr ;

So now one has:

Array[3]= pMyTptr -> myBTime;

These types of operations are done automatically by the array class itself. Developers may interact with the exemplary system by adding to the Framework. One method for adding to the exemplary system that was alluded to above was the concept of an “expansion list.” An expansion list may be a table owned by the exemplary system and initiated at startup. It is part of the local copy of the Data Dictionary. One such expansion list is a list of all the BObject Types that are supported. Each BObject type has a corresponding BIRuntimeClass object which specifies many attributes and default features of a BObject, including the following:
Pointers to functions that can be used to create an instance of the object.
Default Formating, justification and preferred viewing control information
Default Attributes (to be described with the Task Variation feature below)
A Variety of Attribute Flags:

B_IsCObject

B_IsBObject

B_IsMFCClass

B_UseWithSQL

B_AutoCreate

B_AutoDelete

B_IsUseableAsKey

B_IsDataNumeric

B_IsDataString

B_IsDataBinary

B_IsDisplayNumeric

B_IsDisplayString

B_IsDisplayImage

B_IsDataDate

B_IsDataLongText

B_UsesGetSetAPI

B_NoReversion

B_NeedsObjectSerialize

B_Lookup

B_RootObject

Etc.

Developers may add their own BObject classes and notify the exemplary system’s framework of their existence by creating a BIRuntimeClass instance and appending it to the exemplary system's Expansion list. It will then become a part of the Data Dictionary with the same status as the exemplary system’s created classes like BTime, BForeignKey, etc. Each BObject instance points to the corresponding BIRuntimeClass. That is, if one hundred BTime objects are created, each one will point back to the same BIRuntimeClass object in the Data Dictionary and have access to all of its functionality at all times.

“Data Containers” and “Collection Classes” hold multiple BObjects:

Collection Classes
AArray & TLocalTableColumn - Basic and Specialty Arrays. Most BObjects can be placed into generic Arrays, however some specify that they prefer to be placed into custom Specialy Arrays which perform additional useful functions including managing column g roupings and complex data dictionary relationships. The BIRuntimeClass for a BObject will specify a Specialy Array that should be used for a particular type of BObject.
TLocalTable - A group of Arrays. (The term 'Local' table is used to distinguish a client-based table, from a server-based 'SQL' Table.)
BDataCatalog - Named Object Table (This is both a Single Value Object and a Container)
QRecord - holds a client-based copy of a single SQL Row
DDocument - Composite container which holds any type of collection class.

Referring to FIG. 4, the BObject System may be part of the TCTools, which replace much of MFC's layer 3. Some of the more sophisticated BObjects, such as QRecordColumn are database specific, and therefore they exist at Layer 4. The Data Collections all exist at layer 4. The main data container, DDocument, is actually Layer 5. The Data Containers allow developers to hold and manipulate data in a variety of ways, but all of the Data Containers have a consistent API for data access. This API is the same as the API for BObjects, with the minor addition of a few extra parameters that inform the container which contained BObject should is being referenced. Consider the following Data Containers:
BObject::GetAsString(BGSMsg)
AArray::GetAsString(row, BGSMsg)
TLocalTable::GetAsString(ColumnName, row, BGSMsg)
QRecord::GetAsString(ColumnName, BGSMsg)
BDataCatalog::GetAsString(RowName, BGSMsg)
DDocument::GetAsString(ColumnOrControlName, BGSMsg)
etc. Each standard BObject API is replicated by a Container.

Like BPtr's, Data Containers have the option of adding to the functionality of API calls prior to calling the contained BObject's API. For Example, AArray::SetFromString() will determine if the column is owned by a TLocalTable. If it is, the TLocalTable will get a notification that a BObject changed. The TLocalTable will determine if it is owned by a DDocument. If it is, then the DDocument will get a similar notification, etc.

Data Containers link to the Data Dictionary. For example, a TLocalTableColumn (a type of AArray) owns a pointer to a QTableColumnSchema object. So the data column knows everything that is known about the SQL Column including what format it uses, what SQL Table owns it, information regarding Foreign Key relationships, etc.

Referring back to the Layer 5 Framework diagram, which is FIG. 15, Data Collections are the main interface to SQL. So, when data is loaded from the SQL Server each value is placed in a BObject and then attached to a generic collection class such as TLocalTable or QRecord. Then the Data Collections are linked to the Data Dictionary. Information there may allow the Data Collections to reorganize the data.

Virtual Controls are created and point to BObjects inside the Data Collections.

Virtual Controls are BObjects and so are the Data that they point to inside of a collection class. The entire API is completely uniform and function calls bounce around logically so that they hit every relevant object. Functionality is nested so that functions can be added regardless of data type. For example, the Viewer points to the controls. The control could point to a QRecordColumn, a TBRevertablePtr inside of a TLocalTable, a BDataCatalog value (represented by the Misc data container in the diagram). The function calls though are the same either way, yet every party that is interested is notified and every rule in the Data Dictionary has an opportunity to be implemented.

Consider 4 objects:

1. A QRecordColumn Called "CompanyID", which is shown on the screen (has a Virtual Control)

2. A QRecordColumn called "IsRushOrder" which is not shown on the screen, (has no Virtual Control)

3. A Miscellaneous calculated field called "Orders for last 30 days", not represented on the server, but shown on the screen (has a Virtual Control)

4. A Miscellaneous calculated field called "TimePrinted", not represented on the server nor shown on the screen.

This example illustrates that very simple code can be written to access and manipulate this data, regardless of where it is. The exemplary system may minimize the code that a developer must write, yet the code handles all cases, notifications, and functions as if the developer had meticulously handled every detail. So, to set this value the developer would type:

SetFromString(“AnyColumn",“xyz”)

To implement this TruCore has these functions

DDocument::SetFromString(ColumnName,str, BGSMsg)

{

GetObjectPtr(ColumnName)->SetFromString(str);

}

DDocument::GetObjectPtr(ColumnName)

{

If (FindMatching DControl)

return DControl

if (Find Matching QRecordColumn)

return QRecordColumn

if (FindMatching DataCatalogEntry)

return DataCatalogEntry

}

Notice that GetObjectPtr returns 4 different values for the 4 different cases:

1. DControl -> QRecordColumn -> BForeignKey -> BInt

2. DControl -> QRecordColumn -> BBool

3. BRevertablePtr -> BDouble

4. BRevertablePtr -> BTime

The developer’s code does not have to write any custom code to handle this. The developer’s one line API call will access QRecord functionality if the item is a QRecordColumn and/or DControl Functionality if the item is displayed.

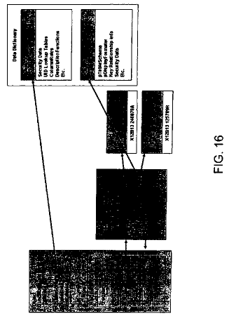

FIG. 16 is an exemplary diagram depicting aspects of the BPtr system. Contrast the following structure, FIG. 16, with the simplified exemplary structure described in the problem above wherein a TrackingNumber was merely stored as a string. Here, the data is encased within the BObject/BPtr and Data Collection Classes so at every single step of the way, everything that could be known and every bit of functionality that can be done generically, is available.

Two particular BObjects are now described in detail. The first is called BForeignKey. A Foreign Key is an SQL column which points to a row in another SQL Table. For example, OrderItem.SKUID is a Foreign Key. The OrderItem.SKUID column holds the value of a SKU.UniqueID. As an example, consider the following:
OrderItem.UniqueID = 100704
OrderItem.SKUID = 108
SKU.UniqueID = 108
SKI Code = "GuessJeans"

In this example OrderItem# 100704 is an order for GuessJeans. But rather than copy the name "GuessJeans" to the OrderItem Table, the UniqueID, 108, is the only thing copied. This is a standard programming convention. It allows users to change data on the SKU, without affecting all of the orders. So changing the name to "GuessJeansXL" does not affect the order, because the ID, 108, is unchanged.

In any database program, there is a lot of code utilized to work with foreign keys. If the user wants to see all the columns for an OrderItem, the user probably does not really want to see SKUID = 108. Instead, the user wants to see "GuessJeans." So the substitution must be made prior to the user seeing the value. Also, if the user is entering a new Order and types in "Guess," the system should allow the user to pick either "GuessJeans" or "GuessPerfume." BForeignKey encapsulates all of the complexity involved with Foreign Keys. For instance, consider the issue of resolving or looking up "Guess" to find the right SKU.UniqueID. With most systems, the code to perform the lookup would be built into the Order Document. Many other screens may need to lookup SKUs too such as the SampleKit Screen, the PriceList Screen, etc. Each screen would have separate code to perform the lookup. With BForeignKey, all of this code is avoided. In the Data Dictionary, the developer specifies which columns in SKU should be searched, which columns should be shown to the user when more than one candidate is found, what order should the result rows be shown, what columns should be shown when the user has picked a SKU, etc. Then, also in the Data Dictionary, OrderItem.SKUID, SampleKit.SKUID, PriceList.SKUID, etc. are all defined as BForeignKeys pointing to SKU. This is all the code that is required. All Foreign Keys pointing to SKU now have the exact same interface. All of the complexities are then buried into BForeignKey.

Layer 4 of the exemplary system contains a toolkit which is used to query a database. These tools work together with collection classes to retrieve and save data from the SQL database. The classes work together with the BObject system to allow complex loading. This following example is somewhat complex, but it is all designed to make the developer’s life as easy as possible:

TLocalTable

myTable;

QQuery q("Select * from OrderItem where OrderID=5 AUTOJOIN.ALL ", &myTable);

These simple lines of API code are all that is needed to fully populate myTable. The collection classes, working the query parser, link all of the data to the Data Dictionary. So each TLocalTableColumn in the table will have a link back to the Data Dictionary, to point to a QTableColumnSchema object. Here it will find any custom information that the developer included about a column. For example, consider the OrderItem.SKUID column. SQL recognizes this simply as an integer. But to the exemplary system it is part of a whole interconnected system of data management. The following is a discussion of how QQuery & TLocalTable process the retrieval of data from OrderItem.SKUID.

There is a Data Dictonary Table on the SQL server called jColumn. This table holds information about several OrderItem columns. TruCore retrieves this information as part of its initial load cycle and from it, TruCore creates QTableColumnSchema objects that match the data in jColumn.

QQuery notifies TLocalTable that there is a QTableColumnSchema available for OrderItem.SKUID. TLocalTable reads the QTableColumnSchema and sees that OrderItem.SKUID uses the BForeignKey data type. TLocalTable will then take that information and lookup BForeignKey in the Expansion List of BObjects. It will retrieve a matching BIRuntimeClass object.

The BIRuntimeClass record indicates the BForeignKey uses a specialty array. Instead of TLocalTableColumn it uses the more robust descendend called ALookupColumnFK. BIRuntimeClass contains a function that can create a ALookupColumnFK object. This ALookupColumnFK will then take over the process of populating the column. It will perform the following:
Check the QTableColumnSchema column for OrderItem.SKUID to see which Foreign Table it accesses.
Find the matching QTableColumnSchema entry for SKU.UniqueID
Create one BForeignKey object for each result row in QQuery and attach it to the array
Initialize the BForeignKey by giving it pointers to both QTableColumnSchema's (one for OrderItem.SKUID and one for SKU.UniqueID)
Send the raw integer that was retrieved from the query into the BForeignKey.
Check for additional columns that have to do with SKUID . The AUTOJOIN.ALL parameter caused the simple "Select *" query to be rewritten by QQuery, adding several data dictionary defined columns to the *(See the example above). ALookupColumnFK links all these columns together and reorders the columns so the SKU columns appear to the right of the OrderItem.SKUID column.
If the SKU has a key column, like SKU.ProductCode, this column is 'merged' into the BForeignKey column and then the old column removed.

The Second BObject that deserves special mention is BDataCatalog. BDataCatalog is the most complex BObject. BDataCatalog is a collection class that descends from TLocalTable. Accordingly, it can hold multiple BObjects. But it also acts just like a regular single Value data object itself as will be described below in more detail. In addition to the objects listed above, the following is a list of objects currently that may be part of the BObject System:

BBarCode

BDNS &/or BIPAddress

BRichText

BHTML

BMP3/BAVI/BWAV

BStockSymbol

BEmail

BCreditCardNumber

BGraph

BDeadline or BDueDate

BPassword

BMoney

BNetDebit

BMarkup, BGrossProfit

BLanguage

BCGIInput

BLength

BVolume

BWeight

BTemperature

BBodyTemperature

BBloodPressure

BStarRank

BURLBinary

BName

BSSN / BEIN

BPhoneNumber

BAddress

BZipCode

BGlobalPosition

BCountry / Bstate

All BObjects may have custom functionality that supports the user’s experience. The BTime data type provides users with a Calendar to select a date. The BColor data type provides the users with a Color Wheel. BImage allows users to pull in a file. The BTrackingNumber data type will search the UPS website to track a package. BForeignKey allows the user to jump to the record being pointed to. All BObjects share a common API and can be held by any data container, such as an Array or LocalTable.

The exemplary system provides for object support:
Runtime Class Support
Entry Filters - a system to allow developers to define allowable characters and formatting place holders
Display Formats - a system to allow developers to define string formats, such as currency, percent, date formats, etc.
Clipboard support.

The Runtime Class, Entry Filter and Display Format systems all allow Application Developers to create their own rules. However TruCore has already used these systems to create the most common rules. So for example, TruCore has registered Entry Filters such as SSN, Zip+4, Visa, Phone10, IP4, etc.

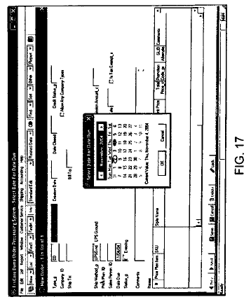

FIGs. 17 – 43 are examples of the interfaces that the BObject system makes available with very little work on the part of developers:

FIG. 17 is an exemplary screen resulting from Input Help for BTime, wherein BTime shows a calendar.

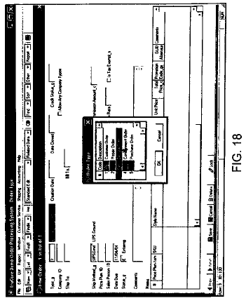

FIG. 18 is an exemplary screen resulting from input help for BGeneralTable, wherein the user can pick from a list of choices relating to Order type.

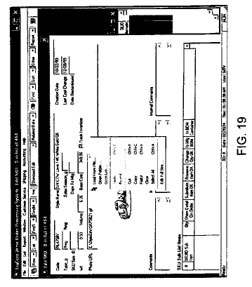

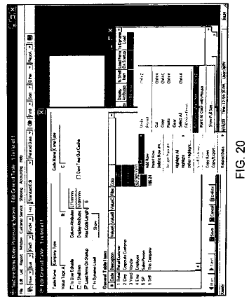

FIG. 19 is an exemplary screen popup related to BURL. The “Copy” and “Paste” features are supported by BURL’s parent, which is BString. The “Load From File” options are added by BURL. The “Revert” function is added by QRecordColumn's parent, BrevertablePtr.

FIG. 20 is an exemplary screen for a popup related to BColor. In this figure, one can see on the left are options supported by TLocalTable which is the collection class that owns the BColor Object. On the right are options supported by the chain of BPtrs owned by the TLocalTable. TBRevertableBPtr supports Revert, BColor supports the color wheel and BString supports the clipboard features.

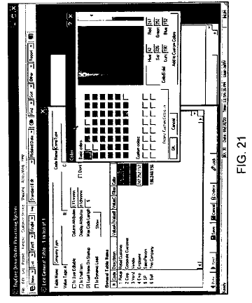

FIG. 21 is an exemplary screen that allows access to the user of the color wheel.

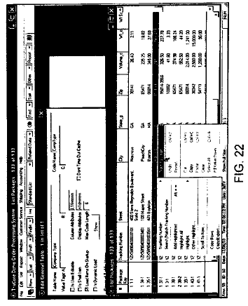

FIG. 22 is an exemplary screen of a popup for BtrackingNumber, which can be used to determine if UPS delivered this package to Palmyra, WI.

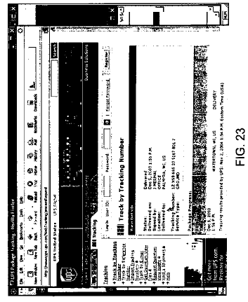

FIG. 23 is an exemplary screen wherein UPS confirms that the package was delivered to Palmyra, WI.

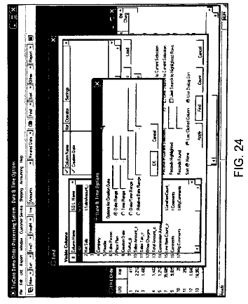

FIG. 24 is an exemplary screen in which BTime help is used for a search dialog. Popup options are not only dependent on which BObject is selected, but also the context. Here on the Find Screen 2410, BTime supports some search range options that do not normally apply to BTime objects on other screens. The BGSMsg allows so much information to be passed into BTime that it always knows where it is, who owns it, what AQTableColumnSchema it points to etc.

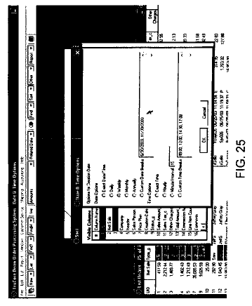

FIG. 25 is an exemplary screen in which BTime help is used for sort screen. On the Sort Screen 2510 a different kind of help box is needed. BTime supports that too.

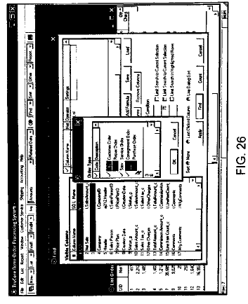

FIG. 26 is an exemplary screen associated with BGeneralTable Help for Find Dialog. One may notice that the lookup dialog box for BGeneralTable used on the Find screen 2610 is similar to the one that appears when the user is looking up a GeneralTable value on the Order Screen. But on the Order screen the user is picking one value. Here the user is checking off any number of values, including the first item which is the 'blank' value. Notice that these dialogs are similar but slightly different. These differences are easily handled as indicated in the description related to “List Variations” below.

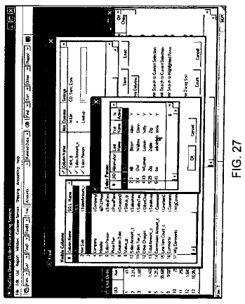

FIG. 27 is an exemplary screen in which the BForeignKey help is used to support the Find screen 2710 to search for a salesperson based on SalesPersonID. BForeignKey supports the “?” option by showing the user all available choices.

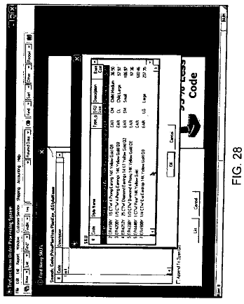

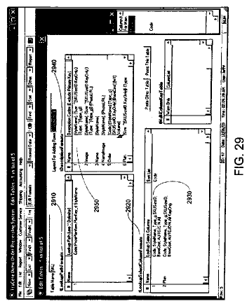

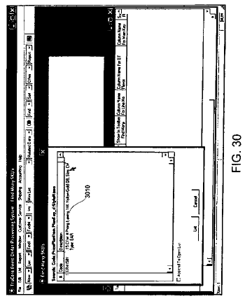

FIG. 28 may be used to examine a BUID lookup function in more detail. [Note: BForeignKey is a type of BUID and they share much of this functionality]. In FIG. 28, the user is trying to find a SKU that begins with the code “er4.” Near the top of the window the user is notified of the Search Path, “Code, PricePlanItem.PlanKey_d and StyleName” 2810. That means that the BUID will first query SKU.Code = “er4%.” If nothing is found, it will move on to PricePlanItem.PlanKey_d, etc.

FIG. 29 is an exemplary screen that relates to SKU Data Dictionary Settings. A user may see a data dictionary entry called tLookupPathFormats 2910. Here the developer informed the exemplary system about the search path. Then look at the Data Dictionary entry for tLookupSelectColumnFormats 2920. Here one will see the value “Code, StyleName, Type_g,SKUSizeID, BaseCost, AUTOJOIN.All” 2930. Since more than one match was found for “er4%,” BUID may display some choices for the user. The tLookupSelectColumnFormats entry screen 2920 tells BUID which columns to show. The 7 choices below were formatted from that information. Notice that the SKUSizeID column has been replaced automatically with a complex join, giving the user a much more readable “SKUSize.Code” and “SKUSize.Description.” The resolution of that join is performed by the exemplary system using similar Data Dictionary entries. In FIG. 29, one may notice now the third BUID-related Data Dictionary entry called tDescriptionFormats 2940. The developer is determining which columns are to be used for the description of a SKU. Compare the first entry 2950 in the tDescriptionFormats 2940 with the value 3010 in FIG. 30 that the cursor is pointing to. That value was derived from the first tDescriptionFormats string.

FIG. 30 is an exemplary screen depicting use of the BForeignKey as it relates to the display of results of a lookup. The description column does not contain the string “.15 CTW...”. Instead, it is simply a BPtrDescription, which is a small BPtr that points to the BObject in the code column. The BPtr simply adds FLAG_Description to every message it sees and then passes the message to the object it points to. BUID::GetAsString() will see the FLAG_Description and return a value based on tDescriptionFormats rather than the Code. But the beauty of the BPtrDescription is that all other functions also pass on to BUID. So by pointing at the description and right mouse-clicking, the pop-up menu will support BUID functions, like the ability to go to the SKU Record.

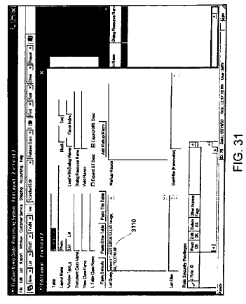

FIG. 31 is an exemplary screen wherein PricePlanItem Data Dictionary settings. Here, the PricePlanItem Photo List screen will also resolve its PricePlanItem.SKUID ForeignKey. Notice that the entry that says AUTOJOIN.SKUID.Image, AUTOJOIN 3110 uses tDescriptionFormats in a slightly different way than BUID in that it adds columns to a list. Here the word “Image” tells TruCore that instead of using the first entry in tDescriptionFormats (the default entry), it should look for the entry named “Image.” The user can see this entry two figures back. The AUTOJOIN.ALL flags tells the remaining BForeignKeys to use their default settings in their respective tDescriptionFormats Data Dictionary entries.

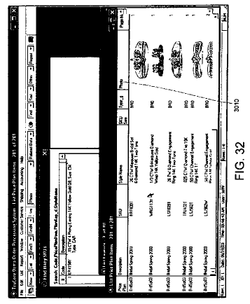

FIG. 32 is an exemplary screen wherein PricePlanItem List uses SKUID.AUTOJOIN.Image. In this figure, the PhotoURL Column 3210 has been added. PhotoURL is a BURL. Notice also that to SQL the value in PhotoURL is just a string. The exemplary system knows to resolve it as an image.

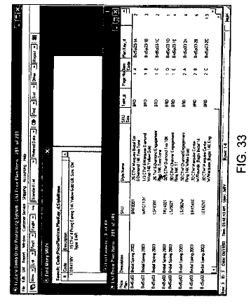

FIG. 33 is an exemplary screen in which PricePlanItem List uses AUTOJOIN.ALL. This view has no image because it uses the default entry for tDescriptionFormats.

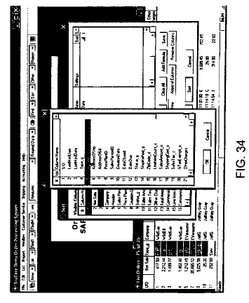

FIG. 34 is an exemplary screen in which the “More Columns” button 3410 (not shown) allows “drilling” to other tables. Here, the user is sorting a list of orders. A normal list of orders does not show a companies credit status. But today the user decides that he wants to see that information. The “More Columns” button allows the user to chase ForeignKey relationships and find more columns. This is another feature of BForeignKey.

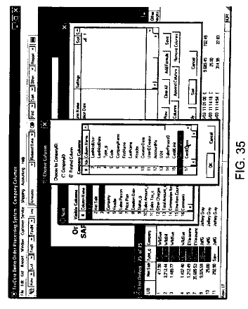

FIG. 35 is an exemplary screen in which the drilling continues to all columns in the related company table. Here, the process is managed by BForeignKey for CompanyID.

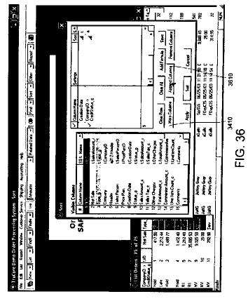

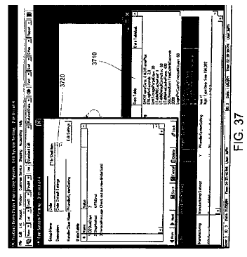

FIG. 36 is an exemplary screen in which an extra column appears after clicking on Append Columns button 3610. The List Orders screen 3620 shows that order number 1 was shipped to a customer who is currently on credit hold.

FIG. 37 is an exemplary screen whereby BdataCatalog is the most complex Bobject. This will be described below in more detail. BdataCatalog acts both like a TlocalTable, and also like a single Value Bobject. Notice that the “Data Table” column 3710 in the highlighted row simply looks like text, just like the values next to it like “Order Default Settings.” Yet while “Order Default Settings” loads in a regular text edit box 3720, the Data Table loads in Table. In the highlighted list the FLAG_Display causes BdataCatalog to return the table as a single string formatted with “Name: Value”+Carriage returns, etc for each line. Yet when the row is loaded into a window, it appears as a full blown table, much like one that was created as a separate listing of data from a related file. The entire value of the BdataCatalog object can be set with BdataCatalog->SetFromString(BinaryEncapsulationOfTable, FLAG_SQLFetch).

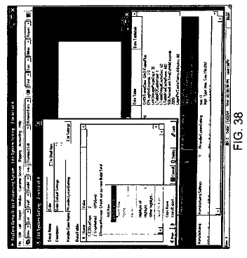

FIG. 38 is an exemplary screen in which a “Typed Row” has been added. Here, the user is not just adding a row of strings to type in. He can specify what data type it is.

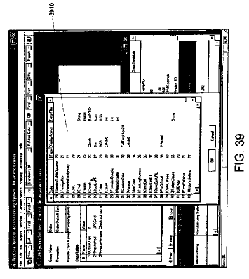

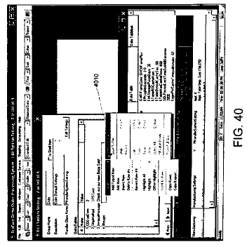

FIG. 39 is an exemplary screen related to how BdataCatalog relates to Select DataType. This list is derived from the expansion list of BIRuntimeClass objects 3910. Any types of data that a developer creates will be added to the list supplied by the exemplary system.

FIG. 40 is an exemplary screen in the user has selected the data type Bimage. Notice that the object now shows Bimage’s popup choices. Now the user will select “Load From File” 4010 to show the image of a teddy bear.

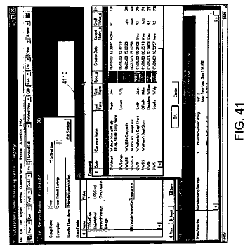

FIG. 41 is an exemplary screen in which BdataCatalog is used to add another type of data – a BvariableForeignKey. This type can point to any record in the database and can even change what table it points to (the table is variable). The user types in “Company w” and up pops a window 4110 displaying a list of companies that begin with a “w.”

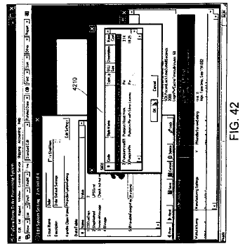

FIG. 42 is an exemplary screen in which BdataCatalog is used to pop up a screen 4210 displaying three SKU’s that begin with “pumpkin” when the user types in “sku pump.”

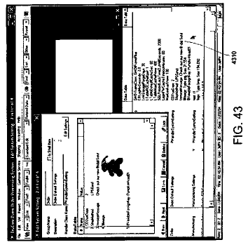

FIG. 43 is an exemplary screen in which the user has now saved the record. The cursor points to a description 4310 that shows a text summary of table entries. The Bimage, unable to show the teddy bear mixed in the text field, simply described what it knew about the image (its type and size). The BvariableForeignKey holds an integer, the value of a SKUID. But it resolves as the very readable “PumpkinHead01.”

Thus, up to this point in this application, one can see that The Framework Layers 4 (e.g., the exemplary system) set up our main structure including our Data Dictionary entries. The Bobjects system at Layers 3 and 4 is used to build data relationships and link everything to information in the Data Dictionary. The Ddocument system, which is Layer 5, holds everything together and provides a framework for developers to use API calls and yet manage highly complex relationships underneath it all.

An aspect of the present invention is task and audience variation. Task and audience variation enables the presentation to the users variantions of different documents (also referred to as task) without requiring the developer to produce customized code for generating and rendering the data in distinct ways for each variation according to the rules defined for each task/variation combination. In the illustrative system, for example, a given screen (e.g., a document) may have several versions (or variations), each with slightly different rules. For example, please refer to Table 1 below for possible variations to certain document types.

| | |
|---|---|
| Document | Variations |
| Orders | Sales, Repair, Service, Consignment, Purchase |
| Company | Vendor, Customer, Employee, Self, Salesperson |
| Account Transaction | Cash Disbursement, Cash Receipt, Accts Payable, Accts Receivable, General Journal |

TABLE 1

It is desirable have these variations coexist with minimum effort, thus reducing code expansion within the Application due to permutations. As discuss herein, a technique for handling permutations inside the framework layer, rather than cluttering up the application layer, is to move from an action-based document to a description-based one. That is, the application layer should describe what it knows, and let the framework layer take action based on those descriptions. This is done by utilizing attributes defined by the application for certain data presented to the user and then filtering the data presented to the user based on these attributes of the data elements.

Thus, the application layer is responsible for describing each data element on a form. The framework layer then sets up about the attribute options. For example, the attribute options may include AT_IsEnterable, AT_IsMandatory, AT_QueryWhenBlank, AT_IsCalculation, AT_IsAlwaysBlank, AT_IsValueHidden, and AT_IsCaptionHidden. The application layer is responsible for picking Yes or No values for these options and then the Framework layer will create a view of the document based on the application layer’s descriptions for each object.

The developer’s interface for this is very simple. Although may be presented with a plurality of options for which the developer will designate Yes or No. In the illustrative system, there are 12 option and about 20 combinations of interest in this illustration. As illustrated in Table 2 below, a single letter is assigned to each meaningful combination. For example, here are some of the most common attribute letters:

| | | | |
|---|---|---|---|
| Common Name | Letter | Options | Display Color |
| Enterable | 1 | AT_IsEnterable | White |
| Question if Blank | q | AT_IsEnterable, AT_QueryWhenBlank | White |
| Mandatory | m | AT_IsEnterable, AT_IsMandatory | White |
| Calculation | c | AT_IsCalculation | Light Blue |
| Not Used | y | AT_IsValueHidden, AT_IsCaptionHidden, AT_IsAlwaysBlank | N/A |
| Hidden | n | AT_IsValueHidden, AT_IsCaptionHidden | N/A |
| Variance | v | AT_IsCalculation | Soft Red |

TABLE 2

A full list of attribute letters comprises:

void GattributeList::AddStandard()

{

// R/O Hide

Add(new Eattribute(“1”, “10000 000 0000”, “d”, “n”, GV->ColorWhite)); //Enterable

Add(new Eattribute(“m”, “11000 000 0000”, “2”, “w”, GV->ColorWhite)); //Mandatory

Add(new Eattribute(“q”, “10100 000 0000”, “d”, “n”, GV->ColorWhite)); //Not Mandatory, but QueryIfLeftBlank

Add(new Eattribute(“c”, “00010 000 0000”, “”, “n”, GV->ColorLightBlue)); //Calculation

Add(new Eattribute(“p”, “00010 000 0000”, “”, “n”, GV->ColorSuperLightBlue)); //Calculation

Add(new Eattribute(“2”, “01010 000 0000”, “”, “w”, GV->ColorLightBlue)); //Calculation/Mandatory

Add(new Eattribute(“d”, “00001 000 0000”, “”, “n”, GV->ColorLightGreen)); //Denormalized Data – Shows but not enterable here

Add(new Eattribute(“u”, “00000 000 1000”, “”, “n”, GV->ColorLightGreen)); //Shows but Not enterable

Add(new Eattribute(“0”, “00000 000 1100”, “”, “n”, GV->ColorDisabledGrey)); //Disabled & Greyed out

Add(new Eattribute(“b”, “00000 100 1111”, “”, “y”, GV->ColorDisabledGrey)); //Disabled – Data is Always Blank

Add(new Eattribute(“i”, “00000 000 1111”, “”, “n”, GV->ColorLightGrey)); //Inactive Table Cell

Add(new Eattribute(“h”, “00000 010 0000”, “”, “n”, GV->ColorLightGrey)); //Value is Hidden – For Table, Column has header but appears blank

Add(new Eattribute(“n”, “00000 011 0000”, “”, “”, GV->ColorWhite)); //Value and Caption are Hidden

Add(new Eattribute(“y”, “00000 111 0000”, “”, “”, GV->ColorWhite)); //Value and Caption are Hidden

Add(new Eattribute(“w”, “01010 011 0000”, “”, “”, GV->ColorWhite)); //Value and Caption are Hidden

Add(new Eattribute(“L”, “00000 000 0000”, “”, “n”, GV->ColorLightYellow)); //FormTable LineNo

Add(new Eattribute(“v”, “00010 000 0000”, “”, “n”, GV->ColorSoftRed)); //Variance (within tolerance)

Add(new Eattribute(“x”, “00010 000 0000”, “”, “n”, GV->ColorRed)); //Variance (out of tolerance)/Error

Add(new Eattribute(“k”, “00010 000 0000”, “”, “n”, GV->ColorOrange)); //Checklist counter or Row counter

Add(new Eattribute(“g”, “11000 000 0000”, “u”, “n”, GV->ColorLightPurple)); //GTAttribute Flavor field while it’s still editable

Add(new Eattribute(“f”, “01010 000 0000”, “2”, “w”, GV->ColorDarkPurple)); //GTAttribute Flavor field after it’s lock in

Add(new Eattribute(“t”, “00000 000 1000”, “”, “n”, GV->ColorWhite)); //NotEnterable – White

}

The 0’s and 1’s set the AT_Attribute values as follows:

Eattribute::Eattribute(Cstring Code, Cstring b, Cstring

ReadOnlyVersion, Cstring NoReadVersion, Ecolor Color)

{

j_Code = Code;

e_ReadOnlyVersion = ReadOnlyVersion;

e_NoReadVersion = NoReadVersion;

e_Color = Color;

if (b.GetAt(0)==’1’) e_AT.Add(AT_IsEnterable);

if (b.GetAt(1)==’1’) e_AT.Add(AT_IsMandatory);

if (b.GetAt(2)==’1’) e_AT.Add(AT_QueryWhenBlank);

if (b.GetAt(3)==’1’) e_AT.Add(AT_IsCalculation);

if (b.GetAt(4)==’1’) e_AT.Add(AT_IsDenomalization);

if (b.GetAt(6)==’1’) e_AT.Add(AT_IsAlwaysBlank);

if (b.GetAt(7)==’1’) e_AT.Add(AT_IsValueHidden);

if (b.GetAt(8)==’1’) e_AT.Add(AT_IsCaptionHidden);

if (b.GetAt(10)==’1’) e_AT.Add(AT_DisableEditActions);

if (b.GetAt(11)==’1’) e_AT.Add(AT_DisableHighlightMany);

if (b.GetAt(12)==’1’) e_AT.Add(AT_DisableHighlightOne);

if (b.GetAt(13)==’1’) e_AT.Add(AT_DimTable);

}

Thus, each data element on the screen has a single letter associated with it, and that letter determines how the framework layer will handle the data element.

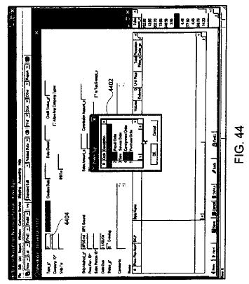

The framework layer can help the application layer change from one attribute to another and then implement all the functionality implied by the attributes. Attributes are linked to the task variation (or task FlavorIndex). Consider, for example, an order with five different types or variations, as illustrated in FIG. 44. The developer defines these types which are managed by a TruCore Bobject called BgeneralTable. BgeneralTable helps users pick from small lookup lists. An additional Data Dictionary Entry tells the system that the Order.Type_g field, which uses the BgeneralTable, is also the TaskVariation Flavor Index. When the user is entering an order, the user can select from among the five types by using a lookup dialog box 4402. The lookup dialog box 4402 is generated when the user types in a question mark in the Type_g field 4404. The order types listed in box 4402 are Customer Order, Repair Order, Service Order, Consignment Order and Purchase Order. The BgeneralTable Object notices checks the Data Dictionary and noticing that is the TaskVariaion Flavor Index, it notifies the Ddocument if the user changes the value.

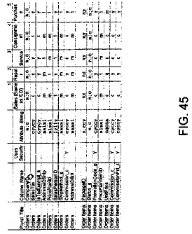

With reference to FIG. 45, a table of the task variation attributes for orders and order items is illustrated. This table is located in the Data Dictionary, and in the table a developer can define an attribute for each of the five types of orders. For example, consider the SQL column SalesTax which has an Attribute String of “cyycy.” These five letters correspond to the five types, also referred to as flavors. Preferably, only one is active at a time. For Sales and Consignment, the attribute “c” applies. For the other 3 types, the attribute “y” applies. When the user changes from one type to another, by changing the value of the Orders.Type_g column, then the framework layer will select a new current attribute for each of the columns that have variable attributes in the chart. This will radically alter the functionality of the screen. The exemplary system also alters the type automatically, as the user navigates from one saved order to another.

Thus, the work of the developer may be made simple. For example, to support multi-flavored screens, the developer links the Orders.Type_g column to a General Table, tell the system which column is the ‘FlavorIndex’ column, which in the present example it is Orders.Type_g, and assign the Attribute Strings to each column.

Similar to LocalTable Variaions discussed above, task variations are implemented using a series of style bit settings and the core manages those settings within the Bobject system. The complex routing system of the Bobjects, Collection classes and Containers all have an opportunity to test the AT_ settings and implement as needed. This shields the Business Rules document from having to continually branch and decide how to implement features. The branching has been systematized and moved into the Layer 5 Ddocument and supporting Bobjects. The end result is that complex permutations are easily implemented, without code expansion. Examples and figures showing how Task Variation works will be provided below.

These actions can be performed from screens within the Data Dictionary. The developer does not have to write any code to set this up because the system, using the data in the Data Dictionary, handles the assignment of the correct attribute and the implementation of the attribute’s rules. However, complex exceptions can be added within code, if needed. As a result, complex permutations are easily implemented without code expansion.

A related feature is audience variation. As an example, a screen may have several audiences, each one seeing a slightly different document. When viewing an order, a staff person in accounting may see commission information, but the staff person in shipping, viewing the same order, may not. An aspect of audience variation is that each audience member’s variation should operate in conjunction with the task variations described above. As a general rule, data manipulation is not altered by who is looking at the data. The only thing that changes is the user’s access to see or influence what is happening. Thus, audience variation comprises three choices as to the level of access: read and write access, read access, and no access. Audience variation comprises three separate features: whole object access, SQL row access, and SQL column access.

These access variations can apply to each SQL Column. The user is assigned access within the Data Dictionary. By default, a user can see any SQL column as long as that user is given access to one or more layouts to view the SQL Table. But the Data Dictionary provides several ways to alter these accesses. On startup, the ’ user’s entire security profile for all SQL columns is downloaded to the client’s Data Dictionary.

When the developer is assigning attribute strings for task variation, the developer can assume that all users have read and write access. When manipulating a screen, the framework chooses a single attribute letter from among those in the attribute string, as discussed above with regard to task variation. Then the user’s security profile is checked. If the user has less than read and write access, then the attribute is converted to one which has less access.

Thus, to create a single screen, several passes may be made. First, all data columns are created virtually (includes edit controls and local table columns). This is done by the Application. The task variation feature then assigns an attribute letter from among those in the attribute string. The audience variation feature then reviews the attribute letter and alters it if needed. The application document gets a final callback to make any non-standard adjustments, and the framework creates actual controls for the visible data elements. The Application can also change any attribute at anytime during the life of the screen.

With regard to whole object access, the Data Dictionary enables the security profiles to be set up for each layout, report and macro. The system has two types of toolbars. The first toolbar is created at startup and it shows all the SQL Tables that can be accessed by this user. Once a table is accessed, a second toolbar is created which tells the user which layouts, macros (find, sort, other) and reports are available for that particular table. Also the user is provided with a list of Related Tables allowing cross table access. These toolbars are populated by examining the user’s security profiles in the Data Dictionary. Each user can have a custom interface, based on their particular security profile.

With SQL row access, even if a user has access for a particular table, the user may not have access for all the rows in that table. For example, a salesperson has access to view Customers and Orders. But you may want to limit access to just his/her customer accounts and their orders. This feature is implemented by setting up a series of filters. The filters are assigned by the application during the startup routine, and the application adds filters to the Data Dictionary. Once added to the Data Dictionary, all user lookups and searches, regardless of the source, are filtered to limit row access.

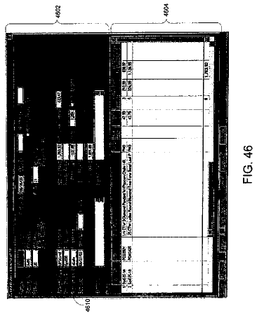

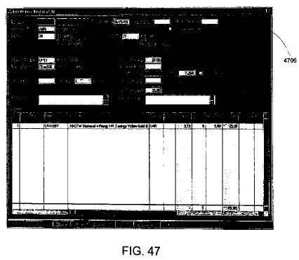

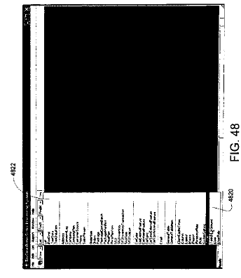

Using whole object access, SQL row access, and SQL column access, each audience may have a different experience using a system according to the present invention. As an example of task and audience variation working simultaneously, refer to FIG. 46, where a user interface 4600 for an exemplary customer order is illustrated. This user interface provides information pertaining to a customer order. A header area 4602 provides the customer identification and other pricing and logistical information, and a local table area 4604 provides a listing of the items included in the order. The same user may select a different variation of an order document (that is, a different flavor) for that customer to view, such as repair orders. Thus, by entering Rep in the Type_g field of the customer order interface 4600, the user is presented with the exemplary repair order user interface 4706 of FIG. 47. The user interface 4706 provides relevant information pertaining to a repair order. In comparison to the customer order screen, note that the Commission Amount, Sales Person, and the Promotion Code column, which were provided in the Customer Order screen, are not provided and the Sales Tax 4714 is blank, while the GLID Alternate column 4716 has been added. The UnitPrice column 218 has changed from calculated to enterable in the repair order screen 4706, and the SKU’s can be selected with or without typing in a price plan item. Repairs also leave out the inventory values column, which is not illustrated.

In the code of the present invention the attributes are facilitating this functionality. For example, if the developer uses the Ddocument API to set Commissions:

SetFromString(“Commissions_c”, CommissionRate*TotalPrice);

For the repair screen shown in FIG. 47, the Commissions_c has an attribute of y which includes: AT_IsAlwaysBlank. When the API command issued above is routed through QrecordColumn::SetFromString(), the AT_IsAlwaysBlank will be checked and the value zeroed out, regardless of the CommissionRate*TotalPrice calculation. So the developer does not have to handle many types of variations in his code:

If((OrderType_g = ‘CO’) or (OrderType_g = ‘Serv’) or (OrderType_g = ‘Cons’)) SetFromString(“Commissions_c”, CommissionRate*TotalPrice);

else SetFromString(“Commissions_c”, 0);

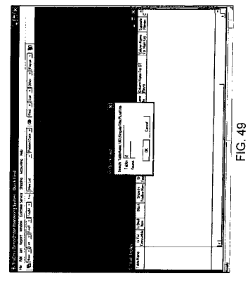

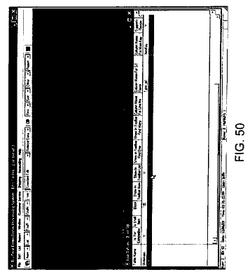

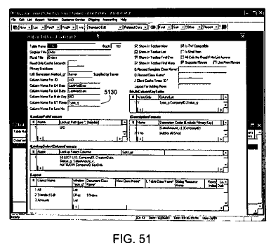

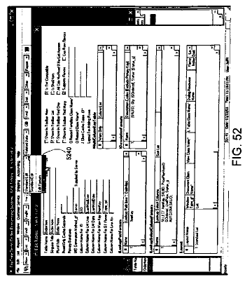

The Data Dictionary is meta data, that is, it is data about other data. The following is a discussion of how the developer may make these entries. First, with reference to FIG. 48, the relevant data dictionary table, called jTable 4820, is selected from the drop-down list 4822 so that it will be loaded. In FIG. 49, the developer uses a query tool to find entries for Orders table within the jTable table. As illustrated in FIG. 50, the query tool returns two tables, OrderItem and Orders. The user then selects the Orders table and is presented with the Dictionary entries for the Orders table, as illustrated in FIG. 51. The user notifies the exemplary system that the Type_g column sets the Task Variation Flavor Index (shown as the Column Name for GT Flavor 5130).

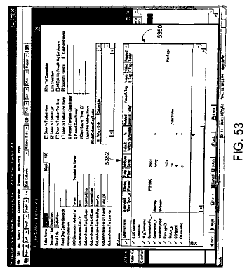

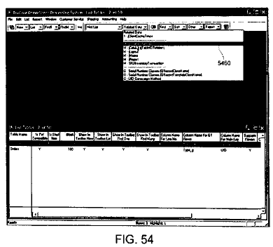

The user can also view the Dictionary entries for the OrderItem table, as illustrated in FIG. 52. The developer may switch to another screen with more Data Dictionary entries by, for example, selecting an edit column option 5240 from a standard edit drop-down menu. In response to this selection, the user is presented with edit column area labeled jColumn 5350 within the local table area, as illustrated in FIG. 53. The jColumn table 5350 provides a listing of the different columns that may be presented in the OrderItem screen and enables the attributes and other parameters of each column to be individually designated. For example, the developer may set attribute strings in the Attribute String column 5352 to implement task variations, as discussed above.

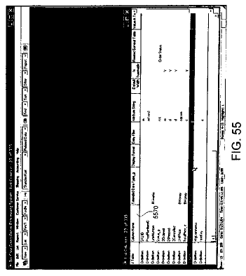

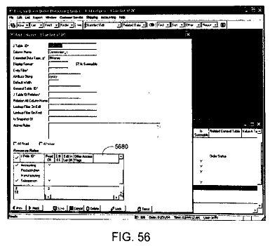

The developer also may use another tool called Related Data to switch to a screen where even more detailed entries for OrderItem Columns can be made. As illustrated in FIG. 54, the user may select the M-jColumn option 5460 under the Related Data drop-down menu for more detailed entries. This selection results in the user being presented with a list of columns corresponding to the OrderItems screen, as illustrated in FIG. 55. The developer may then view detailed information about any one of the columns by selecting a column listed in the Column Name column 5570. This selection results in the user being presented with a screen comprising parameter settings for the commission column in the OrderItem screen, as illustrated in FIG. 56. The information presented includes the security settings for column/audience variation for the OrderItem Commission column. In particular, the Resources Roles table 5680 provides for the selection of the read and write edit rights various audiences will have for commission in this screen.

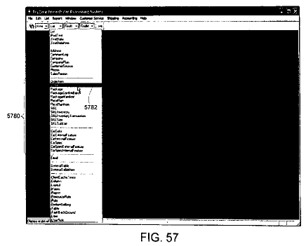

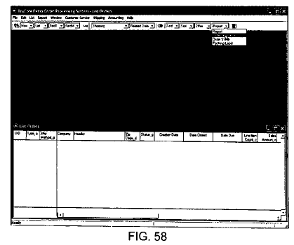

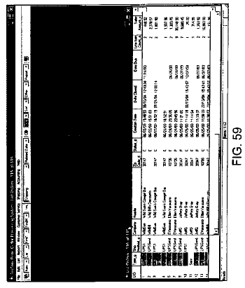

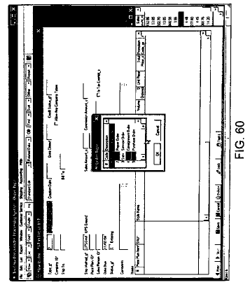

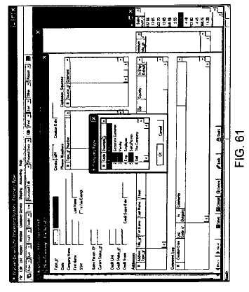

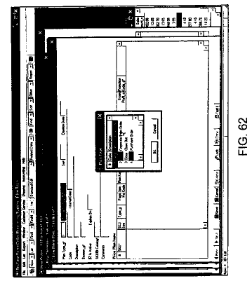

If a different user logs into the system, such as an administrator, then they may have access to view all the different tables in the drop-down menu List. This is whole object access because the tables are objects. Users with lesser rights might not be provided with access to all the tables 5780 of FIG. 57. The user may select the Orders table 5782, and then select from one of the three reports for Orders Table, as illustrated in FIG. 58, whereas other users with lesser access rights would likely have fewer reports from which to choose. This selection will result in the user being presented with a list of orders, and as indicated in FIG. 59, the user is able to view all 116 orders. Thus, this user has row access to all rows. The user may select one of the listed orders to view more detailed information about that order, such as order 117 illustrated in FIG. 60. From this screen, the user can perform task variation to view another flavor of an order, such as repair, service, consignment or purchase. As another illustration of task variation, FIG. 61 shows exemplary variations for Company type. Another example of task variation is price plan variation, as illustrated in FIG. 62.

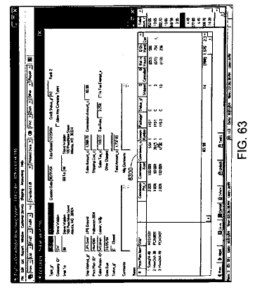

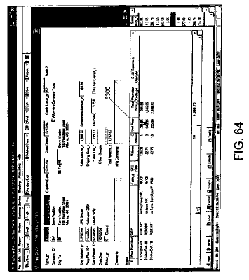

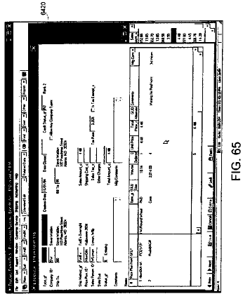

With general reference to FIGs. 63-75, the audience and task variations of the present invention will be illustrated in several screen. For example, in FIG. 63, the screen presented to the user includes a viewable Commission Column 6300, wherein the Commission Column 6300 is displayed blue (see Table 2 above) to indicate that data is not directly enterable. The designation of this column is based on the attribute for this column, as discussed above with reference to FIG. 45. Other commission-related columns are also displayed blue. In the same screen shift via the slide bar, the Unit Price Column 6410 also is displayed blue, as illustrated in FIG. 64, meaning there is no manual entry of data into this column. The same user looking at a different order flavor, specifically the Repair Order screen 6420 as illustrated in FIG. 65, the Commission data/calculations and inventory column are hidden. In addition, the Sales Tax is blank and the Unit Price is enterable. When implementing certain attributes, such as AT_IsMandatory and AT_QueryWhenBlank, the user will be notified of data records, as illustrated in FIG. 66.

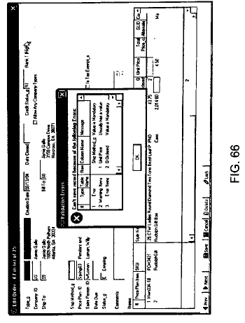

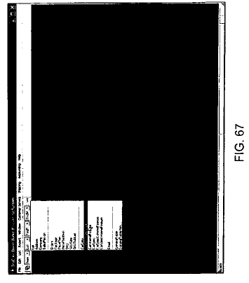

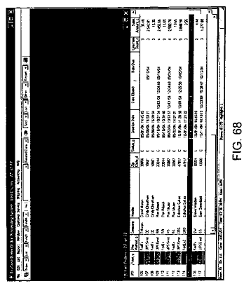

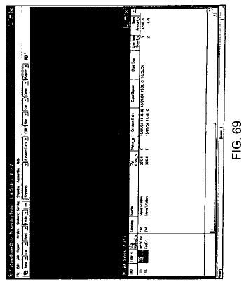

When a user with less access rights logs in, the same screens will be presented with less data. For example, a new user may be presented with fewer tables fro which to choose (referred to as whole object access) in the List drop-down menu, as illustrated in FIG. 67. With regard to row access, the new user only has access to 77 rows, as illustrated in FIG. 68, whereas the user in FIG. 59 had access to 116 rows.

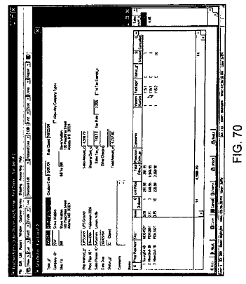

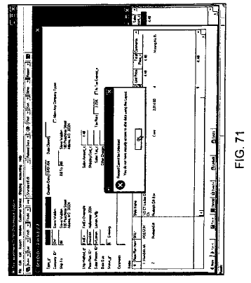

When a customer logs in the exemplary system, the customer is presented with only orders of that customer, which in the illustrated embodiment of FIG. 69 comprises two orders, that is, access to two rows of SQL data. When the customer selects an order to view, as illustrated in FIG. 70, then the customer sees neither commission nor inventory, which is a function of audience variation overriding task variation. Specifically, the task variation attributes typically include the presentation of commission data in a customer order screen, but in the present case the user is the customer and the company operating the system would not want the customer seeing this information so they are denied read or write access via column (and/or row) access discussed with regard to at least FIG. 56. As previously noted, the system will not show the data related to other data that is hidden. For instance, NetSale will be hidden when Commission is hidden because NetSale equals SalesAmount-Commission. The exemplary system parses the query to determine how the hidden data may affect what other data should be hidden. In addition, layout access is the security feature that prevent the customer, for example, from editing any of the data in an order screen, as illustrated in FIG. 71.

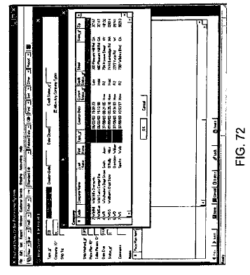

Row and column access are also operative with regard to lookup screens. If the user is looking for a customer than begins with the letter ‘w’, as illustrated in FIG. 72, then the BforeignKey will perform the lookup. However, prior to sending the query, BUID (BforeignKey’s parent) will check the QtableSchema Data Dictionary Entry and look for any security filters, and if any are found, then they will be appended to the query. This is done so a salesman, for example, may only see companies that are his personal accounts. Once the query returns, the columns in the result set are linked to the Data Dictionary and column attributes are assigned.

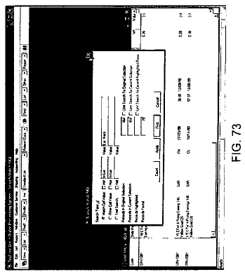

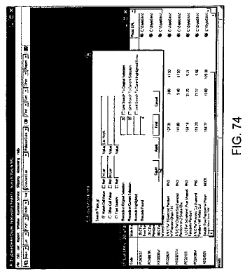

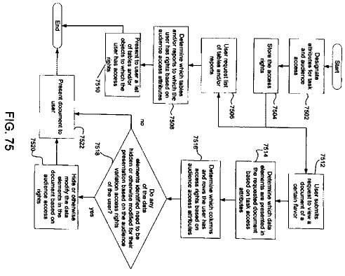

As another example of row access is illustrated in FIGs. 73 and 74 where FIG. 73 shown the search results of an administrative or super user, which finds 79 of 464 SKU rows for the search query for earrings or necklaces. In comparison, FIG. 74 shows the results of the same search query for a customer, which finds only 4 of 20 rows.

In summary, task and audience variation utilizes the Data Objects System to allow the data objects to be continually linked to information in the Data Dictionary. Using this information, most of the complex work of task and audience variation has been removed from the business rules document and standardized into a process that is executed inside the framework

With reference to FIG. 75, an illustrative flow diagram of task and audience variation is provided. Initially, an administrator or developer sets the rights (also referred to as attributes) to the data elements, as indicated at block 7502. At block 7502, the administrator or developer may also set the access rights to the objects (layouts, macros and reports), SQL columns and SQL rows for the different classes of users. At block 7504, the exemplary system stores the settings designated by the administrator. At block 7506, the user may request a list of tables and/or reports. At block 7508, the exemplary system determines which tables and/or reports to which the user of 7506 has rights based on the audience access attributes of the user. The user may also, at block 7502, submit a request to view a document of a certain flavor. At block 7514, the exemplary system determines which data elements are presented in the requested document based on task access attributes. The system at block 7516 may also determine which columns and rows to which the user has access rights, based on the user’s audience access attributes. At step 7518, the system evaluates whether any of the data elements identified need to be hidden or otherwise modified for their presentation based on the audience variation access rights of the user. If nothing need be hidden or otherwise modified, then at block 7522 the document is presented to the user with access rights to the particular identified elements. If, however, the exemplary system at step 7518 determines that elements identified need be hidden or otherwise modified, then at 7520 the system either hides the elements or modifies the data based on the audience access rights of the user before presenting to the user at block 7522. The method of FIG. 75 may be performed by a combination of the exemplary system (which includes the framework) and the application software written by the developer.

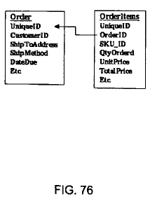

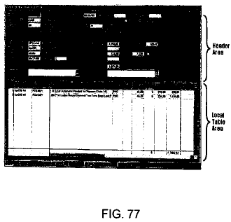

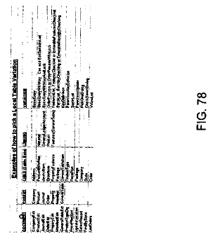

The exemplary system includes a “local table variations” feature that involves creating dynamic ‘templates’ for data management. As stated earlier, the trick to creating a quality framework is knowing how to split the program, by moving common elements into the framework and leaving as little as possible in the application. This feature is perhaps the best work in that area. LocalTable Variations are a big part of the Document (Layer 5). Databases are referred to as “Relational Databases.” A database consists of many SQL Tables which relate to one another. For example, consider these two tables, shown as FIG. 76.

Referring to Figure G+1, OrderItems and Orders form what is called a “Many-to-One Relationship”. That is there can be many OrderItems for each Order. This is one of the most common types of relationships that one sees in database programming. The Order and OrderItem tables exist on an SQL Database Server. The tables are ‘related’ to one another because the OrderItem.OrderID column refers or ‘points’ to the Order.UniqueID column.

Setting Up Local Copies of Data

When users want to manipulate these tables, local copies of the data are created on the client. Let’s say that a developer wants to create a screen to edit an Order. The developer creates a ‘Document’ which will represent the Order Edit Screen. This document will have to hold local copies of a single Order, plus all of the OrderItems which relate to it. A Data Container is a client based structure (a structure created in C++ on a client machine, not on an SQL server machine) which can hold pieces of data. There are several different types of data containers which are useful for holding different types of data. A single SQL Row, such as One Order, is held in a structure of the exemplary system called a Qrecord. When holding multiple SQL Rows, such as several OrderItems, a structure of exemplary system called a TlocalTable is used. A Ddocument is a composite container which can hold Qrecords and TlocalTables. Thus, the Order Edit Screen’s Ddocument looks like this:
Ddocument – a Composite Data Container set up to implement an Order Data Entry Screen. It holds:
Qrecord – a data container which currently holds a local copy of one Order
TlocalTable – a data container which currently holds a local copy of 2 OrderItems
BdataCatalog – a data container which holds any miscellaneous data which the developer creates. It is empty in this example.

Displaying a Document

Most database entry forms have a similar format. There is a ‘Header’ portion and a ‘Local Table’ portion. The image below shows a typical data entry screen. The upper or ‘header’ portion of the screen shows Windows controls which correspond to the Qrecord. The lower portion of the screen, which is FIG. 77, shows a scrolling area which corresponds to the TlocalTable which holds copies of the OrderItems.

On most database screens, managing the LocalTable area is one of the most difficult sections of code. Some screens have multiple LocalTable areas. In this example, the LocalTable is created to hold a copy of SQL Data. But developers can create LocalTables to hold any type of data. Depending on the screen, it is typical for 60-90% of the code to be devoted to LocalTable management. Therefore a huge reduction in code volume can be achieved by tackling LocalTable Area management.

Splitting the Code – Framework vs Application

At first glance, it appears that virtually all of the LocalTable management code would fall into the category of Application code. Each database screen with a LocalTable area seems unique. The screen above holds OrderItem Data. A Package Manifest screen holds a list of Packages. A Company Screen holds a list of Addresses. The rules for managing these seem totally unique and unpredictable – they appear to be the realm of business rules and therefore the responsibility of the Application, not the Framework.

However, this is not true. The overwhelming bulk of the code can, in fact, be transferred to the Framework. But doing this successfully involves meticulously splitting the ‘generic’ from the ‘specific’. If one examines the different uses of LocalTables one can see patterns. Although some LocalTable areas may be totally unique and need custom management, the huge majority can be classified into distinct groups which can be managed by the exemplary system framework.

One of the keys to understanding this process is to see that there are a finite number of ways that SQL tables can relate to one another. Classifying these relationships is one way to classify Local Table management.

In the following example there are three different business processes and examine the similarities and differences among them.
Orders and OrderItems – There are Many OrderItems for each Order. OrderItems are added to an Order. That is, the Order exists first and then OrderItems are added to it. A user can’t have an OrderItem which has no corresponding order. Therefore here are some rules that apply to an Order’s LocalTable Area:
The User Can Add and Delete Rows
The User can type directly into a row
If the user is typing in the last row and hits the return key, a new blank row is automatically created
Clicking on a row allows the user to enter a cell
When creating a new order, the number of OrderItems is zero, therefore the database does not need to be queried to find OrderItems
Rows are numbered
Footers show sum totals for all rows
PackageManifest and Packages – Let’s assume that after creating orders, the items are parsed into packages. As each physical package reaches the end of a pick line, it is ‘confirmed’. That is, a bar code reader scans the label into the computer and the user confirms that the package has been filled and is now ready for shipment. At that point, the box is moved to a pallette and awaits the arrival of a UPS or FedEx truck. Packages are confirmed one at a time, all day long. At the end of the day, the user needs to prepare a PackageManifest. The PackageManifest is a list of all of the items that will be shipped out on a single truck. This list is usually given to the driver or uploaded to the shipper’s computer. The PackageManifest will contain a subset of the packages that were confirmed that day. So for example, lets say that there were 100 packages confirmed. The user creates a PackageManifest record and indicates that the first 40 boxes will fit on the first truck. To create a PackageManifest, the user is presented with a list of all 100 packages. The user then checks off the items which will appear on the first truck and saves the record. Then the user creates a second PackageManifest. The user is presented with a list of the remaining 60 packages and checks off the packages on the second truck, etc. Package and PackageManifest have a Many-to-One relationship, just like OrderItems and Orders. But the way that relationship is managed is very different. With Orders and OrderItems, the One Record is created first and the Many Records are added next. With Packages, the Many Record are created first and the One Record is created second. Packages (the ‘Many’ records) can exist without being associated with a PackageManifest. The PackageManifest screen exists to batch together pre-existing packages. All packages will eventually end up on a Manifest. If an OrderItem is deleted from the Order Screen, it ceases to exist. But a Package cannot be deleted from the PackageManifest screen. It can be unchecked, it which case it will be unlinked from the current PackageManifest and will be free to appear on some other PackageManifest. Some rules for the PackageManifest’s LocalTable Area:
The User Cannot Add or Delete Rows
There is a CheckMark Column at the left of each Row
Single-Clicking on a row checks or unchecks the row
Double-Clicking on a row allows cell entry, but only checked rows can be entered. Most columns, though, are locked since the purpose of this screen is to batch packages together, not to edit them.
Unchecking a Row unlinks it from the Current PackageManifest, checking it links it.
Footers show two separate totals, one for checked rows and one for all rows.
When creating a new PackageManifest, the system will search for all Packages which have not previously been assigned to another PackageManifest.
When loading a previously saved PackageManifest, only packages which were previously assigned will appear. But there needs to be a mechanism to append unassigned packages, so that they can be checked off and added too. This is often need to handle last minute packages which are confirmed and squeezed onto a PackageManifest. Most network queries involve emptying out a LocalTable and replacing the contents with the results of the query. This process involves appending rows, carefully managing duplicates, in case the query loads a record which already appears on the list.

So, even though PackageManifest/Package and Order/OrderItem both have a Many-To-One Relationship, they are handled quite differently. Let’s take a look at a third process:
BankReconciliation and JournalItems – All month long we create Accounting JournalItems. These can be Cash Disbursements, Cash Receipts, A/R, A/P entries, etc. Each JournalItem links to a General Ledger Account. One such General Ledger Account is for a business checking account. At the end of the month we get a bank statement which shows all of our activity. We need to reconcile this bank account. That is, we have a list of all JournalItems which go against the checking account. We need to check off the ones that actually appear on the bank statement. To do this we create a new BankReconciliation record and below it we show all of the open JournalItems which we suspect may appear on the bank’s statement. Now we come to the crux of the issue. What are the rules for the BankReconciliation’s LocalTable Area?
Does the BankReconciliation process resemble either the PackageManifest or Order processes? Does it share some rules and therefore could it share some code with either of these two processes? Well, if you think about it for a moment, you will see that the BankReconciliation process is very nearly identical to the PackageManifest process. In fact, they are almost identical in every way:
Both processes involve the batching together of a finite list of items.
The ‘Many’ Items are created independently and at the time of their creation, they do not point to any ‘One’ Record.
However, each ‘Many’ item will eventually link to a ‘One Record’ – each item will appear in one batch.

Then read through the list of rules for the PackageManifest LocalTable Area and substitute BankReconciliation for PackageManifest, and JournalItem for Package. As you can see all 8 rules fit perfectly. Take a look at the last rule. Just as you may need to add a few more Packages to a Manifest, you often need to add a few more JournalItems to a BankReconciliation. For example, after checking off all of the items, you realize that there are bank charges which appear on the statement, but not yet in your system. The user adds these JournalItems on some other screen, but then need to append them to the BankReconciliation checklist, without interfering with items which were already checked off.

So at first it might appear that a PackageManifest screen and a BankReconciliation screen have nothing in common. But through careful examination of the relationship that exists between the underlying data itself, one can see that the common ground is quite substantial. Therefore, this is a prime candidate for generalization. There are a lot of variables involved, but they fall into finite groups. One can generalize the management of a LocalTable and put that into the Framework, thus reducing Application code dramatically.

LocalTables Styles and Variations

A ‘Style Bit’ is a Yes/No setting. We saw this with the Bobject FLAG_XXX system. The same thing is done here. LocalTables have over 60 StyleBits plus several other types of settings. Style Bits are used throughout the exemplary system as a way of communicating Descriptions. The Application describes what needs to happen by setting Style Bits. Then the Framework implements these actions:

LT_UserCanAddRows

LT_UserCanDeleteRows

LT_TestForMultiKeyViolation

LT_ClearRowWhenKeyCleared

LT_ExamineVisibleColsForEmpty

LT_DeleteClearedRows

LT_RowDeletionUnlinksData

LT_RowsHaveIndependentExistence

LT_LimitEntryToCheckedRows

LT_ClearRowWhenUnchecked

LT_SaveCheckedOnly

LT_MoveFocusToLeftWhenKeyBlank

LT_MoveFocusToLeftOnAddRow

LT_DupKeyWarn

LT_DupKeyDisallow

LT_RunQueryEventOnNew

LT_RunQueryDistinctConcat

LT_KeyAcceptsMultipleResults

LT_DisableUserSort

LT_EnableLineDragging

LT_AutoHighlightorCheckSum

LT_HasInventoryEvent

LT_WantsKeyFocus

LT_SizeWindowWDToDataOnLoad

LT_SizeWindowHTToDataOnLoad

LT_SetWindowTitleToCaption

LT_NoGTMultiFlavorColoring

LT_UserCanRevertRows

LT_NoClearRowsOnLoad

LT_NoUserCopyExport

LT_NoAutomaticTimeStamp

LT_NoAutomaticSave

LT2_UsesRowFlavors

LT2_UsesGTDualLevelFlavors

LT2_NoLockFlavorOnEntry

LT2_DocOwnsTable

LT2_SaveDocumentOnDoubleClick

LT2_ReduceToCheckedOnModalRtn

LT2_NoCleanDirtyOnLoad

LT2_NoCopyItemsOnCopyTable

LT2_NoLimitWindowToThisWD

LT2_NoExpandToWidestWord

LT2_GetInsertIDsOnSave

LT2_NoLinkLineNoToSQLColumn

LT2_InitedForView

LT2_NoDirtyLogging

LT2_ErrorIfTrySaveEmptyTable

LT2_WarningIfTrySaveEmptyTable

LT2_ErrorCheckCleanRows

LT2_NoHScrollBar

LT2_NoVScrollBar

LT2_UseDefaultWidths

LT2_SkipConfigure

LT2_UseSimpleSerialization

LT2_UnlimitedWidth

LT2_UseBatchListLookup

LT2_SkipAllInits

LT2_ParseAllAliasesOnBuild

LT2_ProhibitSecureColumnAccess

LT2_EnableOrderByFiltering

t_paCheckMarks;

t_LockColumn;

t_pDefaultColumnAttribute;

t_ClicksNeededToEnter;

t_AllowHighlightRows;

t_AllowZeroHightlight;

t_MaxUserAddRows;

t_HeaderFormat;

t_pEFont;

t_HdividerPen;

t_VdividerPen;

t_HdividerColor;

t_VdividerColor;

t_RowHT;

t_PadPixelHT;

t_PadPixelHTBottom;

t_AutoHTMin;

t_AutoHTMax;

t_Leading;

t_DetailFormat;

t_FooterFormat;

Variations

Even more powerfully, the style bits themselves are batched into groups called ‘Variations’. Declaring a TlocalTable Variation forces many settings to be adjusted simultaneously. There are 28 Variations listed, however only about 15 are in common use by themselves. The rest are foundations for other groups:

Default

VviewList

ModalDialog

PreExistingData

PickOne

CheckItems

PickOneDialog

CheckItemsDialog

BatchByChecking

EnterableBatchByChecking

FeaturesChecklist

EnterableFeaturesChecklist

BasicEntry

BasicEntryWithKey

FeaturesList

BatchList

ParentlessUpdate

OrderProcess

OrderProcessWithLock

BasicEntryWithKeyAndLock

LineDragging

UseLineAsSort

EditSortableList

KeyDefinition

EditInList

ParentlessKeyDefinition

RowLevelAttributes

DualLevelGTAttributes

To configure a TlocalTable for viewing, select the Variation that most closely resembles the type of screen being constructed. Then the developer can make minor modifications by calling AddStyle or RemoveStyle.

More than one Variation can be used. Variations(“Default”) is called by the TlocalTable constructor. Any call or calls to TlocalTable::Variations() will add additional styles or override those defaults. Some Variations build on or use multiple simpler Variations. Variations can be combined. For example the Variation (“LineDragging”) can be used in conjunction with several other variations. In general though, the variations based on “BasicEntry” and those based on “PreExistingData” are incompatible. Clickable and the Enterable Variations are also largely incompatible (with some exceptions).

How to pick a variation

Typically there is a PARENT record a CHILD record and often a LINKING record. In database parlance, the PARENT record is a ‘One Table’, the CHILD record is either a Many-to-One’ record, or if there is a LINKING record, a ‘Many-to-Many’ record. In general, the Ddocument is holding the PARENT Record and the LocalTable is holding CHILD records. The relationship of these records will largely determine the variation needed. These are some examples that might apply to a typical company doing order processing. However the Parent/Child/Linking relationships exist for all relational databases, regardless of the nature of the data. FIG. 78 provides examples of how to pick a Local Table Variation.

Implementing Variations rather than Styles

Recall the example above where the difference between making a list of what you are packing to take the beach, vs. simply describing your intent as SetDestination(“The Beach”). LocalTable Variations are like the latter. For example, consider the variation is “KeyDefinition”. This variation allows the user to create a sortable list whereby the first column in the list is some sort of a definitional Key. A simple List like this is an example:

Key

Description Other Columns

CO Customer Order

Rep Repair

Serv Service Order

PO Purchase Order

Declaring a list to be a KeyDefinition turns on several settings like LT_UserCanAddRows and LT_EnableLineDragging, etc. But as new features are added one can go back and review the variations and see the best way to apply to each. Another example of adding a new feature and see how it applies to KeyDefinition is if one were to implement a “Type Ahead” feature. This feature would be viewable in the address line of most browsers. If one were to type in “goo” it shows a list of choices below the cursor that includes “google”. The one could stop typing and just select “google”. This makes it faster for the user. Excel does something similar, by comparing the string you are typing with all the values above the current entry cell. As a example, TlocalTable may support this feature. “KeyDefinition” may also support this feature. Because the first enterable column is the KeyColumn in which all the values in this are unique, the type-ahead feature would not apply to this column. However, other columns could support this feature.’ Now consider the situation where there is a ‘search/match’ dialog that the user can load using a pop-up menu. Let’s assume that the user is pointing the mouse at a cell in a table. If the user right-mouse clicks on the cell, there would be an option called ‘search/match’. By selecting that option, the user is presented with a dialog box that allows him/her to search that column for any value. The user can type any value they want, but by default, the value in the entry box matches the value in the current cell. So maybe the user is searching for “more values like the one they are looking at”. This is very useful because if the user is looking through a list of product codes with values like “X860SDDE24”, it is easier to find something that matches all of that rather than to type it in. Recall that because KeyDefinition contains the key column with unique values, nothing can match what the user is pointing at, and thus, this feature would not apply. However, looking through the list of variations, the feature would apply to “BasicEntry”, but not to “BatchList” or “KeyDefinition”, etc.

Therefore, conceptually, describing something as a KeyDefinition allows for ‘backwards expansion’. That is, the Framework can add functionality independently of the developer who is focused on business rules.

Technical Implementation Using the Bobject System

LocalTable variations are possible because they are built on the Bobjects system. All changes to data, all actions, and all interfaces with the user are implemented through layers of the exemplary system. For example, if the user types in a duplicate entry in a KeyDefinition column and then tabs out of the cell, the view will call this:

pVirtualControl->SetFromString(“Rep”, FLAG_Input);

pVirtualControl is a pointer to a Tcontrol, a type of Dcontrol, BPtr, Bobject. The BPtr owns a Bstring. Well, as the example given in Bobject clearly shows, the call to SetFronString will be routed through all of these classes as well as to the Collection class TlocalTable and the Container class Ddocument. See the example in Bobject for details. All of these classes will see the user making this entry. Each call is accompanied by a BGSMsg object which describes the context for the call and makes available enough pointers back to the Root Object that every one getting the notification can test every Flag, Style bit and setting imaginable to determine its best course of action. In this case, the Tcontrol will test the LT_DupKeyDisallow flag and proceed to implement a dialog to the user alerting of the error and then clean up the interface by clearing out the value and returning the cursor to entry cell, rather than allowing the user to tab out to the next cell. All of this requires zero lines of code in the Layer 6 Business Rules document, other than the initial declaration that the list was “KeyDefinition”.

Swapping Lower Layers

The key to implementing an exemplary system framework is truly the appropriate division into layers. The interface to the screen is at layer 4 which reads the Ddocument at layer 5 and decides the best way to communicate that to lower layers. Layer 4 decides how to implement Layer 5 based on what kind of output is desired (email, HTML, screen, printer, excel, etc). Again, the clear set-up of Layer 5, and ’its complete separation from the business rules at Layer 6, enables Layer 4 to make clear, unambiguous choices. This will be outlined with the Output Variations section below. In that section, we will come back to the “KeyDefinition” example and show how the Output Variations interacts with the LocalTable variations to create a powerful ability to translate complex features, all without disturbing the Business rules. The whole point of the exemplary system is to isolate the Business rules so that powerful systems can be built using the 95% less code.

The upshot of all of this is that the main code for the PackageManifest Screen comes down to just this:

BasicLoad(“SELECT t.* FROM Package t WHERE AUTOLINK”);

Variations(“EnterableBatchByChecking”);

And the BankReconciliation screen comes down to just this

BasicLoad(“SELECT t.* FROM JournalItem t WHERE AUTOLINK”);

Variations(“EnterableBatchByChecking”);

So where there was previously a tremendous amount of hand crafted, very complex code, there is now just a simple declaration to the Framework.

In review, the exemplary system for the geometric reduction in code at the business rules layer (Layer 6) which fulfills our goal of 95% code reduction.

Framework - There is an architecture that divides the application into multiple layers and created a framework for isolating the business rules so as to minimize their scope and complexity. The framework layer that interacts with the business rules at layer 6 is the Exemplary system Ddocument at Layer 5.

Data Objects – There is a system for powerfully managing data, so that most data operations occur in an environment of full knowledge and context regardless of any business rule.
Single Value Objects Hold and manipulate Data. There is a hierarchy of functionality.
BPtrs allow functionality to be nested so that features can be added without geometric expansion. This allows for a multi-dimensional hierarchy.
Collection Classes hold multiple pieces of data
Query tools and Collection Classes work together to move data to and from the SQL Server.
BUID/BforeignKey oversee the fundamental needs of a managing relations in a relational database
Ddocument Container holds and interconnects everything.

Task Variations – There is a multi-flavored attribute system to separate the branching that used to grow geometrically inside the business rules layer, and put it instead into the Data Objects and LocalTable Variations sections of Layer 5.

Audience Variations – There are 3 features as discussed below:
Column Security – We created a security systems that lays on top of the Task Variations system, again separating the branching that used to grow geometrically inside the business rules layer, and put it instead into the Data Objects and LocalTable Variations sections of Layer 5.
Whole Object Access – We also used security from the outset when building Layer 4 to customize the load cycle and deliver access only to secure resources
Row Access – We build security directly into the Query tools and Data Objects to filter out inaccessible data rows

LocalTable Variations – As discussed above, the complex patterns within the relationships of data were analyzed. Next, rules were applied to these, thereby allowing the most complex Collection classes to be fully integrated into the document and further reducing permutations within the Business Rules layer.

At this point, all of these features are built to surround the business rules at Layer 6 with a powerful Document at Layer 5, thereby reducing code at Layer 6 geometrically. There are 2 major times when the high Layers 5 & 6 need to connect with lower layers:
When getting data – we must exit down through the pyramid, to the wire at the hardware layer and out to another machine. Query Tools manages the first dip into the lower layers of the pyramid.
When building an interface. We must exit down through the pyramid, to the wire that leads to a printer, a screen, a file, the internet, etc. This process is managed by our Viewer classes. Viewer classes are at Layer 4, just under the document at Layer 5. They are the bridge to the lower layers. They read the Ddocument at layer 5 and decides the best way to communicate that to lower layers. So that brings us to our next feature which is Output Variations – the viewers that connect our document to the outside world.

Output Variation – Document/View Architecture

This feature of the exemplary system enables Output Variations as introduced above. That is, a given set of data can be viewed on the screen, on paper, in an email, as HTML, as an spreadsheet or text document, etc. This is done by implementing a true ‘Document / View” Architecture (Refer to FIG. 14).

The Framework Layer 4 owns the Viewer which reads the Layer 5 Ddocument. Layer 6, the Business rules layer, is left out of the equation. It is isolated from the problems of Output Variation by the preceding exemplary system layers. This fulfills the goal of reducing code in the business rule layer.

Note that several manuals for Microsoft’s MFC C++ library describe MFC’s Document/View Architecture. This architecture splits the code, but then both halves become the responsibility of the Application, because the viewer is not reusable code. The exemplary system splits the task in a totally different way and shares no code or architecture with MFC’s version.

Each time the developer wants to create a screen he creates two structures:
Dialog Resource (Layout) – This holds all of the controls – edit boxes, scrolling tables etc
A Document (a C++ class descended from the exemplary system’s Ddocument Class)

In MFC, and most other languages such as Visual Basic, loading a Dialog Resource causes the automatic creation of Win32 controls. The view owns the Dialog Resource. Let’s assume that a developer creates a database form for editing an accounting record. The developer uses Microsoft Visual Studio to position Edit boxes, check boxes, buttons, etc. on the screen. When the developer saves this form, Visual Studio saves a ‘Dialog Resource’ which is simply a list of data containing the size and position and settings for all of the controls. When a user wants to see a particular accounting record, MFC will read the Dialog Resource and create corresponding Win32 controls. That is, MFC asks the Windows operating system to create controls on the screen. The developer then gathers data and draws it by telling the Window’s control what to draw.

So, the Application code will look like this:

NetCashFlow = Sum(CashFlowColumn)

DrawText(Control_NetCashFlowTotal, Format(NetCashFlow, “DebitCreditFormat”))

CopyToSQLColumn(NetCashFlow, “AccountSummary.NetCashFlow”)

This type of code creates problems. Calls that manipulate data are mixed together with calls that draw data. This makes changing the view difficult. For example, let’s say that instead of viewing the data on the screen, the user wants to view the data in an Excel spreadsheet. Converting from the screen to an Excel readable text file may not be so easy. How can one convert the NetCashFlow value to Excel? All of the Window’s controls can be accessed to find the text value that was put into each. However, ’generic code cannot be written that correctly understands anything about these values. For Control_NetCashFlowTotal, the text value is the string: “2,021.25 CR”. But Excel cannot correctly interpret that text value as a $2,021.25 Credit while interpreting some other text value as a Debit’. Further, the code above does not allow the generic reader to interpret what this text value is such that the problem can be fixed before it gets to Excel. So, to output this simple code to Excel, custom code would need to be written:

NetCashFlow = Sum(CashFlowColumn)

if (Output == Screen)

DrawText(Control_NetCashFlowTotal, Format(NetCashFlow, “DebitCreditFormat”));

else if (Output == Excel)

SendToDocument(Format(NetCashFlow, “FloatingPrecision2”))

else if (Output == SomethingElse)

DoSomethingElse

CopyToSQLColumn(NetCashFlow, “AccountSummary.NetCashFlow”)

This is precisely the kind of permutation problem that is trying to be avoided. This method has another problem. The Dialog Resource describes the exact pixel position of each control. When converting to Excel, these exact positions cannot be reproduced because Excel deals with cells, and not positions. How can the outputter know which caption goes with which data value? Typically, the caption is just to the left of the data value, but not always. It is possible that a generically written output would swap captions by mistake, depending on the layout. So it is difficult to write a generic output that can convert any Dialog to Excel.

There is a generic way of converting from one Output format to another, which would be reliable, and not place any requirements on each Business Rules Document. The exemplary system implements a Ddocument with a ‘Virtual Document’. When a user wants to see a particular accounting record, the exemplary system will read the Dialog Resource and create ‘Virtual Controls’ instead of Win32 controls. As a technical point, Win32 controls are created for a fraction of a second, but never seen. MFC does not create a way for exemplary system to easily read the Dialog Resource, so instead, MFC is allowed to read the resource and create Win32 controls. Then exemplary system examines the controls and deletes them. So the exemplary system reads the Dialog Resource indirectly. But the main point is that these Win32 controls are never actually used, but rather converted to ‘Virtual Controls’ and then immediately deleted. These virtual controls are document level structures and not View level structures. The problem with MFC was making the DialogResource a part of the view. Instead, it should be part of the document. So the document would contain:

Data Containers and Data-to-SQL Links

Virtual Controls / Virtual Control Groups

Each virtual control contains everything there is to know about the control: What data column it links to, where it is on the screen, how items are grouped (which other controls contains ’its caption, edit, and description), what attribute and color and numeric formats it uses, etc. This feature makes extensive use of the rule that the Application should describe, and the Framework should act.

The Framework then creates a viewer which will read the document and interpret the controls in a manner that is appropriate. So a Screen Viewer will create Win32 controls. An Excel Viewer will create a text file, etc. No viewer is favored over the others. Each queries the document and draws out of it what it needs.

As one can see from reviewing the first 5 features of the exemplary system, the Document fully contains all of the data and all of the viewing information needed to render the ‘virtual controls’ into any format. Any viewer can send messages to Virtual Controls or test any element of the document. These messages are sent with the BGSMsg parameters and thus the Bobjects and other classes can know the context of the request.

The Ddocument, at any given time, holds the state of all the data and pointers to all the data. Viewer queries all filter through the Ddocument. The Business rules Document is only queried when the document needs to answer a question. This is the nature of the relationship between a LayerN and a LayerN+1 as described above. The Framework receives an event, asks the lower layer a question (passes is an event) and then regains control, and post processes the event. At the end of certain cycles, when the Document has no more questions of ’its higher layer, the document is in a state where it is no longer in flux. At this point the document is stable and can be read by other layers, each knowing that the document is complete. So, if the user types in a value, the Ddocument will process that, notify the business rules and make calculations, and at some point finish and declare that it is now done and can be redrawn. At this point, any viewer is free to read or query the document. All queries at this point should be answerable by the document without re-querying the business rules layer. The state of the data at this point is not in flux. Only formatting issues remain. This is the key to isolating the business rules from the complexities of output. The business rules only need to respond to predefined questions. As long as the business rules answers the questions as posed, it need not interact with lower layers. It only reacts to the document and the document reacts to the viewer and the viewer reacts to the OS, etc. Layering shields higher layers from lower layer issues.

Now refer back to the example of outputting the credit of “2,021.25 CR”. With the exemplary system, the data is stored at Layer 5, not Layer 6. Layer 4 can query Layer 5 without re-querying Layer 6.

PVirtualControl->GetAsString(FLAG_Display)

At some point, through the complex routing of the Bobject System, this request will filter down to an object called an EdisplayFormat. This object is responsible for adding the “CR” to the number. This object itself can test who is interested in getting a formatting number. The substitution to an acceptable format can occur there, buried inside the exemplary system.

Cstring EformatDisplay::GetFormatedText(double

Input, BGSMsg bgsMsg)

}

if (Not(HasStyle(EF_IsExcelCompatible)) AND

bgsMsg.b_pDControl->d_pDocument->GetViewer() == Excel)

return GetFormat(“FloatingPrecision2”)->GetFormatedText(Input,

bgsMsg);

else

//Add DB and CR formatting here

}

Then, assuming that one day Microsoft modifies Excel to know how to deal with CR and DB correctly, these few lines of code of the exemplary system above can be edited and now all Ddocuments that had Debits and Credit will now export the new way. Indeed, this change may be made without changing any code in the Business Rule layer.

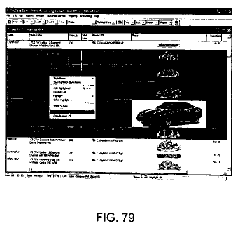

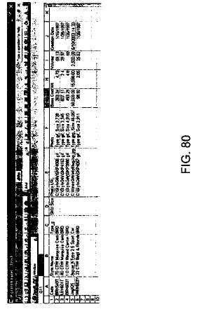

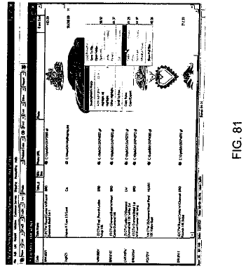

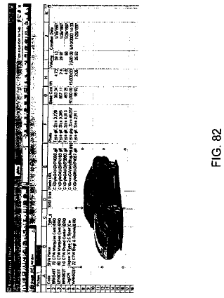

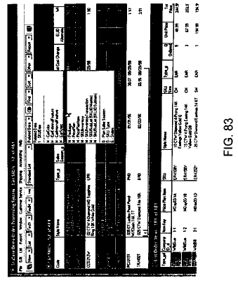

A similar problem will now be discussed. Excel ’will not accept a mixture of images and text in a single copy/paste operation. So, in the exemplary system, the viewer adds FLAG_Display_TextOnly to the GetAsString() function. For example, in FIG. 79, an exemplary screen, a user has selected certain rows for copying into Excel.

When pasted into Excel, as shown in FIG. 80, an exemplary screen of Excel in which the user attempted to paste in the rows copied from the exemplary screen in FIG. 79, we can see that the exemplary system allowed the paste, but the image returns a text description instead of a photo. So the Jaguar returned “Type jpg, Size 46,057”. Notice how this complex feature ties into other Bobject features. The Image itself is returned as the formatted description of the URL String “C:\XmasGifs\MyBluJag.jpg”. The Object in the “PhotoURL” column is a BURL holding the string “C:\XmasGifs\MyBluJag.jpg”. The object in the “Photo” column is simply a BPtr called BptrDescription, which was described above. It does not hold the image of a jaguar. All BptrDescription does is point to the BURL next to it and tag on the FLAG_Description to all Get/Set Messages. So the BURL receives a mix of messages:

The Screen Viewer calls

pVirtualControl->GetAsString(Flag_Display)

The Excel Viewer calls this

pVirtualControl->GetAsString(Flag_Display | FLAG_Display_TextOnly )

If the message happens to be routed through BptrDescription, then it will tack on an additional flag FLAG_Description. BURL returns the result in each case. ’Below is how BURL Responds:

Flag_Display -> “C:\XmasGifs\MyBluJag.jpg”

Flag_Display | FLAG_Description -> [Full 46K image stream]

Flag_Display | FLAG_Display_TextOnly -> “C:\XmasGifs\MyBluJag.jpg”

Flag_Display | FLAG_Display_TextOnly | FLAG_Description -> “Type jpg, Size 46,057”

Now, Excel will accept the pasting of an individual image, just not a blend of images and text. So in this case, the Excel viewer leaves out the FLAG_Display_TextOnly flag and only the Flag_Display | FLAG_Description flags filter down to the BURL. FIG. 81 is an exemplary screen that shows a user copying the image itself only out of the exemplary system. FIG. 82 shows an exemplary screen in which the image that was copied from FIG. 81 was pasted into an Excel spreadsheet.

Control Groups

The exemplary system uses custom ActiveX controls in Visual Studio’s Dialog Editor. These ActiveX controls allow for ‘control groups’. That is, you specify a data element, ’its caption and any description, all in one block. So outputters that can’t support positioned pixel placement can correctly interpret the relationship between various controls. The screen viewer can create multiple Win32 controls for each ActiveX control of the exemplary system. The Excel viewer can choose to have all the captions in column 1 and the values in column 2, regardless of the pixel positions.

Interpreting Descriptions

Layer 4 decides how to implement Layer 5 based on what kind of output is desired (email, HTML, screen, printer, excel, etc). Again, the clear set-up of Layer 5, and ’its complete separation from the business rules at Layer 6, enable Layer 4 to make clear, unambiguous choices. Recall the example given above in the LocalTable Variations section. In the example the TlocalTable was described as a “KeyDefinition”. ’It will now be discussed how the LocalTable Variation and the Output Variation can be combined powerfully to implement a feature without disturbing the Business Rules. The “KeyDefinition” included a style bit called LT_EnableLineDragging. This enabled the user to custom sort the list. Let’s see how an HTML viewer would implement some of the rules of KeyDefinition. The screen viewer implemented the TlocalTable area by creating a scrolling area – only 2 actual Win32 controls was created one for the Caption of the table, and one for the scrolling area as illustrated in many figures. But in an HTML web browser, there are no scrolling tables. We can only output a flat table as a list of separate elements. So how can the KeyDefinition’s requirement that the list be sortable be supported? The HTML browser would have to add check boxes next to each row and then add buttons with up and down arrows allowing the user to sort that way.

So, trying to convert from one output method to another by taking ’what is on the screen and converting it directly is a no-win proposition. But taking a fully formatted document, with a full set of descriptions about what the final goals are, and trying to convert that to a new output method is relatively straightforward. Output Variations interacts with the LocalTable variations and the rest of the Ddocument settings to create a powerful ability to translate complex features, all without disturbing the Business rules. The whole point of exemplary system is to isolate the Business rules so that powerful systems can be built using the 95% less code.

The end result is that the Business Rules Document code now looks like this-

SetFromNumber(“AccountSummary.NetCashFlow”, Sum(CashFlowColumn)).

’It is a single line of code that won’t need to be changed, even as new features and output methods are supported in the future. The format “DebitCreditFormat” is stored in the Data Dictionary as an attribute of the NetCashFlow column, not in the code for this particular interface with that data. The Application document sets the SQL data value. The links to the controls and the branching and substitutions are handled by exemplary system, not the Business Rules Document.

Ad Hoc Queries – Reusable Query Results & Data Analysis

This feature of the exemplary embodiment is a method for converting raw data into useful information in real-time. It builds on all of the previous concepts and allows for multi-dimensional variability, without causing any expansion of code. In fact, this feature works with multiple kinds of data objects, will produce different results for different audiences, can be output to any viewer and yet requires writing little or no code in the business rules.

Reusable Query Results (“Selections”)

SQL database products, such as MS-SQL, Oracle and others, provide the basic functionality which was laid out by international convention in 1992. This is called the SQL-92 standard. Unfortunately, this standard has not had a major overall in many years and is missing some interesting and innovative features. In particular, none of the available SQL products support ‘Reusable Query Results’. All modern GUI Applications allow users to highlight data and then manipulate that data over and over again. A Word processor allows the user to highlight a sentence and then make it bold, then make it centered, etc. An email program allows you to highlight many emails and then move them all together into a new folder or into the trash. These simple and obvious interfaces are difficult to implement using SQL because SQL does not ‘maintain state information’. SQL does not remember what the user is doing. Consider the simple list of steps:

| | |
|---|---|
| User Request | SQL Server |
| Show me a list of open orders | Returns 1000 orders |
| Sort the list of orders by region | Returns 1000 Sorted Orders |
| Highlight rows in Eastern Region and Reduce List | Returns 600 Sorted Orders |
| Show all packages | Returns list of 850 packages |
| Sort the package List by Shipping Method | Returns 850 Sorted packages |
| Highlight the Overnight packages and Reduce List | Returns 75 Rows package |
| Sort the package List by packing status | Returns 75 Sorted packages |
| Highlight overnight packages that have not been packed yet and Send the list to the Report “Expedite Packages” | List of 30 packages sent to Report Manager |

TABLE 3

This interface appears simple and intuitive. But it is surprisingly difficult to implement in SQL code. The problem is that SQL does not remember what the user is doing from one step to the next. So very quickly problems are encountered:

| | |
|---|---|
| User Request | SQL Server |
| Show me a list of open orders | Returns 1000 orders |
| Sort the list of orders by region | What orders? |

TABLE 4

And right there, the problems begin. So as events unfold, the frustrations increase when dealing with SQL databases.

There are a variety of messy ways out of this problem for developers. However, all of them have a lot of problems of their own including a great deal of efficiency and speed concerns. Most systems either dramatically limit user functionality or generate tremendous code expansion and permutation growth in order to get around the problem. The exemplary system introduces the concept of the Reusable Query Result called a "Selection". It is implemented by the C++ class QSelection as a wrapper for a special KeySet Cursor on the Server. This is a way of maintaining state. The problem is outlined in further detail here:

Reusable Query Results:

-The Problem

SQL does not provide for adequate tools to allow the results of one query to be re-used as input into a subsequent query. This is a critical requirement for users. One will see how a particularly difficult permutation problem develops without this feature. Conversely, implementing this feature collapses a tremendous number of permutations and allows for a tremendous expansion of features without the need for extensive business rules document code.

–Background

Recall the primitive days of Lotus 1-2-3. Using Lotus, a user selected an action, for example 'Copy'. Then the copy function asked the user to supply a range of cells upon which to apply the function. If the user wished to perform a second operation, the user called another function and would again be asked to supply a range of cells upon which to apply that function. In other words, the sequence of events was as follows:

1. Choose Action A

2. Select Data from scratch by typing in a range

3. Choose ActionB

4. Select Data from scratch by typing in a range

In this scenario, the Function and Selection process are linked together in that they must be specified together and run as a single operation.

Compare that with a more modern application such as Excel. Using Excel, these 2 actions are separated and reversed (recall that separating operations into discrete layers often allows for much more reusability and power). In other words, the user first selects data by highlighting one or more cells. Then the user can apply a function to the selection. The selection exists independently from the function, rather than within it. This allows for the development of better ways of creating a selection. For example the user can easily pick cells by using the mouse. The old method was largely limited to rectangular ranges and even those were a challenge.

Also, since the selection is independent, the user can re-use the selection for multiple functions:

1. Select Data from scratch by using the mouse to highlight

2. Choose Action A

3. Choose Action B

4. Choose Action C

5. Modify previously selected data - Add one more cell

6. Choose Action D

A user Selection:
Exists independently of any function which may act on it.
Is modifiable - can expand or shrink
Has a graphical interface - modifications can be made by the user by simply pointing with the mouse.
Is reusable

Obviously, the newer methodology is far superior to the old method. This concept of a Selection exists in many GUI based applications. The user can select text in a word processor, cells in a spreadsheet or shapes in a paint program.

Unfortunately, SQL was designed in the 1970's and has not had a major overhaul since 1992. Consequently, a standard SQL query behaves much more like the old Lotus application.

1. Choose Action A : retrieve these DataColumns into this data structure

2. Select Data from scratch by specifying a criteria (WHERE clause)

3. Choose Action B: retrieve other DataColumns or Update Columns

4. Select Data from scratch by specifying a criteria (WHERE clause)

Like with a Lotus Function, the 2 operations (Action/Selection) are performed together with no good way to separate them.

A Database Row Selection has one other feature that has no Lotus/Excel analogy. A Database Row Selection can be used as the input to a Function, just like an Excel Selection. But a Database Row Selection can also be used as the input to create another selection. Two independently created Database Row Selections can be compared to create a third selection. This is perhaps the most the most important use for Selection. This feature is what makes Database Row Selections indispensable to creating a quality user interface.

How SQL handles Queries

For clarification, a SQL query does not return database rows. Instead, it returns Tuples, which may or may not correspond to specific rows in the database. When the term Selection is used, this is referring to a list of actual database rows. 'Where clauses' that result in some other grouping of information will not be discussed.

First, you cannot run a WHERE clause by itself. When you execute a WHERE clause:
Indexes are searched -Indexes contain pointers to database rows. If necessary, those Row Pointers are chased to gather further information for the WHERE clause
If a table scan is needed, the master list of Row Pointers is used. Row Pointers are chased to gather further information for the WHERE clause

Following these actions a determination is made. The Row either meets the WHERE clause conditions or does not. However, the action cannot be stopped at this point. That is, a list of Row Pointers cannot simply be gathered. Instead, the row pointer can be used to chase column information or simply counted (as in a count(*)). But then it is immediately discarded and therefore cannot be reused.

If one wanted to access that same list of rows again one must:

| | |
|---|---|
| Action | Problem |
| Re-run the WHERE clause | Requires re-work on server. Does not allow for modification and re-use in a practical way (this will become obvious as you read further) |
| Retrieve and Save a unique Row Identifier (i.e. a Unique ID Column) which can be used in a different WHERE clause to access the same row again. Note that there is (or should be) a one-to-one relationship between a Unique ID Column and a Row Pointer (unless SQL can move rows??). | Access using a Unique ID Column require s first accessing the ID by chasing the RowPointer, then re-accessing the RowPointer by chasing the ID using an indexed search. This is many times slower (20- 200x slower?) than a Row Pointer list would be.Storage and manipulation of ID list presents many problems (see below) |

TABLE 5 So this is a key problem. There are at least 2 ways to implement this feature.

Version 1

Currently SQL Server does not allow manipulation of RowPointers, therefore the UniqueID method described above is used. The current version of exemplary system implements Database Row Selectons this way.

A ‘keySet Cursor’ in SQL is used to maintain a list of UniqueID’s. This is not ideal, but it is the best tool available right now. It is instantiated inside the ‘JSelectInit.txt’ stored procedure. See the code there for implementation.

QSelection is a Layer 4 C++ wrapper for the cursor. QSelection owns a binary array which it uses to track user highlights on a list. The list of highlighted rows is passed back to the server as a compressed string, noting only the highlight breaks. The number of user created highlight breaks is generally pretty limited, regardless of the size of the result set. See QSelection::RangeStringFromSelectionArray() to see how this is implemented.
The Stored Procedures JSelectionMgr.txt, JSelectSetOps.txt, JJoin.txt manipulate the cursors in a variety of ways.

1. ID’s from the cursor are combined with the AUserHighlight information to create a temporary table of IDs.

2. This table is then used in a variety of Join operations. They can be joined to other temporary tables similarly constructed from other Keyset cursors, or they can be mixed with lookup criteria, etc.

3. Ultimately, these join operations will result in either the creation of a new Row list, or ‘Select’ result (data columns).

With this version QSelection holds the full API and calls into stored procedures for the results. In the next version, QSelection will still hold the client side API but may alter its calls to the server based API.

Version 2

This next method is the preferred method but will require code to be written on the server. The only database that allows that right now is mySQL, and this conversion may be implemented there or in other databases in the future as soon as native Row Pointer access is allowed. These Row pointers do exist. Indexes use them and surely SQL implementations must use them internally in many places to store intermediate results.

These class headers are using C++ syntax. QSQLSelection class needs to exist and run on an SQL server. QSQLSelection is primarily an Array of RowPointers. The only part that is challenging is getting SQL to return a RowPointer[] array, and getting it to accept a RowPointer[] in a WHERE clause. It is desirable to be able to go back and forth.

Once one has this:

QSQLSelection @MySelection = SELECT RowPointer FROM OrderItem WHERE OrderDate = '08/01/2002'

And this:

SELECT *

FROM OrderItem

WHERE OrderItem NOT_IN @MyNotInterestingOrderItemSQLSelection AND

OrderItem.ProducID = Product.ID AND

Product IN @MyProductSQLSelection

Then the process is nearly done. Here is an example of the full -blown API:

Class QSQLSelection

{

QTableSchema* m_pTableSchema;

Int m_Size;

RowPointer[] m_ArrayOfRowPointers;

Int m_LastAccessedRow;

Bool m_IsAllRecords;

CString m_LastOrderByClause; //If applicable

Cstring m_FromWhereClause; //If applicable

Cstring m_DisplayQuery; //Optional

//Creation

int CreateUsingWHEREClause (CString TableName, CString WhereClause)

int CopySelection (QSQLSelection* pOtherSelection, AUserHighlight* pSubSet = NULL);

//Set (Bitwise) Operations –

int Intersection (QSQLSelection* pSelection); //Logical AND

int Union (QSQLSelection* pSelection); //Logical OR

int Difference (QSQLSelection* pSelection); //Logical ~

int Intersection (CString WhereClause);

int Union (CString WhereClause);

int Difference (CString WhereClause);

//User Manipulation – RangeString is the result of QSelection::RangeStringFromSelectionArray() on the client

int ReduceTo (CString RangeString) //intersection with RangeString

int Exclude (CString RangeString) //difference from Highlight

bool OrderBy (CString OrderByClause);

QSQLSelection SubSet (CString RangeString) //Copy plus ReduceTo

RowPointer[]* GetRangeOfPointers (int FirstRow, int LastRow)

RowPointer[]* GetRangeOfPointers (CString RangeString)

ResultSet SelectDisplay (int FirstRow = 1, int LastRow = ALLROWS); // m_DisplayQuery

}

AUserHighlight is a list of highlighted rows on the client - the user is presented with a list and using the mouse and keyboard, highlight all or some of the rows. It is translated intoa RangeString by QSelection::RangeStringFromSelectionArray.

The Interface

This feature allows for a user interface that is extremely powerful. Assume the user wants to see all the package tracking numbers that went out for salesmen Joe and Bob that contained any of 18 Diamond Rings on some hand written list. As a single query, this is a 5 table join:

SELECT Package.*

FROM Package, OrderItem, Product, Salesman, Order

WHERE [very complex string for Diamond Rings]

But broken into little reusable pieces, you can create an interface that can answer the question in about 2 minutes. Note that the user never sees any of the complexities involved . The only words typed by the user are the words 'Diamond' and 'Ring'. All the rest simply involves highlighting records with the mouse, and choosing joins from a list.

To accomplish the task, the user performs several separate simple queries. The resulting Selections are then combined to generate the final answer.

//User Runs Query Returns 500 Row Pointers in new Selection

QSQLSelection @MySQLSelection("Product", "Type = 'Ring')

//note that this step is skipped for all subsequent examples, but you get the point…

@MySQLSelection .m_DisplayQuery = " SELECT ProductCode, Description, Etc.

FROM Product WHERE SELECTION_PLACEHOLDER"

//User shown first 20 results. SelectDisplay uses m_DisplayQuery but replaces theWHERE clause

//with a subset of the RowPointer list .

@MySQLSelection.SelectDisplay(1,20); //using m_DisplayQuery returns 20 rows

@MySQLSelection.SelectDisplay(406,425); //using m_DisplayQuery returns different 20 rows

//User sees list and realizes list should be tightened

//User chooses "Limit Search To Visible Rows" option and runs second query- Returns 65 Row Pointers

//This is the last step that involves typing from the user. All the rest is mouse based.

@MySQLSelection. Intersection("StoneType = 'Diamond')

//User shown first 20 results of trimmed list

@MySQLSelection.SelectDisplay(1,20);

//User scrolls and highlights rows from his list(highlighting has no server at this point, but scrolling does)

@MySQLSelection.SelectDisplay(21,40);

@MySQLSelection.SelectDisplay(41,44);

@MySQLSelection.SelectDisplay(45,65);

//User selected 18 rings from handwritten list then performs a 'RelatedData' Action.

//That is , he is shown a list of tables that join to Product and he selects "Show Me

//Related OrderItems" from that list (similar to image above)

//He wants to see the Order items that were sold for the 18 rings. See FIG. 83.

//Returns 8000 OrderItems for the 18 rings

QSQLSelection @MyDiamondOrderItems("OrderItem"," OrderItem.ProducID = Product.ID AND

Product in @ ySQLSelection. SubSet(pUserPickedRings)")

@MyDiamondOrderItems.SelectDisplay(1,20);

//User Now searches for the 2 saleman;

QSQLSelection @JoeAndBob("Salesman", " ') //Show all

@JoeAndBob.SelectDisplay(1,20);

@JoeAndBob.SelectDisplay(21,35);

//User Scrolls to find 2 saleman. Highlights them and then performs 'RelatedData' to Orders

//300 Orders are found for Joe and Bob.

QSQLSelection @ MyJoeAndBobOrders ("Order"," Order.SalemanID =Salesman.ID AND

Salesman in @JoeAndBob. SubSet(pUserPickedJoeAndBob)")

@MyJoeAndBobOrders.SelectDisplay(1,20);

//User Highlights all using Menu "SelectAll" and performs another 'RelatedData' action

//This time, the user had the 'CombineQuery' option turned on in the toolbar. This means that if

//a previously existing 'OrderItem' selection is found, the new selection and the old

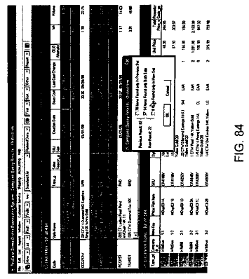

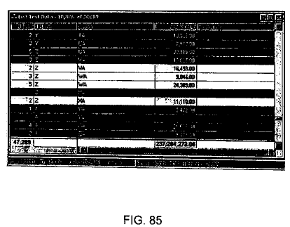

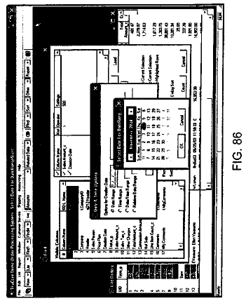

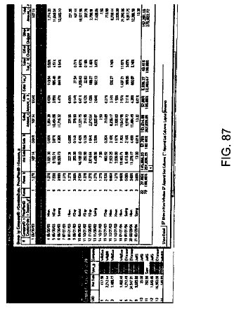

//selection are intersected. See FIG. 84.

QSQLSelection @ MyJoeAndBobOrderItems ("OrderItem"," OrderItem.OrderID =Order.ID AND

Order in @ MyJoeAndBobOrders")

QSQLSelection @ComboSelection.Intersection(@MyJoeAndBobOrderItems, @MyDiamondOrderItems)

Delete @ MyJoeAndBobOrderItems

Delete @ MyDiamondOrderItems

@ComboSelection. SelectDisplay(1,20);

//User wants to see ShipmentInformation so he performs final

//'RelatedData' Action, this time joining from OrderItems to Packages

QSQLSelection @MyNewShipmentSelection("Package"," OrderItem.PackageID = Package.ID AND

OrderItem in @ComboSelection")

//User examines tracking numbers

@MyNewShipmentSelection. SelectDisplay(1,20);

As can be seen, a very difficult query is a simple task if the user can combine small result sets. As also can be seen, it would be difficult to create the same interface using just WHERE-clauses. In theory, a developer might be able to create a WHERE clause and at every step, the developer could append something to it as the user goes. In this way, the developer could eliminate items the user didn't pick or combine two joins into a single WHERE clause. But this would quickly reach its logical limit and break. In all likelihood, after 3 or 4 joins any such strategy would run into problems. This is where the issue of permutation arises. There are so many ways to mix and match queries, that to try to follow it and build a ‘master question’ by building on what has been asked before and what has been done will quickly spiral out of control. And at each step it would get progressively slower too. As the user rummaged, eventually one has to concede that the only thing that can be said for sure about how to reproduce the user’s particular selection is an enumerated list of the results themselves. This is why the reusability of such a list is critical – it creates a layer or boundary that can be reused without maintaining logic or history.

This example underscores a logical limitation in the way that SQL queries have been implemented for decades. SQL queries assume that queries are 'criteria based'. That is, they assume that there is some logical description and that a query can be written to fit. In the real world, this represents a small fraction of what is really needed. As criteria get more complex, queries become geometrically more complex to write and execute. In the real world groupings are not so neat. People work with and massage data based on what they know. Things aren't always categorized or described in the data - Users point at data and say, 'this is what I need'. The interface described is component based, not query based. It provides simple tools that allow for users to create and combine smaller pieces of information in to more and more complex results. In this way, problems that grow geometrically more complex with SQL are handled sequentially instead. This vastly increases the ability of the common user to utilize data and yet simultaneously reduces the amount of unique, Business Rule Document layer code that must be written to implement it.

Using the example above, the user might continue to alter his selection, each time using the previous selection as a starting point:
Limit the packages to a data range
Join to the customers.
By hand, elminate some customers.
Feed the list of customers into an email
Etc.

Each step is independent so the process can continue anew at each step. Regardless of implementation, here are the features as supported by the current version of exemplary system.

Selection Features

Unlimited Selection Sizes - When working with QSelections, the data for the selection (the row pointers) exists on the server, not on the client. The end result is that managing huge result sets is not a problem. For example, in the image below, only the handful of rows showing are actually transfered to the client. Scrolling up and down a huge Selection is also very fast, because unlike many SQL implementations, rows do not need to be processed sequentially. In most SQL implementations, if the user were to scroll to row 15,000, the system would need to process the first 14,999 rows to get to row 15,000. With the exemplary system’s QSelections, this is not the case. Only the visible rows, 15,000-15013 would need to be processed, so the result is instantaneous.

User Highlighted - Users can highlight any group they want, picking rows as they go. Many SQL systems force users to define criteria for searches. With the exemplary system, the user can also pick rows by eye. This is a much more realistic understanding of the way that data works in real life. The User Highlight information is kept on the client, so changes do not require network calls. Various functions allow users to highlight rows by range, row numbers and many other criteria. The user can highlight rows even if the row has never been accessed. For example, if the user scrolls from Row 1 to row 15,000, the user could highlight the range in between, even though those rows have not actually been downloaded to the client. New QSelections can be generated from the highlighted rows. The User Highlight information is sent to the server in a very efficient, compressed format and a new QSelection can be constructed from the result. The new QSelection will maintain sort information from the original.

Shared Selections - If the user double clicks on a row shown below, the user is brought to a Record Edit window. This screen has 'Next' and 'Previous' buttons. The user can use these to navigate through the list. On creation of the Edit window, both the list and the edit window share a single server-based selection. But if the user clicks on the list and performs a new query the list will be given a new selection, while the edit window will keep the old one. The exemplary system manages the sharing of the selections and destroys the server based structure when it is no longer needed. In other words (for C++ programmers), selections are 'reference counted'.

Appended Rows - If the user adds a row using an Edit window, the row will be appended to the QSelection in the corresponding list window. This is done without having to re-write the server based cursor. Yet all of the functions, such as fetches, User Highlights, etc. function as if the original and appended rows were stored in the same way. See, for example, FIG. 85

All of the other features in the Ad Hoc Query section rely on Selections in order to function. Selections are a standard intermediary between functions of the exemplary system.

Related Data & Compare Queries

These two features are the cornerstone of the Ad Hoc Query feature. Related data allows a user to perform an SQL Table join at will using a graphical user interface. Foreign Key relationships are defined in the Data Dictionary. Then the exemplary system allows users to jump from one table to another, building and refining search criteria on a step by step basis. The Compare Queries function allows two separate queries to be compared using 'Set Operations' (intersection, union, difference). The result of these two features is that users can answer complex questions in minutes that in other systems would require the input of a programmer. Using these features of the exemplary system automatically allows business modules to be connected to each other. Rather than constructing custom interfaces, from one module to another, developers attach business modules to the Framework, describe the foreign key relationships, and then using this information, the exemplary system builds a user interface to connect all of the parts.

BOjbects

The Ad Hoc query system, like all systems, makes use of the entire BObject system. For example, using the generic Find Screen, a user is presented with a list of columns that can be queried. These are BObjects that use the same complex routing mechanisms discussed previously. So BTime will test the BGSMsg to see if it is running inside of a search screen. If it is, its entry behavior will be modified. Normally BTime stores just a data. Here it stores a range of dates or times and and will even provide the user with a Date&Time Options dialog box to assist in entering dates for a query. See, for example, FIG. 86.

The Find Screen does not have to know how to support each type of BObject. The objects support themselves. For example, consider a BDataCatalog object. This object stores an entire table inside an SQL LongBinary column. Some of the table that it stores looks like normal text, but it is buried inside a LongBinary. If a user wants to lookup a string within a list of these LongBinaries, the Find Screen does not have to know about any of these complexities. It creates a system where the objects themselves are responsible for managing their own area within the Find Dialog. BDataCatalog will get a chance to format the query and insert functions that look inside the LongBinary for a user's string. Similarly BObject supports the Sort Dialog and other similar dialogs. The concept of separating the logic into discrete BObjects is critical to reducing the complexity and expanding the power of user functions like this.

BForeignKey

Multi-Table relational databases involve understanding complex relationships among data. Thus, it is not surprising that the BForeignKey is heavily involved in implementing Ad Hoc query methods. The AUTOJOIN feature that was described above allows lists to resolve Foreign Key ID's into useful strings from related tables. BForeignKey is again called upon to clarify queries. So, for example, a list can be generated from a string in the Data Dictionary "Select t.* from Orders where AUTOJOIN.CompanyID, AUTOJOIN.ALL.KeyOnly". This causes the Company.Code and Company.Header columns to appear. Now, if the user sorts on the Header Column, the sort will involve reestablishing that join and applying it to the old QSelection's, Keyset cursor, and then generating a new keyset cursor to replace it. BForeignKey is responsible for maintaining those links. Simply retrieving the data and pushing it into a straight string column would not allow that sort of robustness. (Keep in mind that if the result returned 100000 rows, only the screenful's worth of data is loaded to the client, so sorting on the result string is meaningless. The sort must be performed against the server-side state object, therefore BForeignKey must know how to do these joins). When performing a multi-column search or sort, all the different types of data objects must be able to add their portions to the query without invalidating each other's work. This all involves a meticulous division of labor to avoid permutation problems.

Ad Hoc Queries and Other Features

The Ad Hoc query system is a way of manipulating data. As such it makes use of all of the previous features that have been described.
The Framework supplies the QSelection and Query Tools. The Data Dictionary allows for the description of all components and relationships.
Data Object Variation - BObjects/BPtr system supports all the complex data interpretation
Audience Variation allows and limits access to views, columns within views, and rows that can be accessed using all of the methods that run queries.
Task Variation supplies the basic color and visibility attributes
LocalTable Variation - supports the data caching and the entire method of mimicking a long table with 100,000 rows, while actually downloading only a screenful at a time.
Output Variation allows rows to be export to Excel or Printed, etc.

Using all of the powerful tools above, the entire Ad Hoc Query system requires little or no Code in the Business rules yet allows the most powerful query interface available.

Data Analyzer

Users can generate complex reports from lists, without writing any code. This feature provides an easy to use interface for SQL's 'Group By' feature. Any basic list can be grouped by one or more column and the summable columns will be totaled. The data analyzer also allows the user to add additional columns to a list, essentially building a custom list, by appending columns from any related table. The Framework uses the data dictionary to provide the user with appropriate choices and the framework hides a vast array of complexity associated with joining and data typing. So, for example, in the sample below, a list of Orders was analyzed. The user wanted to summarize the data based on the date that the company record was created and cross reference that against the season of the price list. Neither of these two pieces of information is normally displayed on the basic List of Orders. However the interface allows these columns to be added and used for analysis. The complexities of the join are hidden, even on multi-level joins. If the user decides to hit the 'Show Detail' button to see the detail that made up the two highlighted summary rows, the added columns will automatically appear on the detail as well. This detail could then be used as the basis for another query, a related data, or another report. The user is given various date rounding options and has chosen to round by month. Notice that each column has a % of Total column displayed alongside. The data analyzer has a unique point and click interface to drill into an analyze data in unique ways. See FIG. 87.

General Tables

The General Tables system allows many simple SQL tables to be merged into just a single pair of 'General Tables'. This dramatically reduces the number of SQL Tables, often by a third, and provides a clean robust interface for users. All databases have lots of short lists that users can pick from. For example, this could be a list of 5 phone types or 50 states, etc. Normally these are handled with pop-ups or other separate data management strategies. The key to the GeneralTables system is that the developer does not have to have a separate management strategy for single value fields as the developer does for these small tables. BGeneralTable encapsulates all of the management of a small list into a BObject. A BGeneralTable has the exact same API as every other BObject, so no other strategy needs to be employed. BGeneralTable, like BForeignKey manages joins. So if you look at the example in Feature 7 where BForeignKey had to manage a sort join, you can see that BGeneralTable might be called upon to perform the same join logic. These are very complex features, but since they are all rolled into the object, the Business Rules Document never has to deal with it. It is all part of the strategy to reduce the code by 95% or more.

The GeneralTable system links to the Task Variations feature. It provides the basis for setting the 'FlavorIndex'.

What is a General Table?

The General Table system is a construct of the exemplary system that provides a robust interface for storing and using small lists of information. In a typical application, there are many small lists of information that are needed:

| Example | Code | Description | Extra Columns | Number of Elements | User can Add | Sample Data |
|---|---|---|---|---|---|---|
| Phone Type | Y | | | 5 | Y | Home, Cell, Fax, Beeper |
| Departments | Y | Y | Manager | 10 | Y | Accounting, Shipping, Marketing, etc. |
| Order Type | Y | Y | | 4 | | Produce Sale, Repair, Consignment, PO |
| Email Status | Y | | | | | Que, Hold, Sent, Fail |
| Approval Code | Y | Y | | 4 | Y | Favored, Probation, Suspended |
| Price List Type | Y | Y | | 5 | | Sales, Closeouts, Purchase |
| Shipping Method | Y | Y | | 15 | | UPS1, UPS2Air, UPS2, FedEx1, FedEx2… |
| Sales Season | Y | Y | Start Date, End Date | 10 | Y | Xmas, Valentines, MothersDay |

TABLE 6

There are many ways to store these types of information:
Resource
Member Variables
Static Array
CArray
AArray
TLocalTable (Multiple AArrays)
General Table in SQL
Regular SQL Table

All ERP applications have to handle these types of information. Many problems occur because there are too many types of data and too many ways to store them, leading to inconsistencies and very bad code.

For example, let's say there are 4 Order Types. What is known about this data is that the users cannot add Order types at will, since each requires programming to handle it. Also, it is not desirable to create a regular SQL table for a list with just 4 static elements. So one might store it in a AArray or Static Array at startup. The same strategy might be used to hold Email Status. But Phone type is different. The users can add Phone Types. So we might store them in an SQL Table, then dump it into a TLocalTable as needed. So already, we have an inconsistency - Order Types stored one way, and Phone types another.

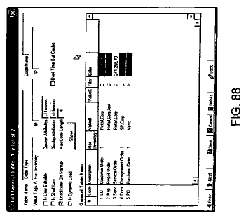

To compensate for this, the exemplary system introduces the concept of a 'General Table'. The General Tables system uses 2 SQL tables - GeneralTables and GeneralTableItems. Rather than using static arrays or small SQL tables, OrderType and PhoneType are simply 2 rows on the SQL GeneralTable. Their items co-exist on the GeneralTableItems table. A GeneralTableItem can have a Code, a Description, a Sort order, Color, Filter, and up to 3 more elements of string data. See FIG. 88.

Basically GeneralTables are a convenient way to store simple lists. Which lists should be stored as General Tables? Almost every small static list would be more manageable if it were promoted to a General Table. And many database tables could benefit by being demoted from regular tables to GeneralTables. If one reviews most DB Structures, one will see that there is not only a quantitative difference but also a qualitative difference between a GeneralTable and a regular SQL Table. General Tables are therefore much more appropriate for many SQL tables.

A regular SQL Table uses an ID number as its key. But a General Table uses either an ID Number or a unique code. The unique code is recommended for most uses. The code is very useful because many of these small lists appear repeatedly throughout the database. If you are using a Unique ID to store these, you have to perform a join to sort rows. With a General Table, an abbreviated code replaces the UniqueID, making the data readable without performing a join. Where the description or other data is needed, network traffic and joins are avoided because GeneralTables are cached at startup. The exemplary system handles the lookups locally and manages refreshing the cache using the Cache Management system which will be described below. The benefits of using General Tables are as follows:
Very flexible - can handle many different classes of data.
BGeneralTable hides all of the complexity involved at nearly every stage including joins on QSelection sorts
General Table Lookups provide a very robust, flexible and user-friendly interface, compared to pop-ups or other selection mechanisms.
Interfaces provided for users to add rows on the fly.
Use of code vs ID eliminates the need for many Joins.
Use of code vs ID eliminates the need for many network calls.
Color Coding system
Caching the 2 SQL tables used by the General Tables system is much more efficient than caching many, many small database tables. Also, Cache refreshing is efficiently handled by exemplary system periodically.
One doesn’t need a separate Edit and List dialogs for each General Table data. If you have 50 GeneralTables you still have just one provided screen of the exemplary system to edit them all. This is an incredible reduction in Business Rules Document code.

General table lookups are fully integrated into the Standard lookup system which is used on all Edit Forms plus, the Find dialog, The Apply to Highlighted dialog, Sort Dialog, etc. Static arrays would need additional programming to be fully integrated. See BGeneralTable.

Flow of Control Management for the 6 Major Types of Windows

GUI operating systems, like Windows, require developers to understand what is called 'Event Programming'. The simplest way of explaining Event Programming is just to say that with a Window's based system, the user is liable to do anything at any time. And programmers need to be prepared to handle any event that is thrown their way, at any time. There are a lot of variables that can throw developers off.

The exemplary system makes it possible for developers to avoid the overwhelming bulk of this problem. It provides handlers that deal with the six major classes of screens that are common to ERP systems. It provides a way for Application Developers to override or supplement the default handlers of the exemplary system, but for the most part this is simply unnecessary. The six major types of windows are:

List Records - Shows a list of SQL Records. Creating these is so easy that most are created entirely within the Data Dictionary, without ever having to write a line of C++ code.

Edit Record / Modal Edit Record - The Edit Order screen shown above is an example of an Edit Record Screen. These can be loaded modelessly or modally (no easy task)

Edit Dialog - Misc edit screens which don't apply to a single SQL Record. Generally, these are modeless windows which process data and have an OK and Cancel button.

Modal Dialog - These windows are loaded within the pump of a single message and set up a secondary pump loop. Thus they can be loaded in-line, wait for the user to respond, and then continue the stack from the point at which the window loaded.

Inline Status / Progress window (externally controlled window) - An example would be a window that shows the user a counter or progress bar while some data is being crunched. The trick here is that the window is loaded and then drawn, but returns execution to the caller's stack. The caller then continually updates the window with new information. Each update redraws the controlled window by generating a new pump loop and allowing drawing messages to execute on each cycle.

Independent Window (i.e. Multi-Threaded Log) - This type of window is a modeless window which allows data updates from outside its main controller. Thus multiple documents can post messages and affect the data.

Instead of requiring Application Developers to supply window handlers, Developers simply supply documents. Documents are containers for holding and managing data. Then the exemplary system supplies a handler to continually manage and redraw the document. So developers deal with the business rules, not with all of the complex computer interface issues.

Some interesting features of the exemplary system window system are as follows:

Minimal-Modal Windows - Usually, when a modal window is created, all other windows in an Application are suspended. With the exemplary system, only the window which spawned the Modal window (the dependant parent window) is suspended.

Multiple copies of the same Layout - So a user can edit two orders side by side, or show two separate customer lists.

Multiple Views per Table - For example, one list of orders might show the sales information, while another shows the shipping information.

Context Sensitive Toolbars - Each Window can have it's own toolbars which show various canned searches ('Find' Macros), sorts, relevant reports, related data links etc.These toolbars are created automatically for each window, based on information in the Data Dictionary.

List View Interface

As mentioned in the previous feature, the exemplary system provides a way for users to see a List of SQL Records. The exemplary system provides a vast array of tools for creating these. The following is an exemplary list of orders that was created entirely within the Data Dictionary. There is no C++ code required to create this. The Data Dictionary contains the name of the layout, security information, and the following exemplary portion of a SQL query:

"Select t.*, AUTOJOIN.CompanyID, AUTOJOIN.ALL.KeyOnly"

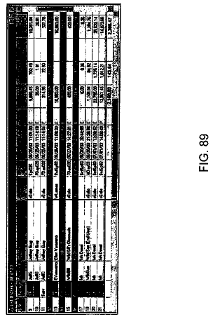

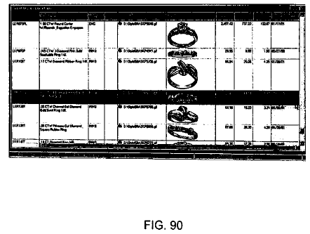

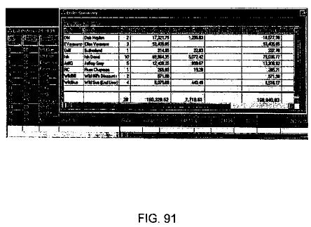

Using this exemplary portion, the exemplary system can create the exemplary layout in FIG. 89.

The exemplary system may have “Administrator Defined Layouts” features.

Given the simplicity of creating lists, Administrators can add lists without the aid of a developer. New lists do not require the program be recompiled, only that users log off and on to refresh their Data Dictionary.

The exemplary system’s rules for Audience Variation apply to Lists as well as Edit views. So the same portion of SQL code can yield a different display for each user, based on security settings in the Data Dictionary.

The exemplary system may also provide a list view interface feature of “Auto-Managed Joins.” A simple query like "Select * from Orders" would return unreadable Foreign Keys. That is, it would show Order Columns like Order.CompanyID (which would not be very meaningful) to a user. Instead, the exemplary system may perform the necessary joins automatically, yielding layout shown above. The code "AUTOJOIN.CompanyID" indicates that when joining to the Company file, the default join should be performed. The Company Table itself defines which columns adequately describe it. So the Data Dictionary entry for the Company Record says that the Company.Code and Company.Header columns are to be used by anyone wishing to join to the company. The other code portion "AUTOJOIN.ALL.KeyOnly" says that all remaining joins should use only the 'key'. So the join using Order.SalesmanID uses only the Salesman.Abreviation and not the Salesman.FirstName and Salesman.LastName columns too. The PricePlan column similarly shows only the key and omits the PricePlan.Description column.

The exemplary system may also provide a list view interface feature of “Highlight/Scroll Tools,” wherein dialogs allow complex highlighting and scrolling functions. These functions may include searching and matching options, inversions, ranges, etc. An example may be when a user selects highlighted rows, those rows are “remembered” by the exemplary system and maintained when switching views, or creating a copy of the screen.

The exemplary system may also provide a list view interface feature of an “Add Highlight Tools” feature. For example, in the figure above (FIG. 89), the three highlighted rows have been added in the footer.

Another list view interface feature of the exemplary system may be “Column Locking.” In the figure above, the horizontal scrollbar on the bottom of the list begins at the Salesperson column. In the exemplary system, as the user scrolls to see the columns on the right, the Order UID, and Company name remain visible. In both examples shown, the column selected for the lock was the default automatically calculated by the exemplary system using Data Dictionary information.

The exemplary system may also provide for list view interface features that relate to automatic column width calculations. In the figure shown above, all columns are an appropriate width, even though no developer code is provided. Column widths adjust in real-time. So, for example, if an Add Highlighted action yields a total that is wider than the displayed column width, the column will automatically widen itself. However, in the exemplary system, users may manually change column widths as well.

The exemplary system may also provide a list view interface feature of “Column Attributes.” Since Column Attributes are defined in the Data Dictionary with the SQL column definition, and not with the individual screen, column attributes can be supported on Lists automatically. Where a column has multiple attributes, depending on the flavor, a variety of options are available for resolving the attribute, including the ability to vary the attribute on a cell-by-cell basis, rather than on a column wide basis, or to merge the attributes using the least restrictive one.

The exemplary system may also provide a list view interface feature of “Main Flavor Column Coloring.” For example, the Main Task Flavor, in this case, the Order.Type_g column, shows in user defined colors. These colors match the colors shown on the edit screen.

The exemplary system may also provide a list view interface feature of “Multiple Views.” With multiple views, any number of column sequences can be created for a given SQL Table, and switching between one view and another maintains the highlight and scroll position. See, for example, FIG. 90.

The exemplary system may also provide a list view interface feature of “Column Header Sorting.” With this feature, columns can be quickly sorted by clicking on the header. The header then changes color to indicate sort by that column. In the exemplary list screen above, the list has been sorted by the first column, the header of which appears in a different color or shade from the headers of other columns. A second click of that header reverses the sort. In the exemplary system, Column Header Sorting is even supported on joined and calculated columns.

The exemplary system may also provide a list view interface feature of “Auto-Manage URL Fetches / Fetch Cache” feature. For example, in the figure above, the PhotoURL column is a SQL column. Only the URL string is stored in the database. The Photo Column has been automatically generated, based on the URL. The URL can be any file on the internet. The exemplary system manages a cache so that as the user scrolls up and down, images are pulled from the cache and not refetched.

The exemplary system may also provide a list view interface feature of “Clipboard Support.” This feature enables highlighted rows, which may include headers, to be copied and pasted to Excel or other programs. Since Excel and most programs will not accept images mixed with text in a single paste operation, the images are replaced with meaningful text such "JPG 3467 Bytes", instead of just a blank. If a user desires to copy a single cell, instead of a row, image copy and paste are also supported.

The exemplary system may also provide a list view interface feature of “Automatic Variable Row Heights.” With this feature, rows expand in height to fit the height of the various images. For example, in the above image, images of jewelry appear in the list, and the heights of the rows automatically adjust to accommodate those images. The exemplary system implements this feature for long text as well as images. While text will wrap and the row will expand in height to accommodate the text, the exemplary system does not break a long word. Instead, if a long word is too wide to fit in a column, the column will be made wider.

The exemplary system may also provide a list view interface feature of “Row Caching.” With this feature, there is no upper bound to the number of rows that can appear in a List. Only the visible rows are actually transferred to the client. The remaining portion of the list exists as a list of pointers on the Server. This enables the user can scroll up and down on a list of a multitude of rows just as easily as on a list with a few rows. In the exemplary system, the last few hundred rows accessed are saved in a cache, to allow quick updates if the user is scrolling up and down a list.

Another list view interface feature that may be provided in the exemplary system is “Row Updating.” The Record Editing system works with the Row Caching system. If a user updates a row using an edit screen, the row will automatically be updated in any list that it appears in. If the updated row has scrolled out of view, but is still in the cache, it is cleared from the cache. So an update will be performed only if the record is scrolled back into view.

The exemplary system may also provide a list view interface feature “Edit in List (Bulk updates).” With this feature, a developer can specify columns that allow bulk updates. For example, if a salesperson quits, a decision may be made to split his/her 100 customers by sending half to one salesperson and the other half to another. The user can highlight any set of rows and perform a bulk update. In this example, if the name of the former salesperson would be replaced in those highlighted rows with the name of the succeeding salesperson.

The exemplary system may also provide a list view interface feature of “Deletion Tools.” With this feature, bulk delete is supported where security permits. The exemplary system provides tools for cross referencing relations,which finds conflicts that prohibit deletions.

The exemplary system may also provide a list view interface feature of “Status Bar Information.” The status bar of the exemplary system may show UID, Last Modified Date, Time and User for each row as the cursor passes over it. It also may show the current scroll number and the number of rows highlighted and any other sort information.

The exemplary system may also provide a list view interface feature of “Complex Search Tools.” This feature may work extensively with the Reusable Query Result feature to provide complex search tools, including support for a dozen menu items.

The exemplary system may also provide a list view interface feature of “Save / Restore Search Results.” This feature allows a user to return to work on a list later, or even email the list to another user.

The exemplary system may also provide a list view interface feature of “Summarize Highlighted.” In the above exemplary figure, FIG. 91, the exemplary system is operative to enable a user to select highlighted entries in a list of orders and summarize the selections by Company. Notice that the summary key, Order.CompanyID, is a ForeignKey which has been automatically resolved. The 'Row' column has been added to show the number of rows which make up each summary. Only columns that are summable have been summarized. Other columns, such as the OrderDate and Salesperson have been stripped. In the exemplary system, generating the list, including the rules for this summary, only required the code snippet and data dictionary information. No C++ code was required to generate this function.

The exemplary system incorporates a powerful reporting system. The system has many options. Developing a system which allows so many options, without creating permutations conflicts, requires careful thought and planning. The exemplary system may allow developers to reuse code. For example, in other systems, let’s say that a developer writes a report. Later it is decided that the report needs to be dumped to a spreadsheet or sent to someone via email. Does the original code need to be modified to accomplish this? Or worse, does the original code need to be copied and pasted into a new report and reworked completely?

This kind of problem leads to permutation problems that have been described above. Code is copied over and over and reworked as a method of incorporating variations. This leads to an explosion in the size of the program, and to inconsistent availability of features.

The exemplary system tries to combat this by developing a comprehensive report management system. To do this, the many options that are available have been identified and broken into distinct groups with clearly defined interfaces. As mentioned before the exemplary system comprises Layers 3-5.

The reporting system exists mostly at Layer 5, but is itself divided into 7 mini-layers. Defining and managing the boundaries between these interfaces allows the report system to expand geometrically in power, without causing permutation problems with the code.

Taking a look at these boundaries, here are some basic questions that need to be addressed:
How is the report launched?
What criteria or options are available?
What are the values for these options for the current job?
What client machine is going to execute the job?
When is the job to be run?
Where is the report to be output?

The architecture is designed in a way that for each job, each of the above questions is answered independently. Different managers can be installed to manage each layer, interfacing with the layers above and below along clearly defined boundaries. The general principle is very similar to the 7 layers of translation that make up networking (ISO/OSI Network Model - see: http://www.webopedia.com/quick_ref/ OSI_Layers.asp). These seven layers are:
Physical
Data Link
Network
Transport
Session
Presentation
Application

In this scheme, each layer can be replaced independently. At the Application layer, one can replace Internet Explorer with Netscape. At the Network Layer, one can replace TCP with AppleTalk. At the physical layer you can replace coaxial with microwave transmission. Each layer only really cares about the layers it directly contacts. This is what makes the mix and match system possible. It allows for the development of new, powerful options at each layer, without causing backwards compatibility problems that would otherwise prohibit innovation. For example, VPN strategies can be developed independently from browser technology. Thus, the networking architecture is extremely powerful and well thought out.

The report system has been developed with this is mind. Let’s examine some of the known options that need to be available at each layer
LAUNCH LAYER - How is the report to be launched?
From a List Layout by selecting the report in the toolbar
From an Edit Layout by selecting the report in the toolbar
From the main Report Menu
Via code
Via a script (Macro or Background job)
SERVICES LAYER - what common API tools do all reports need?
Access to standard formatting tools
What criteria or options are available?
Selection based Reports
Criteria Based Reports
Generically Defined Criteria
Custom Defined Criteria
OPTIONS LAYER - What are the values for these options for the current job?
Interact with User to get value of options
Pull values from storage

/----Job completely defined at this point. Job----/

/----could be serialized and moved or delayed ----/
JOB LAYER - When is the job to be run?
Execute Now on Current Machine
Put in Queue on Current Machine
Put in delayed Queue on Current Machine (i.e. a local overnight manager)
Send to Background Manager (Run on a separate machine)
Send to Overnight Manager (Run on a separate machine)
GENERATION LAYER - Oversees document(s). Can create multiple documents. For example, is this a report on the 100 records the user selected or is this 100 reports, 1 for each record selected? Also, provides basic services to Document, such as stamps, and sysobjects.
DOCUMENT LAYER - This is the class for the actual Business Rules of the report. Each report has it's own handler that you will define.
OUTPUT LAYER - Where is the report to be output?
Printer - Pick Driver and device, nCopies, page range, paper tray.
Email - Pick From/To Addresses (single pair for batch or for each doc in batch)
Export - Pick Path (single path for batch or for each doc in batch)
Print Screen (CDC with formatted breaks, header and footers)
Screen List (Scrollable TLocalTable with no breaks)

If one begins to think through this system, one will begin to see the power that is available. The power comes about because each layer can be expanded and made more robust, without conflicting with code already written for other layers. As long as the boundaries between the layers are standardized, the layers themselves can grow independently.

For example, by creating a separate LAUNCH LAYER, we can provide the ability to define a job via a script. That is, the job can be defined in some sort of a text based format, rather than only through code based formats. The JOB LAYER allows a job to be launched via the Overnight Manager. Overnight Manager strategies can be developed independently from the document code or the Launch code. New timing options, such as weekly or monthly runs can be added. By separating the OUTPUT LAYER from the DOCUMENT LAYER, there is the ability to open up the possibility of emailing or exporting the report, without affecting the document.

Development of various handler features will be (largely) compatible with all documents. Once the kind of robust handlers that are needed have been developed, the task of emailing a report to each vendor will become a trivial administrative task, rather than a long programming task.

Basically, each developer deals primarily with coding the DOCUMENT LAYER. This is the layer at which report-specific code is written. The DOCUMENT LAYER is also special because other layers will often have to consult the DOCUMENT for handling instructions - ultimately the DOCUMENT layer should have the final say on the report.

Both the Network Protocol system and the report system of the exemplary system are idealized models. This means that both strive to make each layer as independent as possible, but this may not always be achievable. For example, in theory the Physical layer should not make a difference to the Application layer. For instance, Outlook Express (Application Layer) should not care whether the email is sent over twisted pair or satellite (Physical Layer). But in reality, this independence does not hold in all cases at all times. So an Application layer application that deals with streaming 2 way audio may not work as well over satellite. Similarly, some DOCUMENTS may not be able to use all features available from all layers.

For example, not all documents of the exemplary system will work with all OUTPUT layers. A typical document deals with printing a TLocalTable with added break level processing. This type of report should work well with any output viewer. But a report that prints pre-formatted labels with barcodes, etc, may not export to a spreadsheet very well. So the system is idealized. But keeping the distinctions in mind is important, in and of itself. This will allow for maximum compatibility.

Each layer of a Network job may need to attach layer specific information which can then be read and understood by other programs functioning at the same layer. For example, a Session Layer breaks a job into packets and attaches packet information as it prepares to send the job. The receiving Session software reads the packet info and reassembles the job. Since Network jobs are by their nature serial, this type of data is added as a header onto each packet. There are several strategies that can be employed to serialize data. If all the parameters are known in advance, one could just concatenate them together as a header and retrieve them by position. But if all the parameters are not known, then you can create a table of named parameters. Emails are formatted this way:

Message-ID: <005701c1a36d$dc798a00$7a539c42@snowdog>

From: "Ima Sender" <ima.sender@sample.com>

To: "Ima Receiver" <ima.receiver@sample.net>

References: <20020122172947.NQMN19161.imf03bis.bellsouth.net@[66.156.36.10]>

Subject: Re: thanks

Date: Tue, 22 Jan 2002 12:54:36 -0500

MIME-Version: 1.0

Content-Transfer-Encoding: 7bit

X-Mailer: Microsoft Outlook Express 6.00.2600.0000

Content-Type: multipart/mixed; boundary="multipart-FRI,_MAY_31,_2002,_10:53_AM"

This header can be parsed into a simple table

PARAMETER NAME PARAMETER DATA

Message-ID <005701c1a36d$dc798a00$7a539c42@snowdog>

From "Ima Sender" <ima.sender@sample.com>

To "Ima Receiver" <ima.receiver@sample.net>

References <20020122172947.NQMN19161.imf03bis.bellsouth.net@[66.156.36.10]>

Subject thanks

Date Tue, 22 Jan 2002 12:54:36 -0500

MIME-Version 1.0

Content-Transfer-Encoding 7bit

X-Mailer Microsoft Outlook Express 6.00.2600.0000

Content-Type multipart/mixed; boundary="multipart-FRI,_MAY_31,_2002,_10:53_AM"

This type of table is perfect for storing variable types of data. Any handler can read from the table or attach new information. For example, Outlook express adds the 'To:' parameters, but some lower level layer adds the 'References:' parameter.

Taking a quick look at the jSystemSettings Edit screen, one will see a very similar system. Each data object is a Name plus the data, stored as a binary. The tools for managing setting, accessing and serializing the table are already built into the BDataCatalog data object. So this is really simple in the exemplary system. So, now a structure begins to emerge for the reporting system. There are many layers of actions, each with their own flow of control and parameters. So the system looks like this:

A table of Parameters which is capable of storing any type of data and is also capable of serialization can be created. This allows each handler to work with a single data structure. The entire reporting cycle is divided into the aforementioned layers. Rather than try to create a single manager that is responsible for handling all options, each layer gets its own handler class. This allows future reports to work with future handlers. Each handler is responsible for managing its own parameters by providing a dialog for editing them. This is very similar to GSystemSetting/ PHandlerSystemSetting. Default handlers will be created for the basic system, and others added in time.

So now we one see what a RReport Object must look like to support all of this. RReport is a TLocalTable with 3 columns, LAYER, PARAMETER_NAME, PARAMETER_DATA. Note that LAYER & PARAMETER_NAME may be concatenated to form a single key so that Report will really be just KEY, DATA (a classic BDataCatalog).

Here is the structure for a very simple report:

LAYER PARAMETER NAME PARAMETER DATA

DOCUMENT Handler RSalesReport

OUTPUT nCopies 2

Note that where not specified, all layers use the default handler for that layer. So the OUTPUT parameter nCopies is managed by the RPrintManagerBasic handler. The default JOB Handler is RPrintNow, but we could change this by adding:

JOB Handler POvernightManager

JOB TimeStart 3AM

JOB Days Mon,Wed,Fri

Since the overnight manager runs on another machine, we may want to specify the printer that this report is supposed to go to:

OUTPUT Device JohnsHP2000

OUTPUT PrintSettings <Serialized PrintSettings Structure>

If the report needs to be emailed instead of printed, we could change the output handler and assign new parameter data:

OUTPUT Handler REmail

OUTPUT From Info@Company.com

OUTPUT To SalesManager@Company.com

If the report is divided into regions, each with its own SalesManager, we could change the GENERATION LAYER handler to set up a report Loop. The DOCUMENT RSalesReport could be edited to change the "OUTPUT To" address on each loop. This type of change is an example of where one layer does need to interact with another layer. The GENERATION LAYER can provide looping services, but only if the DOCUMENT supports that service.

GENERATION LAYER Handler RReportManagerBasic

GENERATION LAYER LoopBreakOn Region

To change the records that are reported on, one could add a From/Where/Order by clause to the LAUNCH LAYER.

LAUNCH LAYER Handler RLaunchManagerBasic

LAUNCH LAYER SQLWhere t.CreditStatus = 'Active' and t.SalesYTD > 100

A more sophisticated Launch handler could be constructed which could accept a standard find screen and serialize it into a QQuery.

LAUNCH LAYER Handler RLaunchManagerAdvanced

LAUNCH LAYER QQuery <Serialized HLFind Dialog data>

or

LAUNCH LAYER SQL <some Query pulled from HLFind dialog>

While each layer is responsible for maintaining its own data members, any layer can see or even edit the members of another layer.

Reports and the Other Features

Aside from the special launching layers that are described here, Reports are a version of Output Variation. They are documents that make use of all of the features described above in that section including Audience Variation, Task Variation, LocalTable Variation and of course all of the BObject logic. The Report DOCUMENT layer referenced here is simply an expanded DDocument which has already been described above.

BObjects can be queried to measure their required output size. This allows viewers, such as the Report Viewer to perform functions like ‘Shrink to Fit’ and other scaling functions. This prevents truncated reports, allows for long text to expand to other multiple lines and avoids truncating columns with or ending them with ellipsis, which you often see in many applications.

Query / ODBC Management

The exemplary system accesses SQL through ODBC. It provides a robust query API for developer. So for Example:

TLocalTable myTable;

QQuery q("Select * from SKU where UID > 5", &myTable);

These simple lines of API code are all that is needed to fully populate myTable. The exemplary system performs a host of functions to make queries easy:
Automatically fills data containers from query Results. In the example above, a TLocalTable is filled. TLocalTable can hold the results of any query. Other data containers susch as QRecord, AArray or any BObject can also be used.
Allows multiple result sets (multiple queries blocked into a single network call) to be returned into different data objects.
The query is parsed and makes Full use of the exemplary system's complex data typing and Data Dictionary. So when the query above returns, the TLocalTable will contain an AArray column which points to a QRecordColumnTemplate for SKU. ImageURL. So everything that there is to know about the column is at the developer's fingertips. This AArray will hold BURL data objects, etc.
Single result columns can easily be expanded to multiple columns to handle AUTOJOINS (show above in Feature number 11), GeneralTable Joins or URL Lookups. The expanded columns are separate, yet link to the original to allow various block functions.
Full library of query building tools, including help with complex joins.
Saving a data container back to the database is easy. The exemplary system handles so many problems, so the developer can just say: MyObject.Save().
Complex problems such as binary/long-data binding and quote escapement, etc are seamlessly handled by the exemplary system.
If the developer has mixed calculated and joined columns in a TLocalTable, the exemplary system knows to skip these.
If columns in a TLocalTable have been reordered, the exemplary system will handle it.
The exemplary system handles dirty logging of each and every cell in a data container and these are used to efficiently generate Update statements.
The exemplary system handles automatic generation of UniqueID, Last Modified User Date and Time stamps.
On an Edit screen, the Unique ID of the Header Record is generated first, and then used to populate the 'Many' records automatically. The LocalTable Variations system makes extensive use of Query Tools, making most saves very simple for the Application.
The exemplary system can even perform some validation based on Attribute Rules.

Edit Screen Tools

This is actually a collection of miscellaneous features. Quite a number of these features are geared towards users, rather than developers. In general, many developers focus on getting the basics of their screens to work, but do not include the extra features and capabilities. Or, just as bad, developers sometimes put the features onto some screens but not others. By burying these features into the Framework, the user is given a huge assortment of features, with minimal developer input needed. And the features are applied consistently across all screens. These types of features are a great example of the power of 'backwards expansion'. Most of these features have been added to the Framework one at a time, as the system evolved. Yet they are always backwards compatible with old documents. This is achieved because the primary split between document and view has already occurred. So adding new view features can be done without affecting old documents. Keep in mind that these features are in addition to the editing assistance provided by the the various types of Data Objects (Feature number 7).

Edit Controls Automatically Link to Data

Edit Controls have a Property Page created as an ActiveX control. The developer simply types in the SQL Column Name and the exemplary system will link the control to the data automatically (The exemplary system does not use MFC's DoDataExchange or DoFieldExchange). The Property pages also allow default settings to be adjusted. If a Control Name is manually assigned a data type, then the system will create a new data object in the 'BDataCatalog' within the DDocument.

Record Locking Management - Any layout can be presented as Read-Only for any of the following reasons:
Read Only Layout (User has no access - Defined in the Data Dictionary)
Archive Mode (Entire database is locked - Defined as a System Setting in the Data Dictionary)
Multi-User Locks (Another user has accessed the same data)
Polite Loading (Load Read-Only unless user requests Read-Write manually)
Record Complete Locking (Row no longer editable, example: Order has shipped, so it is locked.)

Automatic Object Size Calculations - BObjects can be queried to determine how much screen real estate is needed for them to fit. This has a variety of uses.
It allows windows to expand to fit data. For example, if you review any of the figures that shows data being looked up, you will see that each window exactly fits the data being displayed.
One does not see truncated data in the exemplary system. Many programs "End sentences like th..." The exemplary system will expand table entries to 2 rows, or adjust column widths to fit.
Layout objects are placed on the screen in groups with "Caption, Edit and Description" groups all manifestations of a single object. If multiple objects have different caption widths, the system can automatically calculate those and align the edit and description controls accordingly. This means that if one object changes size, the others will move automatically, without the developer having to reposition them. This type of work is seems mundane but often comprises much of a developer's day. So having it done automatically is a big time saver.
Alternate viewers can make extensive use of these tools. Reports can be scaled so the data fits the page.

Inline Modal Dialogs using Developer Defined (Core managed) Control Rules

Rules are defined in the Dialog Resource by filling in Property Pages on the ActiveX Controls, or by code. Other Databases have simple Rules that can be applied to a Window's Control, like Min/Max Constraints. The exemplary system’s rules are a little more sophisticated. ActiveX control Property Pages capture object descriptions. The Property Pages are designed to capture known, and common settings. The exemplary system provides an additional generic text area to allow other settings that were not specifically hard coded into the ActiveX Property Page. This area can capture less common settings, settings which only apply to one data type, or settings that developers wish to define that go beyond the scope of the Framework. These are the 'Control Rules'. Rules are very commonly used with Modal Dialogs. The exemplary system allows Dialogs to be created in two ways. For complex dialogs, the developer creates a document, just like for any window. But there is a shortcut method that can be used for simpler dialogs. The shortcut is much easier than the normal method. Here is an example of the shortcut, called 'In-Line' creation:

HDialog myDialog;

myDialog.InitRadioChoices("Pick Cereal:","Corn Flakes;Rice Krispies;Raisin Bran");

myDialog.AddCheckBox("Add Milk");

myDialog.AddLocalTable(GETGT("Fruit","Pick Fruits", "CheckItemsDialog");

if (myDialog.DoModal())

etc.

This system of creating dialogs is extremely easy. In most systems, one has to create a layout (Dialog Resource), and then create a separate C++ class to manage the layout, which is put into both a header file and a code file, etc., thereby ending up with extraneous code in many places. Here, no separate resources or classes are needed. The dialog is created as it is needed, in just a few lines of code. However, the shortcut has a minor problem. By the time the window is shown, ALL the functionality must be known to the Framework. The developer is not providing a separate custom controller, so the Framework has to do everything. Unfortunately, what often happens is that developers need just one or two custom actions, and so shortcut has to be scraped in favor of the long method. The Control Rules system is an attempt to add more functionality to the Framework - if more sophisticated rules can be described then many more dialogs can use the shortcut (classic description vs. action savings). This is the real purpose of the Control Rules System. Here are some of the supported Rules:
Range pairs - Puts a rule on 2 controls, allowing them to act as a range (Example: Print Range: From - To)
Min/Max
Lookup Filters - Limit searching on a ForeignKey or General Table Lookup
Dependent Attributes - (Example: Disallow entry in From and To controls if user selected "All Pages" instead of "Print Range")
Object Grouping
Cross Dialog Data Linking - Save/Restore values to the user's last entry. So the next time this dialog is loaded, the user will see his/her previous settings.

So Control Rules, combined with intelligent BObjects that know how to treat their own data, and Automatic Object Size Calculations guarantee that most dialogs can be created inline without separate controllers. This will reduce the number of Business Rule Documents that need to be created.

Error Reporting System

Data Entry screens need validation. The exemplary system standardizes this process. On saving a screen, an Error Reporting List Object is created. When an error is found with a Control or Table Row, or Table Cell, the error is added to the Error Reporting List. The exemplary system checks all of the data against known Attributes and will post errors. Then the Application Document will check for errors too. Errors can be either Fatal or Warnings. If errors are encountered, the user is presented with a dialog. If all the errors are warnings, the user has the option to stop or proceed. If any fatal errors are encountered, saving is stopped. When Errors are posted, the offending controls, Rows or Cells are highlighted by a colored border (Red for Fatal Errors, Green for Warnings). The Framework will automatically scroll tables so that the first error is showing. The color highlights appear while the dialog explaining the errors is shown to the user, so the user can see both at the same time. The highlights stay in place when the dialog is dismissed and are not cleared out until the next attempt at a save.

Modification Stamps

All records can have LastModUser and LastModDate columns. The exemplary system automatically manages these.

Identity Key Management

Auto Assign/Retrieve

Auto Apply to Linked Records

Single Column / Multi-Column Unique Key

Warns or Prohibits on entry of duplicate combinations. For example, the developer can put a rule in the Data Dictionary that says that Customer.FirstName and Customer.LastName together form a key. If a user enters 'John' & 'Smith', the system will automatically go out and look for other John Smith's. If any are found they are shown to the user in a separate window, so that the user can compare the two records. More than one Key combination can be defined for a single table. So a Customer might have "Warning: FirstName/LastName" and "Prohibit: SSN".

Deletion Tools (related data management)

If deletions are allowed, the exemplary system will check to make sure that no ForeignKeys point to the current record. The developer has a simple API whereby some ForeignKeys can be excluded so that they can be handled manually. These tools work on both List (Bulk Delete) and Edit windows.

Record Cloning

Record cloning provides a tremendous feature. Records can be cloned. Assume there is a screen that shows a PriceList in the Header and its 100 related PriceListItems in the LocalTable Area. To create next season's price list, the user can 'clone' the record. The new PriceList will have a new ID and all of the new PriceListItems will point to the new PriceList. Then the user can go through and edit the actual prices and add or remove a few items. This saves the user a great deal of time. Developers specify which screens can use this feature and then get a callback to make any fine tuning adjustments. But this process is mostly automatic.

Import Related Data

As an example, using standard search tools, a user has compiled a list of 30 products which need to be added to a PriceList. The products are on one screen, and the PriceList/PriceListItems show on another screen. In most systems the user would have to type the product list into the PriceListItem area one item at a time. With the exemplary system, there is a pop-up menu item to import them all at once. The exemplary system assures that any normal validation will continue to occur. So if the PriceListItem LocalTable normally alerts the user when a duplicate product is entered, this will occur with the import as well.

Copy Down

Bulk copy a value into multiple rows in a table. This feature also implements standard validation.

Edit Record Log

Edit record log is another great user feature. Each time the user accesses an SQL Row in a Document, the system tracks the Row and the time. At any time the user can pull up the log and see where he/she has been. This feature is a great way to help users with real life situations. Right now the log clears out at the end of each session, but it will be extended to multi-session allowing a week or two of log entries.

AutoSet vs. UserSet Values with Separate Dirty Flags

The Framework makes a distinction between values that were set by the Application Developer and values that were set by the User. As an example, if a value has changed on a screen, then the user is asked if he wants to save the screen before closing. But what if the only value that changed is something set by the developer? What if the only change is that the developer set some default values? Then any time a dialog appears, it will always ask the user to save changes, even if the user was just looking at the record. This can be frustrating. There are many times when it is helpful to have separate dirty flags for the user and for the developer.

Visible Dirty Flags

Users can see at a glance which controls they have edited because all controls have a tiny, unobtrusive dirty flag marking.

Revert Data - Restore Any Edit box, Table Row or Table Cell

For example, consider the situation where a database user has mistakenly typed an entry into the wrong field, but does not remember the overwritten value. Further, the database user does not want to restore the record to its last saved state because the user made so many other changes." This situation is very common with database users. For instance, this may occur when they are entering data while on the phone. The framework provides a great feature to deal with this problem. Every Data Object can store its current and previously saved value. The user can revert any Edit box, Table Row or Table Cell to it's previously saved value. Even if the user has sorted a table, the old values follow along with each cell.

Keyboard Navigation

There exists a problem of mixing mouse-driven controls and keyboard-driven controls. All controls of the exemplary system strive to be mouse-free. The forms themselves also allow Keyboard Navigation. So PageUp and PageDown map to Previous and Next records on Edit Screens. On List screens they map to scroll up and scroll down. The arrow buttons move cells within a LocalTable. If a LocalTable is in 'lookup mode' then the up and down arrows move the highighted row and type-ahead searches for matching strings.

Expand Locked Objects to Full Size

On many forms, the data extends beyond the area of the control. For instance, there are many window's forms where a path name is truncated where the entire path is not displayed. With the exemplary system, pointing at any object and a pop-up menu will allow one to see the text/image full size in a separate window.

Copy Any Object

Sometimes a user wants to copy an object to the clipboard, but since the object is not enterable, the user can't highlight the text and so can't copy it. With the exemplary system any object can be copied to the clipboard, even if it is a locked object or just a non-enterable caption.

Automatic Screen Resize Logic

When a user expands or shrinks a window, objects expand or move automatically. The exemplary system's default logic for this is very intuitive. For example, lets's say that a user has a a dialog with some Edit Controls at the top, a LocalTable in the middle and then some more Edit Controls and Buttons near the bottom. When the user expands the window, the exemplary system assumes that the table should expand. So the top controls are unchanged, the table expands and the controls below it move. Developers can alter these settings but rarely need to.

Simplified Fonts

Applying Fonts to forms in C++ is anything but easy. The exemplary system handles the problem for developers. All that is required is to set up the font on startup and then simply supply the name of the font to any control.

Create Procedure JCreateTables

Create Table jTable (

UID int PRIMARY KEY NOT NULL IDENTITY (1, 1),

LastModUser varchar(20),

LastModDate datetime,

TableName varchar(30),

jDatabaseIDPrimary int,

IsTWCompatible bit,

IsShellItem bit,

Block int,

SingularTitle varchar(30),

PluralTitle varchar(30),

ShowInToolbarNew bit,

ShowInToolbarList bit,

ShowInToolbarFindOne bit,

ShowInToolbarFindMany bit,

LayoutForAddingRows varchar(20),

tMultiColumnKeyTable image,

tLookupPathFormats image,

tLookupSelectColumnFormats image,

tDescriptionFormats image,

tSortFormats image,

ColumnNameForID varchar(15),

ColumnNameForLMUser varchar(15),

ColumnNameForLMDate varchar(15),

ColumnNameForLineNo varchar(15),

ColumnNameForGTFlavor varchar(30),

ColumnNameForMainKey varchar(15),

SupportsFlavors bit,

UseRowFlavors bit,

ReadOnlyCacheSeconds int,

jClientCacheTimesID int,

UIDGenerationMethod_g varchar(8),

QRecordClassName varchar(30),

QRecordTemplateClassName varchar(30),

AllColsNoReadIfNoListAccess bit

)

Create Table jDatabase (

UID int PRIMARY KEY NOT NULL IDENTITY (1, 1),

LastModUser varchar(20),

LastModDate datetime,

DBName varchar(30),

ConnectionString varchar(255)

)

Create Table jReplicationServers (

UID int PRIMARY KEY NOT NULL IDENTITY (1, 1),

LastModUser varchar(20),

LastModDate datetime,

jTableID int,

jDatabaseID int

)

Create Table jCompile (

UID int PRIMARY KEY NOT NULL IDENTITY (1, 1),

LastModUser varchar(20),

LastModDate datetime,

VersionNumber int,

UpgradeOnOvernightIdle bit,

Comments varchar(50),

FTPAddress text

)

Create Table jCompileComponent (

UID int PRIMARY KEY NOT NULL IDENTITY (1, 1),

LastModUser varchar(20),

LastModDate datetime,

jCompileID int,

jComponentID int

)

Create Table jComponent (

UID int PRIMARY KEY NOT NULL IDENTITY (1, 1),

LastModUser varchar(20),

LastModDate datetime,

ComponentName varchar(20),

VersionNumber int,

FTPAddress text,

ZippedComponent varbinary

)

Create Table jDialog (

UID int PRIMARY KEY NOT NULL IDENTITY (1, 1),

LastModUser varchar(20),

LastModDate datetime,

)

/*

Create Table jUniqueSeries (

UID int PRIMARY KEY NOT NULL IDENTITY (1, 1),

LastModUser varchar(20),

LastModDate datetime,

NextNumber int

)

*/

Create Table jColumn (

UID int PRIMARY KEY NOT NULL IDENTITY (1, 1),

LastModUser varchar(30),

LastModDate datetime,

jTableID int,

ColumnName varchar(30),

ExtendedDataType_g varchar (30),

DisplayFormat varchar(15),

EntryFilter varchar(15),

AttributeString varchar(20),

DefaultWidth int,

IsSummable bit,

GeneralTableID int,

jTableIDRelation int,

LookupFilterOnEdit varchar(50),

LookupFilterOnFind varchar(50),

RelationAltColumnName varchar(30), --Example: if ((TableName = Product) && ((jTableIDRelation == CompanyID)), then RelationAltColumnName might be "Supplier" or "Vendor"

AllRead bit,

AllWrite bit,

IsGTList bit,

IsSnapshotOf varchar(60), --Example, OrderItem.UnitPrice is snapshot of "PricePlan.UnitPrice"

ActiveRules varchar(1000)

)

Create Table jLayout (

UID int PRIMARY KEY NOT NULL IDENTITY (1, 1),

LastModUser varchar(20),

LastModDate datetime,

jTableID int,

LayoutName varchar(40),

WindowType int,

DocumentClassName varchar(30),

ViewClassName varchar(30),

LTableClassName varchar(30),

DialogResourceName varchar(30),

FlavorIndex int,

LoadWithDialogViewer bit,

Block int,

Sort int,

ListQuery text,

ListFilter text,

UserFilter text,

ExpandGTDesc bit,

ExpandURLDesc bit,

ValidFlavors varchar(50),

MarkupMacros image

)

Create Table jReport (

UID int PRIMARY KEY NOT NULL IDENTITY (1, 1),

LastModUser varchar(20),

LastModDate datetime,

jTableID int,

ReportName varchar(80),

DialogResourceName varchar(30),

Sort int,

Block int,

LayoutName varchar(15),

ShowInList bit,

ShowInEdit bit,

UseAll int,

UseList int,

UseSpecial int,

TextForSpecial varchar(40),

StartDateType int,

EndDateType int,

PageType varchar(2),

Thumbnail varbinary,

Description varchar(255),

TableName varchar(30),

IncludedFile int,

DisplayChoices varchar(15),

MinimumMemory int,

UseSelect bit,

NeedsHighlight bit,

SendToBackMgr varchar(10),

OwnerUserID int,

AddressFormat varchar(20),

ForceLoop bit,

AllowALSExport bit,

HasPreLoadEvent bit,

ALS_NumberAlias int,

BackMgrHandler varchar(15)

)

Create Table jMacro (

UID int PRIMARY KEY NOT NULL IDENTITY (1, 1),

LastModUser varchar(20),

LastModDate datetime,

jTableID int,

gToolBarType varchar(6),

MacroName varchar(60),

HandlerClassName varchar(35),

Variation varchar(20),

DataTable image,

Block int,

Sort int,

ShowInList bit,

ShowInEdit bit,

FollowByStandardSort bit

)

Create Table jRole (

UID int PRIMARY KEY NOT NULL IDENTITY (1, 1),

LastModUser varchar(20),

LastModDate datetime,

RoleName varchar(20),

Sort int,

MinimumCompile int

)

Create Table jUser (

UID int PRIMARY KEY NOT NULL IDENTITY (1, 1),

LastModUser varchar(30),

LastModDate datetime,

UserName varchar(20),

FirstName varchar(20),

LastName varchar(20),

IsActive bit,

UniversalLink varchar(30),

Department_g varchar(20),

PhoneObject varchar(255),

Settings varchar(255),

Comments varchar(100),

CurrentPassword varchar(12),

LastPWDate datetime,

PW1 varchar(12),

PW2 varchar(12),

PW3 varchar(12),

nAccess int,

LastAccess datetime,

nFailedAccess int,

LastFailedAccess datetime

)

Create Table jUserRole (

UID int PRIMARY KEY NOT NULL IDENTITY (1, 1),

LastModUser varchar(30),

LastModDate datetime,

jUserID int,

jRoleID int

)

Create Table jResourceRole (

UID int PRIMARY KEY NOT NULL IDENTITY (1, 1),

LastModUser varchar(20),

LastModDate datetime,

jRoleID int,

jLayoutID int,

jMacroID int,

jReportID int,

jColumnID int,

ReadOK bit,

AddOK bit,

EditOK bit,

EditInListOK bit,

DeleteOK bit,

OtherAccessFlags varchar(50)

)

Create Table jSystemSetting (

UID int PRIMARY KEY NOT NULL IDENTITY (1, 1),

LastModUser varchar(20),

LastModDate datetime,

GroupName varchar(20),

Description varchar(100),

IsShellItem bit,

HandlerClassName varchar(35),

DataTable image

)

Create Table jClientCacheTimes (

UID int PRIMARY KEY NOT NULL IDENTITY (1, 1),

LastModUser varchar(20),

LastModDate datetime,

Code varchar(40),

IsShellItem bit,

InsertTimeout int,

UpdateTimeout int,

DeleteTimeout int,

Other1Timeout int,

Other2Timeout int,

CacheVersion RowVersion NOT NULL,

MasterChangeTime datetime,

InsertTime datetime,

UpdateTime datetime,

DeleteTime datetime,

Other1Time datetime,

Other2Time datetime

)

--drop table jTaskBackGround

Create Table jTaskBackGround (

UID int PRIMARY KEY NOT NULL IDENTITY (1, 1),

LastModUser varchar(20),

LastModDate datetime,

TaskKey varchar(30),

Description varchar(40),

ProcessGroup varchar(20),

Priority int,

BatchLockName varchar(20), --Not supported yet

HandlerClassName varchar(35),

DataTable image,

HandlerMachine varchar(35),

IsInProgress tinyint, -- 1 for in progress, -1 for disabled

TimeCompleted datetime,

NextHandleTime datetime, --Delay when repeating job

RepeatIntervalSeconds int, --86400 for a daily job

nErrors int,

LastErrorMsg varchar(255)

)

/* BatchLockName: This will provide additional concurrency support

Let's say that there are 10 processes which have an effect on inventory. Rather than test for lock conflicts at each step of each the 10 processes, each process simply tries to grap the jBatchLock.BatchLockName = 'Inventory' at the beginning. Only one can lock the 'Inventory' record at a time, so once grabbed, the remaining stages of the process are free of any conflicts from the other 9. Judicious use of jBatchLock can prevent deadlocks before they occur, rather than after. Todo: write a simple stored procedure wrapper for locking and unlocking the jBatchLock. Todo: support jTaskBackGround.BatchLockName if one is is used (skip jobs that can't grab the BatchLockName and release when done).

*/

Create Table jBatchLock (

UID int PRIMARY KEY NOT NULL IDENTITY (1, 1),

LastModUser varchar(20),

LastModDate datetime,

BatchLockName varchar(20)

)

Create Table jTaskServer (

UID int PRIMARY KEY NOT NULL IDENTITY (1, 1),

LastModUser varchar(20),

LastModDate datetime,

TaskKey varchar(10),

ProcedureName varchar(30),

Status int,

DataText varchar(255),

DataBundle varbinary

)

/* This has been rolled into jTaskBackGround with RepeatIntervalSeconds = 86400 (1 Day)

--drop table jTaskOvernight

Create Table jTaskOvernight (

UID int PRIMARY KEY NOT NULL IDENTITY (1, 1),

LastModUser varchar(20),

LastModDate datetime,

HandlerClassName varchar(30),

InputParameters image

jReportID int,

Description text,

IsShellItem bit,

IsActive bit,

Sort int,

)

*/

Create Table jBugReport (

UID int PRIMARY KEY NOT NULL IDENTITY (1, 1),

LastModUser varchar(20),

LastModDate datetime,

LoginUserName varchar(30),

Author varchar(30),

ScreenImage image,

BugMessage varchar(255),

IsFixed bit,

FixedBy varchar(20),

CreationDate datetime,

Priority int,

Group_g varchar(15),

MachineName varchar(40),

MachineType varchar(30),

OSVersion varchar(15),

ShellVersion varchar(20),

ApplicationPath varchar(255),

ApplicationType varchar(15),

ConnectionDNS varchar(255),

FreeMemory int,

PhysicalRam int,

LogicalRam int

)

Create Table GeneralTable (

UID int PRIMARY KEY NOT NULL IDENTITY (1, 1),

LastModUser varchar(20),

LastModDate datetime,

TableName varchar(25),

CodeName varchar(12),

ValueATag varchar(15),

ValueBTag varchar(15),

ValueCTag varchar(15),

IsUserEditable bit,

MaxCodeLength int,

ColumnAttributes varchar(8),

DisplayAttributes varchar(8),

IsShellItem bit,

LoadItemsOnStartup bit,

DynamicLoadClass varchar(30),

DontTimeOutCache bit

)

Create Table GeneralTableItem (

UID int PRIMARY KEY NOT NULL IDENTITY (1, 1),

LastModUser varchar(20),

LastModDate datetime,

GeneralTableID int,

Code varchar(20),

Description varchar(50),

ValueA varchar(50),

ValueB varchar(50),

ValueC varchar(50),

SortOrder int,

Filter varchar(6),

Color int

)

Create Table Email (

UID int PRIMARY KEY NOT NULL IDENTITY (1, 1),

LastModUser varchar(20),

LastModDate datetime,

UserIDSender int,

Status_g varchar(5),

Type_g varchar(15),

Signature_g varchar(12),

SendAttempts int,

DateSent datetime,

ToAddress varchar(60),

FromAddress varchar(40),

Subject varchar(80),

Message varchar(255),

Parameters varchar(40)

)

Technical Note number 1: Reconsidering the position of a Dialog Resource in MFC’s Document/View Architecture

The idea of document / view is to have separate objects to do the following tasks:
Document – Holds, Manipulates and saves data
View- Formats and displays data (output) and handles user events (input)

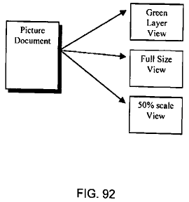

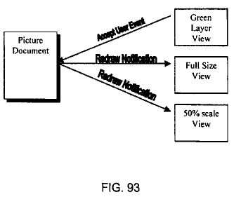

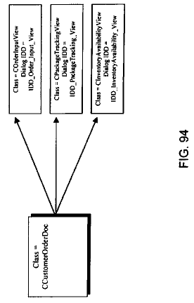

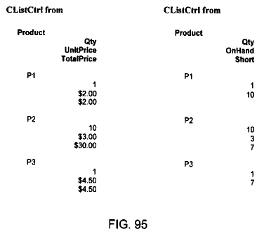

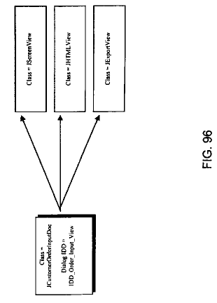

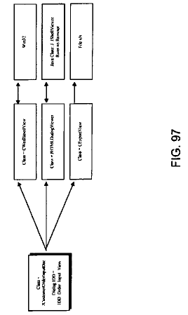

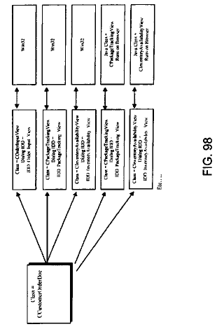

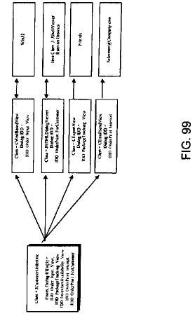

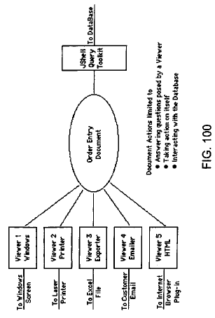

This distinction allows data to be displayed by multiple views. Refer to FIG. 92.

In order to maintain the Document / View distinction, the methods in the Document class can not make any graphics calls, but the member variables can and should store information about how graphics calls should be made:

Not Document / View Compliant:

CDocument PaintText(Text, Font);

Document / View Compliant:

CDocument m_Font;

CDocument NotifyViewsOfFontChange();

CView1 OnFontChange(NewFont);

CView2 OnFontChange(NewFont);

In this system, the Document holds all of the data, and the views can request all or part of that data in order to paint its output. Any view can accept an event from the user and then tell the document to change its data. The document, in turn, should notify all views that some data has changed. The views can then get the new data and redraw themselves (refer to FIG. 93).

Dialog Based Views: Let’s compare 2 very different examples of Document / View, using a database linked Dialog:

Example 1 - MFC’s standard Dialog-based Database Architecture (refer to FIG. 94).

In Example 1, there are 3 views. Each view pulls different types of data from the Customer Order Document. The document supports data requests sufficient to draw each view. In MFC’s architecture, the Dialog is part of the view. In this scheme, the concept of ‘multiple views’ refers to different formats of data. So, where the Picture document has a ‘Green Layer View’ which pulled only a subset of data from the doument, similarly, the CustomerOrder’s InventoryAvailability View, pulls only a subset of data. is up to the view to determine how to show this data is shown and formatted (refer to chart FIG. 95). So, just as the Green Layer view determined which part of the picture so show, these two order views choose how they will display data from the order document.

Example 2 – JShell’s Architecture (see FIG. 96):

In Example 2, there are also 3 views. But the type of views are very different. Instead of being specific to the document, the views classes are specific to the output format or device.

This brings us to an important concept that is critical to a true Document / View Architecture. In a well designed Document / View scheme, the view does not need to know anything specific about the document. So our graphics program can show any document in Green Layer view or any document in 50% view. This is what is expected of the view. In the end, there are hundreds of actual documents, and a handful of views. Each view can show each document. To the view, all the information it needs should be obtainable by querying the document with standard requests.

In MFC’s Dialog architecture, shown in Example 1, this system breaks down. The COrderInputView is capable only of rendering a single document. While the document does allow multiple views, different ways of rendering the same logical view are not supported. So there is no way to render COrderInputView as HTML or as an exportable or e-mailable report. New views must be created to support that. Assume there are 20 Database tables similar to CustomerOrder, each with 3 formats such as input, tracking, and inventory. To support the database with screen, HTML and export views, one would need these classes:

| (a) Class type | (b) Qty |
|---|---|
| Documents | 20 |
| Screen Views | 60 |
| HTML Views | 60 |
| Export Views | 60 |
| Total Classes | 200 |

TABLE 7

In the Jshell architecture, we end up with a very different count:

| (c) Class type | (d) Qty |
|---|---|
| Documents | 60 or less |
| Screen Views | 1 |
| HTML Views | 1 |
| Export Views | 1 |
| Total Classes | 63 |

TABLE 8

In addition, both architectures appear to violate portions of an ideal Document / View standard:
In MFC, CInventoryAvailabilityView seems to hold too much document info, such as specific column names and field names. Just as you wouldn’t expect Microsoft Word to know which words are in which font, why would the dialog view know the names of the field labels? That info should be supplied by the document.
In JShell, JCustomerOrderInputDoc seem to contain view-specific elements such as buttons. Dialogs contain info for creating CWnds which are view elements.

How can a document hold all the dialog information? Well, it depends on the interpretation of a Dialog. CDialog and CFormView classes descend from CWnd and are clearly views. But a dialog resource is not a CWnd. It is a serialized document in that it contains all the data needed to create an actual CWnd. But much like any document, it is possible to have several views of a serialized dialog resource, some of which have no CWnds at all (See FIG. 97).

And like any view, these views choose which information in the document they support. So CExportView can simply skip over buttons because there is no need for them. It might also choose to interpret some of the controls differently. For example, the text from Static and or Edit boxes would be used, but the exact positioning of these items might be ignored or used to simply order the items. Other items, such as JLocalTable, are ideally suited for multiple views. JLocalTable (document class) easily serves as the basis for JLocalTableView (JShell’s version of CListCtrl), JLocalTableHTMLChart and JLocalTableDelimitedOutput.

Reorganizing the Dialog Resource and the View:

Moving the Dialog into the document raises some interesting problems. Some dialog elements seem very much like they belong on the document, while others seem like they belong on the view. A button that says “Find Retail Outlet Nearest to Customer,” seems very much like it belongs with the document. But a button like “Cancel” seems much more like it belongs with the view since it will directly affect what the window shows next. Let’s take a closer look at screen elements, particularly buttons, in order to see how they should be handled in this new architecture. Basically, a button can have 4 scopes:
View scope - Action applies to any document within that view type. Buttons, such as Save, Cancel, Next Record, LockToggle, AddHighlighted, etc. have some document related action, but must be wrapped by some code from the view:

CWndBasedEditRecord::OnToolBarSaveRecordButton()

{

if(JDocument::SaveRecord())

{

JDocument::CreateNewRecord();

ShowDocument()

}

}

JHTMLDialogViewer::OnHTMLFrameSaveRecordButton()

{

if(JDocument::SaveRecord())

{

ShowConfirmationDialog();

if(RecordWasFromList())

GoBackToList()

Else

GoToUsersPreviousPage()

}

}

These buttons should be moved out of the dialog resource, and into the view class, which can create them dynamically as part of the frame of the actual dialog. The document needs to support only the logic that is common to each view’s button:
RecordSet Scope - Any function which applies to a record set and not to any particular view of that record set, can easily be moved out of the dialog and into the ‘Other’ Macro List. This has two added benefits. 1) the function becomes automatically becoming visible to all previous and new views of the same DBTable and 2) Macros have security profiles, allowing them to be hidden from selected users.
Document scope – These buttons can be left on the dialog. Any view which supports buttons can support these by simply passing the command back to the document.
Dialog Scope – These buttons apply only to a specific View of a specific document. To handle these, a new attribute called the ViewAttributeString will be added to the dialog control. This will enable hiding the control based on View type. See description below.

Aside from the button problem, several others can be solved by wrapping the standard dialog controls in ActiveX controls. By wrapping the controls, we can:
Add more properties to each control - The information in the dialog resource is formated specifically for use by the matching CWnd. So an EDITTEXT line from a resource contains the properties of a CEdit control. To support other interpretations, an ActiveX control replaces the EXITTEXT resouce. The ActiveX control can then expose properties in the dialog resource which are needed to create a CEdit, HTML edit etc.
More closely match a Static label with it’s dynamic counterpart - The link between which CStatic applies to which CEdit, is contained only in the positioning of the two separate controls. So the CStatic “CustomerName” sits just to the left of the CEdit IDD_OrderCustomerID. If a view is incapable of reproducing these exact positions, it may find it hard to pair up the correct static label with the correct CEdit value. The ActiveX control contains both the label and the edit box, so other views can interpret them as a single unit. Also, a secondary static, which is typically used as a lookup description is also included in the ActiveX control. All three elements are wrapped together, which is more appropriate for a database form.
Include the SQLColumnName directly on the control – This means that the dialog item can be linked through the JShell framework directly to the JRecordColumnTemplate and JRecordColumn. This property will completely do away with the need to have a ‘DoFieldExchange’ and ‘DoDataExchange’. Also, by linking to JRecordColumnTemplate, the framework can get useful information from the data dictionary such as the DisplayFormat and Entryfilter.
Include Data dictionsary overrides on the control – Overrides what is found on the JRecordColumnTemplate
Include an ViewAttribute String – This allows each control to have a different set of attributes based on the view class. In this way, buttons or other controls can be excluded from certain views.

There is an additional problem remaining. This is the problem of replacing the functionality provided by MFC’s interpretation of multiple views. How can one have a single document handle different Dialogs, in the way that MFC did?

(a) MFC’s Multiple View Architecture (See FIG. 98)

(b) JShell’s Multiple View Architecture:

To handle the multiple views as they are in MFC, a JDocument will be able to support multiple dialog resources. The dialog resource is simply one element of data, among many, that the document can serve up to the view. A Single document could easily support multipe dialogs running an assortment of views as long as both the dialog resource and document remain compliant with the standards that are imposed by JDocument class.

The creation of new View classes, and new dialogs, can proceed independently. Here, a new view class CEmailSendView has been added. There are also two new dialog resources that have been added, which are similar but show slightly different data:
OrderPrint_ForCustomer - has Order header and OrderItem info, company logos, return policies, tracking info, etc.
OrderPrint_Internal - Similar data, but suitable for the salesman - the Order header and OrderItem info, are the same, except profit margin and inventory shortage info are added columns to the OrderItem table. The company logos and return policies are replaced by customer contact info.

But the differences are handled by adding and subtracting items from the dialog, and by changing attribute flags. The JCustomerOrderDoc is largely unchanged. So all the code is the same for populating the table, calculating the order totals, summing the proper columns, finding the billing and shipping addresses, etc. The views are not changed at all. An overnight job can email the saleman’s copy and the customer can view his on the web. (See FIG. 99). Likewise, in FIG. 100, the same order entry document can interact with the database and interface with multiple viewers including Windows, a printer, an exporter to Excel, an emailer, etc.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-readable medium storing computer-executable instructions for performing the steps of:
creating a document having a plurality of variations;
defining for the document a plurality of data elements, including rows and columns of data from which to populate the document;
designating for each data element an attribute associated with the access of that data element based on the each variation of the document;
designating for each row and column of data access rights based on different defined classes of audience;
receiving a request from a user to view a first variation of the document;
determining which data elements are presented in the document based on the attributes;
determining which columns and rows of data are presented in the document based on access rights for the class of audience; and
generating the document for presentation to a user.

2. The computer-readable medium of Claim1, further comprising determining if any of the data elements that are presentable in the document according to the attributes need to be not presented based on the access rights for the class of audience.

3. The computer-readable medium of Claim 1, further comprising receiving a request from the user to view a second variation of the document.

4. 4. The computer-readable medium of Claim 1, wherein the data elements of the document are processed by an application layer.

5. 5. The computer-readable medium of Claim 1, wherein an attribute of a data element is processed by a framework layer.

6. 6. The computer-readable medium of Claim 1, wherein the attributes are task variation attributes.

7. 7. The computer-readable medium of Claim 1, wherein determining which columns and rows of data are presented in the document based on the access rights for the class of audience includes determining the read and write access for the data elements based on the access rights for the class of audience.

8. The computer-readable medium of Claim 1, further including receiving a request from a user to view a list of tables or reports;
based on the request of the user, determining which one of the tables and reports to which the user has rights based on the access rights for the class of audience; and
generating the list for presentation to a user.

9. 9. The computer-readable medium of Claim 1, wherein determining which columns and rows of data are presented in the document based on the access rights for the class of audience is determined after determining which data elements are presented in the document based on the attributes.

10. A hierarchical programming system for manipulating data in a relational database programming application comprising:
at least one container, wherein each container has at least one owned object having data;
a message passing system for passing instructions and contexts from each container to the at least one owned object;
a callback function through which the at least one owned object can call its container;
and
a revertable function callable by the at least one container to revert the at least one owned object from a current state to a previous state.

11. 11. The hierarchical programming system of Claim 10, wherein the revertable system comprising a counter for tracking changes.

12. The hierarchical programming system of Claim 10, wherein the at least one owned object includes functionality independent of its container.

13. The hierarchical programming system of Claim 10, wherein the message passing system for passing instructions and contexts comprises get and set routines operable on parameters.

14. The hierarchical programming system of Claim 13, wherein the message passing system is operable with all data types.

15. The hierarchical programming system of Claim 14, wherein the parameters comprise information specifying a data type.

16. The hierarchical programming system of Claim 10, wherein reverting the at least one owned object form a current state to a previous state comprises changing a current value of the at least one owned object to an original value.

17. A method for managing foreign keys in a relational database system having a plurality of tables, comprising:
defining foreign keys in a data dictionary, wherein each foreign key in a first table defines a relationship to a second table;
specifying, in the data dictionary, search and display characteristics of each table of the plurality of tables, wherein each table has at least one column; and
automatically resolving at least one foreign key to at least one column of the first table based at least in part on the search and display characteristics of the first table.

18. The method of Claim 17, wherein the step of resolving comprises merging the at least one column of the first table with columns of the second table, wherein the first table contains the at least one foreign key defining a relationship to the second table.

19. The method of Claim 18, wherein the merged at least one column of the first table and the columns of the second table is sortable.

20. The method of Claim 17, further comprising an interface allowing a user viewing a second table to graphically explore columns in a first table based upon the at least one foreign key and the search and display characteristics of the first table.

21. The method of Claim 17, wherein the search and display characteristics comprise:
information specifying which columns in each table that are searchable; and
information specifying which columns in each table are displayable on a user interface.

22. The method of Claim 21, wherein the information specifying which columns in each table are displayable further comprises specifying which columns to display when more than one column is available.

23. The method of Claim 21, wherein the information specifying which columns in each table are displayable further comprises specifying which columns in the first table to display based upon a query of a particular column in the second table.

24. The method of Claim 21, wherein the search and display characteristics further comprise information regarding an order in which results rows are displayed.

25. A software framework for managing variations in a programming application comprising:
a task variation system comprising a plurality of task flavors, wherein the task variation system is operable to assign first attributes to data records for each of the plurality of task flavors; and
an audience variation system operable to assign second attributes to objects for controlling access to the objects depending on a classification of a user,
wherein a view is determined at least in part on the first attributes and the second attributes.

26. The software framework of Claim 25, further comprising a local table variation system operable for assigning third attributes to at least one data record, wherein the view is determined at least in part on the first attributes, the second attributes, and the third attributes.

27. The software framework of Claim 26, wherein the third attributes are selected based upon whether the at least one data record is a parent record, a child record, or a linking record.

28. The software framework of Claim 26, wherein each third attribute further comprises a group of attributes.

29. The software framework of Claim 25, wherein the view is a format chosen from a one of a screen, a printer, an email, a web page, and a file.

30. The software framework of Claim 29, further comprising a plurality of plug and play viewers, wherein each viewer is capable of providing at least one format.

31. The software framework of Claim 25, wherein the second attributes comprise one or more of read and write access, read access only, and no access.

32. The software framework of Claim 25, wherein the audience variation system further comprises whole object access, row access, and column access.

33. 33. The software framework of Claim 25, wherein the second attributes override conflicting first attributes.

34. The software framework of Claim 25, wherein the objects comprise one or more of layouts, macros, reports, tables, columns, and rows.

35. A method of reusing a query result in a database application comprising:
presenting a result of a first query;
providing unique row identifiers for each row of the query result;
selecting a portion of the rows of the query result; and
storing in a table the unique row identifiers corresponding to the selected portion of rows,
where the table is representative of a subset of the query result.

36. The method of Claim 35, wherein selecting a portion of the rows comprises a user highlighting the portion of the rows of the query result.

37. The method of Claim 35, wherein the table can be input into one or more of a second query, a join, a report, an alternate view, and an edit function.

38. A hierarchical data dictionary in a programming application comprising:
a plurality of single value objects, wherein each single value object is of particular data type;
a plurality of collections, each collection including a plurality of single value objects;
a plurality of containers, each container including a plurality of collections, wherein the plurality of collections comprises at least one collection including a data type different from another collection; and
a plurality of functions within the programming application, wherein each function is operable with the plurality of single value objects, the plurality of collections, and the plurality of containers.

39. 39. The hierarchical data dictionary of Claim 38, wherein the plurality of function calls comprise get or set routines, wherein each get or set routine is operable to receive parameters.

40. 40. The hierarchical data dictionary of Claim 39, wherein the parameters are receivable from a message passing system.

41. 41. The hierarchical data dictionary of Claim 40, wherein the parameters from the message passing system include identification of calling functions.

42. 42. The hierarchical data dictionary of Claim 38, wherein the data dictionary is in communication with a data container including a plurality of data for resolving the plurality of data into single value objects, collections, or containers or a combination thereof.

43. 43. A report system in a software application for managing, generating, and viewing reports comprising:
a launch layer for determining how the reports are to be launched;
a services layer for obtaining application program interface formatting tools common to the reports;
an options layer for receiving job option values for the reports;
a job layer for scheduling the reports for generation;
a generation layer for managing execution sequences of the reports;
a document layer containing business rules for the reports; and
an output layer for handling delivery variations for the reports.

44. 44. The report system of Claim 43, wherein the delivery variations comprise one or more of a printer, email, export to a path, print screen, and screen list.

45. 45. The report system of Claim 43, wherein determining how the reports are to be launched comprises determining if the reports are launched from one or more of a list layout toolbar, from an edit layout toolbar, from a main report menu, from code, or from a script.

46. 46. The report system of Claim 43, wherein receiving job option values comprises interacting with a user to obtain the job option values.

47. 47. The report system of Claim 43, wherein receiving job option values comprises retrieving the job option values from storage.

48. 48. The report system of Claim 43, wherein scheduling the reports for generation comprises queuing the reports for later generation.
